(19) United States
(12) Patent Application Publication
(10) Pub. No.: US 2026/0202318 A1
(43) Pub. Date: Jul. 16, 2026

(54) OPTICAL SENSOR AND SENSING METHOD

(71) Applicant: City University of Hong Kong, Kowloon (HK)

(72) Inventors: Juan Antonio Zapien, Kowloon (HK); Yun Zhang, Kowloon (HK); May Thawda Phoo, Kowloon (HK); Yishu Foo, Kowloon (HK)

(21) Appl. No.: 19/245,793

(22) Filed: Jun. 23, 2025

Related U.S. Application Data
(60) Provisional application No. 63/743,673, filed on Jan. 10, 2025.

(51) Int. Cl. G01N 21/21; G01N 21/41

(52) U.S. Cl. CPC G01N 21/21; G01N 21/4133

(57) ABSTRACT

There is provided an optical sensing method, which includes obtaining a plurality of zero-reflection points (ZRPs) with overlapping conditions for s-polarization and p-polarization at a given value of interrogation variable, and sensing variations in amplitude ratio (Ψ) and phase difference (Δ) spectra of orthogonally polarized ZRPs at overlapping conditions, or alternative representations derived upon polarization changes.

### TECHNICAL FIELD

The present invention relates to optical sensors and sensing methods using the optical sensors.

### BACKGROUND

Optical sensing is a powerful and non-invasive approach with wide-ranging applications in biomedical diagnostics, environmental monitoring, and food safety, among others. The sensing strategy aims to detect and quantify the interactions between a target analyte and the selective receptor immobilized on the optical devices. However, when the targets are small and rare in quantities, achieving suitable specificity and sensitivity becomes increasingly challenging. Traditional biosensors rely on the use of fluorescence or secondary amplifying labels to measure biomolecular interactions, but the labeling process is time-consuming, costly, and may result in false negative signals due to the blocking of reactive binding sites. An alternative label-free strategy based on plasmonic and photonic platforms has been extensively investigated to achieve ultra-sensitivity, high stability, and ultra-compact capabilities.

### SUMMARY OF THE INVENTION

According to a first aspect of the invention, there is provided an optical sensing method, which includes obtaining a plurality of zero-reflection points (ZRPs) with overlapping conditions for s-polarization and p-polarization at a given value of interrogation variable, and sensing variations in amplitude ratio (Ψ) and phase difference (Δ) spectra of orthogonally polarized ZRPs at overlapping conditions, or alternative representations derived upon polarization changes.

In some embodiments, the alternative representations comprise ρ, N, C, S, non-zero Mueller-Matrix elements, and/or other variables derived upon polarization changes.

In some embodiments, the step of obtaining the plurality of ZRPs with overlapping conditions for s-polarization and p-polarization at a given value of interrogation variable may include tuning a resonance of one or more optical waveguides and a thickness of two or more plasmonic layers.

In some embodiments, the interrogation variable may include wavelength (λ), photon energy (E) and/or angle of incidence (AoI).

In some embodiments, obtaining the plurality of ZRPs may include implementing a hybrid plasmonic-photonic mode enabling interaction between surface plasmon polaritons (SPPs) and photonic waveguide (PWG) resonances.

In some embodiments, p-polarized reflectivity spectra Rₚ is affected by coupling of SPPs and PWG modes, while s-polarized reflectivity spectra Rₛ remains uncoupled.

In some embodiments, the p-polarized reflectivity spectra Rₚ exhibits the Rabi splitting and waveguide coupled SPR where two distinct polariton states energetically split from the uncoupled SPP and PWG resonances and identified as lower polariton branch (LPB) and upper polariton branch (UPB).

In some embodiments, one branch of Rₚ overlapping with the ZRP of Rₛ in a polarimetric strategy is used for smaller variation sensing, and another branch of Rₚ is used for larger increment sensing.

In some embodiments, obtaining the plurality of ZRPs enables spectral overlap of s-polarized photonic modes with coupled p-polarized resonances.

In some embodiments, the method may further include resetting the ZRPs by adjusting the interrogation variable.

In some embodiments, the optical sensing method may be used for refractometric sensing and/or biosensing.

In a second aspect of the invention, there is provided an optical sensor, which includes a substrate for coupling light into surface plasmon polaritons, a first layer of plasmonic material on the substrate, a second layer of photonic material on the first layer, a third layer of plasmonic material on the second layer, and an outer layer exposed to external stimulus for sensing.

In some embodiments, the substrate may be transparent in one or more bands in ultraviolet/visible/near infrared/infrared spectral regions. The substrate may include quartz, sapphire, glass, and/or silicon.

In some embodiments, the plasmonic material may include metals, doped semiconductors, and/or 2D materials.

In some embodiments, the first layer and the third layer are plasmonic materials that may include silver (Ag), gold (Au), copper (Cu), aluminum (Al), indium tin oxide (ITO), titanium nitride (TiN), zirconium nitride (ZrN), graphene or other 2D materials, black phosphorus or a mixture or alloy thereof to satisfy the plasmonic resonance conditions in ultraviolet/visible/near infrared/infrared spectral regions. The first layer and the third layer may not be of the same metallic or plasmonic materials.

In some embodiments, the second layer is a photonic material that may include aluminum nitride (AlN), aluminum oxide (Al₂O₃), aluminum oxynitride (AlON), titanium dioxide (TiO₂), silicon nitride (Si₃N₄), silica (SiO₂), and/or other suitable materials that can be part of the photonic waveguide part of the embodiment.

In some embodiments, the thickness of the first layer is no more than 30 nm, and the thickness of the third layer is no more than 100 nm.

In some embodiments, the outer layer is exposed to air or solution in contact with analyte or other forms of the external stimulus, the external stimulus comprising temperature, humidity, stress, vibrations, pressure and/or combinations thereof.

In some embodiments, the outer layer contacts microfluidic device, electrode, temperature controller, and/or surface modification anchors for sensing.

In some embodiments, the optical sensor may further include a fourth layer of photonic material on the third layer acting as a photonic waveguide.

In some embodiments, the fourth layer may include aluminum nitride (AlN), aluminum oxide (Al₂O₃), aluminum oxynitride (AlON), titanium dioxide (TiO₂), silicon nitride (Si₃N₄), silica (SiO₂) and/or other suitable material that can be part of the photonic waveguide part of the embodiment.

In some embodiments, the thickness of the second layer and/or the fourth layer is larger than 1000 nm, and the optical sensor provides multiple spectral sensing points.

In some embodiments, each of the first layer, the second layer, the third layer, and/or the fourth layer may include metasurfaces, and the metasurfaces may include subwavelength plasmonic or photonic nanostructures.

In a third aspect of the invention, there is provided a method for fabricating an optical sensor, which includes preparing a substrate, forming a multilayer stack on the substrate, the multilayer stack comprising a first layer of plasmonic material, a second layer of photonic material on the first layer, and a third layer of plasmonic material on the second layer, and forming an outer layer on the multilayer stack.

In some embodiments, the step of forming the multilayer stack may further include forming a fourth layer of photonic material on the third layer.

In some embodiments, the step of forming the multilayer stack may include sequentially depositing the first layer, the second layer, and the third layer, or additionally the fourth layer, via physical vapor deposition.

In some embodiments, the step of forming the multilayer stack may be lithography-free.

In some embodiments, each of the first layer, the second layer, the third layer, and/or the fourth layer may include metasurfaces, and the metasurfaces may include subwavelength plasmonic or photonic nanostructures.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

Second embodiment of the invention will be described with reference to FIGS. 1-20.

FIG. 1 shows experimental demonstration of zero-reflection points. a-d Experimental polarized reflection characteristics Rₚ, Rₛ, Ψ and Δ for the multilayer structure in the Kretschmann configuration. The angular resolution is set to 0.01°. The (i) regions in a (Rₚ→0) and c (Ψ→0°) indicate the p-polarized ZRPs, while the (ii) regions in b (Rₛ→0) and c (Ψ→90°) represent the s-polarized ZRPs. Two direct crossings between the p- and s-polarized zero-reflection points at ~1.418 eV and ~2.748 eV are evident in c Ψ. e-h The corresponding spectra of Rₚ, Rₛ, Ψ and Δ at 59.60° AoI (marked by the dashed lines in a-d, respectively) with both experimental and fitted results. The insets in e-h show the enlarged versions of the spectra converting photon energy into wavelength scale (x-axis), as indicated by the gray regions. The green arrows point to the overlap of p- and s-polarized ZRPs at ~1.418 eV or 874.5 nm. The green dashed lines are guides to the eye for the position.

FIG. 2 shows calculated electric field distribution of the multilayer system using FDTD. The electric field correspond to a p- and e s-polarized ZRPs at ~1.418 eV (874.5 nm) and 59.60° AoI. b,f The corresponding line profile of |E_{z}|² in the same region for the conventional SPR (line with square), TIR (line with triangle), and hybrid (line with diamond) systems, the exponential decay characteristics in the water are fitted. c,g The enlarged version of the thin films region and the corresponding electric field distributions in logarithm scale. Calculation of power absorbed for the hybrid system (line with diamond) and conventional SPR (line with square) under d p- and h s-polarization. A zoom-in views of the corresponding power absorbed in the Ag₂ layer are shown as insets for both systems.

FIG. 3 shows conceptual illustration of orthogonally polarized ZRPs intersection. Calculated ellipsometric parameters a Ψ and b Δ for (i) hybrid mode, (ii) PWG mode, and (iii) WCSPR mode, respectively, in water ambient. The gray dotted lines are parallel lines of sight, the black dotted arrows present the overlapping locations of the p- and s-polarized resonances (A and B regions, Ψ→0° and 90°) in the hybrid system. c,d The corresponding spectra of Ψ and Δ at 59.60° AoI, as indicated by the dashed lines in a,b, respectively.

FIG. 4 shows characterization and optical study of the metasurface multilayer. a Schematic of the metasurface multilayer. b Cross-sectional SEM image of the fabricated Ag₁ (25 nm)/AlN₁ (260 nm)/Ag₂ (30 nm)/AlN₂ (330 nm) multilayer. c XRD spectrum with distinct peaks corresponding to the (002) and (101) orientations. d SEM image of the metasurface. e AFM topography depicts the three-dimensional contours of the metasurface. f The corresponding height profile as indicated by the arrow in e). g,h Anisotropic optical constants of the metasurface in the range of interest. The in-plane components (dashed curves) are in comparison with the out-of-plane components (solid curves). Corresponding ellipsometry spectra and optical constants of other layers are displayed in Supplementary Note 6.

FIG. 5 shows sensitivity and LoD assessments of the metasurface multilayers. a Real-time response of ellipsometric parameters Ψ (violet) and Δ (pink) to the RI variations in the sensing medium is recorded at 1.418 eV and 59.60° AoI. The average b Ψ and c A changes of the measured signals with respect to UPW as a function of the NaCl concentration (C_{NaCl}, top x-axis) and the equivalent variation of RI (δn, bottom x-axis). The error bars denote the standard deviations (σ) associated with the noises floor at each concentration. d Comparison of our metasurface multilayer device with previously reported advanced label-free optical sensors on sensitivity and LoD.

FIG. 6 shows an ultrasensitive aptamer biosensor for the detection of ampicillin. a, b Real-time detection of ampicillin from 0.1 fM to 1 nM after the anti-ampicillin aptamer functionalization. Dependence of the logarithm of sensor responses c The schematic of the metasurface functionalization for ampicillin detection. d log(OF) and log(δΔ) on the logarithm of the ampicillin concentrations, log(Cₐₘₚ), with a linear fit. The last minute of the bioconjugation process was considered as the ultimate response of the sensor. The error bars represent the standard deviations (σ) associated with the noise floor of the blank sample for the first 5 minutes. e Comparison of our metasurface-based aptasensor with previously reported ampicillin detection techniques in terms of LoDs.

FIG. 7 shows a schematic diagram of an optical system that measures polarized reflections (Rₚ & Rₛ) and their amplitude ratio (Ψ) and phase difference (Δ). An ellipsometer or other suitable polarimetric instrument with a Polarization State Generator (PSG) and Polarization State Detector (PSD) enable quantification of Rₚ and Rₛ, such that their ratio

$$tan ( Ψ ) = \sqrt{\frac{{R}_{p}}{{R}_{s}}} ,$$

or other related polarimetric representations such as for examples (N, C, S) and Muller-Matrix Element (MME) shown in FIG. 23B, can report the degree of p- to s-polarized reflection overlap. Note that an added advantage of using the ellipsometric approach is that the relative phase difference Δ also provides sensitivity information (shown also in FIG. 23).

FIG. 8 shows calculated p- and s-polarized reflectivity spectra for conventional SPR at 61.50° AoI (dashed line), and pure TIR (line with square), WCSPR (line with down-triangle), PWG (line with up-triangle), and hybrid systems (line with circle) at 59.60° AoI, respectively. The arrows indicate the spectral position used to simulate the electric fields of each system.

FIG. 9 shows calculated p-polarized electric field distribution and corresponding |E|² line profile in the same region for a,b conventional SPR (at 61.50° AoI, 1.418 eV), c,d pure TIR (at 59.60° AoI, 1.418 eV), e,f pure WCSPR (at 59.60° AoI, 1.393 eV), and g,h pure PWG (at 59.60° AoI, 1.4099 eV), respectively. The exponential decay characteristics in the water are highlighted. The right panels show the enlarged versions of the thin films area and the corresponding electric field distributions and absorbed power. The absorbed power of the hybrid system is also plotted for comparison.

FIG. 10 shows calculated s-polarized electric field distribution and corresponding |E|² line profile in the same region, along with the absorbed power for a,b conventional SPR, c,d pure TIR, e,f pure WCSPR, and g,h pure PWG system. The absorbed power of the hybrid system is also plotted for comparison.

FIG. 11 shows thickness adjustment of Ag₁ layer (25 nm) in the multilayer system at 59.60° AoI showing (a) Rₚ, (b) Rₛ, (c) Ψ, and (d) Δ spectra when the Ag₁ thickness changes (dt_{Ag1}) from −3 nm (line with circle) to +3 nm (line with triangle). The gradient arrows highlight the spectral variations as the Ag₁ thickness increases.

FIG. 12 shows thickness adjustment of AlN₁ layer (260 nm) in the multilayer system at 59.60° AoI showing (a) Rₚ, (b) Rₛ, (c) Ψ, and (d) Δ spectra when the AlN₁ thickness changes (dt_{AlN1}) from −10 nm (line with circle) to +10 nm (line with triangle). The gradient arrows highlight the spectral variations as the AlN₁ thickness increases.

FIG. 13 shows thickness adjustment of Ag₂ layer (30 nm) in the multilayer system at 59.60° AoI showing (a) Rₚ, (b) Rₛ, (c) Ψ, and (d) Δ spectra when the Ag₂ thickness changes (dt_{Ag2}) from −3 nm (line with circle) to +3 nm (line with triangle). The gradient arrows highlight the spectral variations as the Ag₂ thickness increases.

FIG. 14 shows thickness adjustment of AlN₂ layer (330 nm) in the multilayer system at 59.60° AoI showing (a) Rₚ, (b) Rₛ, (c) Ψ, and (d) Δ spectra when the Ag₁ thickness changes (dt_{AlN2}) from −10 nm (line with circle) to +10 nm (line with triangle). The gradient arrows highlight the spectral variations as the AlN₂ thickness increases.

FIG. 15 shows thickness tolerance analysis of Ag₁—AlN₁ layers in the hybrid system showing a log(Rₚ), b log(Rₛ), c Ψ, and d Δ spectra when adjusting the δt_{Ag1} from +3 nm to −3 nm, δt_{AlN1} from +16 nm to −9 nm, and δAoI from −0.6° to +1.4°, respectively. The horizontal black lines in (a) and (b) are the guide for R<1%, which is considered to be the limit of ZRPs. The vertical dashed lines highlight the overlap positions of ZRPs.

FIG. 16 shows dielectric materials analysis of top layer (dielctric₂) in the hybrid system showing a log(Rₚ), b log(Rₛ), c Ψ, and d Δ spectra when adjusting the δt_{Ag2} from +5 nm to +4 nm to balance the amplitude, δd_{2_void} from 0% to 6%, and δAoI from −0.6° to +0.8°, respectively. The horizontal black lines in (a) and (b) are the guide for R<1%, which is considered to be the limit of ZRPs. The vertical dashed lines highlight the overlap positions of ZRPs.

FIG. 17 shows characterization of the multilayer structures using spectroscopic ellipsometry (SE).

FIG. 18 shows the ellipsometry measured the optical constants (n and k) of each layer. The solid lines represent the fitted optical results, while the dotted lines indicate the reference values obtained from the library.

FIG. 19 shows the raw and smoothed sensorgrams for a δΨ and d δΔ are plotted. The baselines were measured under an ultrapure water medium, with 200 data points recorded over 35 minutes. A Savitzky-Golay filter was applied to remove high noises. Histograms of raw and smoothed datasets are shown in b,c and e,f. The dashed lines denote the Gaussian fit of the distributions.

FIG. 20 shows a SEM image of the metasurface. b Final image after automatic analysis of voids. The segment lines indicate the detected boundaries of the voids.

Third embodiment of the invention will be described with reference to FIGS. 21A, 21B, 22A, 22B, 23-49.

FIGS. 21A and 21B show experimental demonstration of the Optical Vernier Scale (OVS) sensor. a) i) Schematic of the total internal reflection ellipsometry (TIRE) measurement geometry, which provides both amplitude ratio (Ψ) and phase (Δ) information of the reflected light; ii) SEM cross-section image of the fabricated Ag₁ (20 nm)/AlN (500 nm)/Ag₂ (48 nm) multilayer that supports the SPP & PWG coupled mode. b, c) Experimental and d, e) fitted ellipsometric parameters Ψ and Δ for the multilayer. The Δ regions (Ψ→0°) in b,d) indicate the p-polarized ZRPs while the B regions (Ψ→90°) represent the s-polarized ZRPs. Two anti-crossings originating from the interaction of the SPP and PWG modes are observed in p-polarized reflection. Two direct crossings between the p- and s-polarized ZRPs are also evident. f-i) The enlarged versions of fitted Ψ and Δ (indicated by the dashed areas in (d) and (e), respectively) with the incident angles from f,g) 60° to 62° and h, i) 65° to 75°. The dashed lines in f-i) show the positions of the Vernier scales, and j-m) are the corresponding amplitude Ψ and phase A spectra, experimental and fitted results, at j,k) 61.12° and l,m) 70.80° AoI, respectively. The arrows indicate VS1 and VS2. The OVS effect simultaneously arises in both Ψ j,l) and Δ k,m) spectra.

FIGS. 22A and 22B show the strong coupling of plasmonic and photonic modes. a) The measured p-polarized reflectivity spectra of i) an unperturbed SPP mode, ii) an unperturbed PWG mode, and iii) the SPP & PWG coupled mode at ≈610 and ≈70° AoI, respectively. The dashed lines in a) are guides to the eye for each resonance. The spectra of the SPP & PWG coupled system exhibit two distinct polariton states at both sides of the uncoupled SPP and PWG resonances, identified as LPB and UPB, indicating the presence of new eigenstates. b) The p-polarized reflectance of the coupled system from 550 (bottom) to 750 (top) AoI. The dashed lines in b) indicate the unperturbed multimode PWG resonances, PWG₁ (purple) and PWG₂ (dark cyan). The black solid lines are guides for the eye highlighting the split polariton states and the Lorentz fit resonant energies (see Note 5, Supporting Information), corresponding to the spherical symbols in the dispersion relation c,d) Magnified plots for the angular ranges c) 60.6°-62.2° and d) 64.0°-76.0° are presented to highlight the different angular dependence of these hybrid modes. The solid curves in c,d) are theoretical fits of the UPB and LPB respectively with a coupled oscillator model. The dotted and dashed lines correspond to the unperturbed SPP and PWG dispersions, respectively. e,f) Hopfield coefficients α and β, representing the fractions of the SPP and PWG modes in i) upper and ii) lower polariton branches; the stars correspond to the coefficients of SPP mode, and the triangles represent those of the two PWG modes. g-j), The calculated Eₓ of the coupled system corresponding to the points shown in a iii). The incident angles are 61.00° at g,h) and 70.00° at i,j). The left rows of g-j display the intensity map, and the right rows represent the corresponding cross-section of |Eₓ|² in the same region.

FIG. 23A and FIG. 23B shows OVS for sensing. The measured a) amplitude ratio Ψ and b) phase difference Δ at 61.050 while varying the sensing media RI from δn=2×10⁻⁸ RIU to 5×10⁻⁵ RIU. The lower panels in a) and b) represent the logarithmic scale of the net changes in Ψ and Δ with respect to ultrapure water (UPW). The insets show the VS2 signal-to-noise ratio (SNR) of the measured spectra below δn=2×10⁻⁶ RIU. The maximum c) amplitude and d) phase changes of the measured spectra with respect to UPW as a function of the NaCl concentration (top x-axis) and the equivalent perturbation of RI (bottom x-axis) for VS1 (squares) and VS2 (circles) with the error bars representing the standard deviation of the corresponding spectral region. FIG. 23B e-t), depiction of the Vernier scale “reset” by adjusting the AoI. Simulated e,g) Ψ, f,h) Δ, i,l) N, j,m) C, k,n) S, o,r) M21, p,s) M33, and q,t) M43 spectra under UPW medium (black solid line), and after consecutive RIU increases by δn₁=2×10⁻⁶ RIU (light dashed line), δn₂=2×10⁻⁴ RIU (light solid line), and δn₃=2×10⁻⁴+2×10⁻⁶ RIU (dashed line) at e,f,i,j,k,o,p,q) 61.05° and g,h,l,m,n,r,s,t) 61.10° AoI, respectively. The lower panels of e-t) are the corresponding net changes (δΨ and δA) in RI variation of δn=2×10⁻⁶ RIU.

FIG. 24 shows biosensing and Vernier scale reset. Ellipsometric parameters a) Ψ and b) Δ of the multilayer after overnight incubation in 11-MUA. The black line with sphere represents the baseline in UPW at 61.05° AoI, the gray line with sphere represents the final step of S2 protein bioconjugation at 61.05° AoI, and the gray line with square indicates the reset baseline at 61.10° AoI without changing the solution. Real-time functionalization process of the S2 protein is demonstrated at 61.05° AoI with chosen spectral positions c) E₁=0.83 eV (VS1) and d) E₂=0.99 eV (VS2), respectively. e,f) Real-time dose-dependent response of the S2 protein is recorded for the same spectral positions but at 61.10° AoI. Various concentrations of the S2 protein (5 to 25 ng/mL⁻¹) are progressively added and a cumulative increase/decrease in Ψ (left-axis)/Δ (right-axis) is observed.

FIG. 25 shows: a The simulation geometry of the plasmonic and photonic coupled system (x-z view). b-e Comparison of the resulting FDTD spectral dependence of Ψ and Δ against the experimental ellipsometric data and FE modeling.

FIG. 26 shows calculated p-polarized reflectivity spectra for the multilayer system at a 61° and e 70° AoI. Calculated p-polarized electric field distribution and corresponding line profile. b-d correspond to the points I, II, III shown in a, while f-h correspond to the points IV, V, VI marked in b.

FIG. 27 shows calculated s-polarized reflectivity spectra for the multilayer system at a 61° and d 70° AoI. Calculated s-polarized electric field distribution and corresponding line profile. b,c correspond to the points I, II shown in a and e,f correspond to the point III, IV marked in d, respectively.

FIG. 28 shows calculated p-polarized reflectivity spectra for the uncoupled SPR system (48 nm Ag layer) at a 61° and c 70° AoI. Calculated p-polarized electric field distribution and corresponding line profile. b,d corresponds to the point I shown in a and the point II marked in b, respectively.

FIG. 29 shows: a Schematics of four planar multilayer structures that support the (i) unperturbed SPR mode, (ii) unperturbed PWG mode, (iii) coupled SPP & PWG mode, and (iv) coupled mode with a thicker AlN. The corresponding ellipsometric parameters Ψ and Δ for configuration (i) are shown in b,c, and d,e show the configuration (ii), f,g present configuration (iii); and h,i display four Rabi splitting and eight Vernier scales in a thicker AlN multilayer system. The upper arrows in f,g indicate the anti-crossing behaviors originating from the interaction of p-polarized zero reflection (region A, Ψ→0°) between the SPP and PWG modes that constitute the system. The lower arrows show the nodal points associated with the overlap of p- and s-polarized zero reflection (region B, Ψ→90°) of the coupled system.

FIG. 30 shows experimentally obtained ellipsometric parameters a Ψ and b Δ for the coupled system. c, d Phase behaviors for incidence angles slightly below and above the ZRPs.

FIG. 31 shows the fitting results of the experimentally measured p-polarized reflectivity spectra for a the unperturbed SPR system, b the unperturbed PWG modes, and c the coupled system are selectively displayed as examples. d The summary of the Lorentz fitted resonant energies as a function of incident angles for each system. The lines represent the uncoupled SPR (dotted) and PWG (dashed) modes, and the spherical symbols indicate the resonances of the coupled system.

FIG. 32 shows the measured a Rₚ and b Rₛ at 61.05° while varying the refractive index of the sensing media from δn=2×10⁻⁸ RIU to 5×10⁻⁵ RIU. The lower panels in a and b represent the logarithmic scale of the net changes in Rₚ and Rₛ with respect to ultrapure water (UPW). The insets show the SNR of the measured spectra below δn=2×10⁻⁶ RIU.

FIG. 33 shows: a Schematic of the Vernier caliper. b Experimental demonstration of the VS2 dynamic range in 4) and A spectra resulting from the ZRPs overlap of Rₚ and Rₛ in the coupled system (δn from 2×10⁻⁸ to 5×10⁻⁵ RIU).

FIG. 34 shows experimental ellipsometric parameters a Ψ and b Δ for the coupled SPP & PWG system from 60.8° to 75.0° AoI.

FIG. 35 shows the logarithmic scale of the net changes in a Ψ and b Δ with respect to ultrapure water (UPW) at 61.05° while varying the refractive index of the sensing media from δn from 2×10⁻⁸ RIU to 5×10⁻⁵ RIU (bottom x-axis) and NaCl concentration (top x-axis). VS1 is indicated as squares and VS2 is displayed by circles with the error bars representing the standard deviation of the corresponding spectral region. The enlarged versions as indicated by the dashed areas in a and b, show the first four measurements (δn=2×10⁻⁸ to 2×10⁻⁶ RIU) in logarithmic scale c, d and linear scale e, f, respectively.

FIG. 36 shows noise levels of a Rₚ, b Rₛ, c Ψ and d Δ during 150 measurements in UPW at 61.05° AoI. The top panels present the 150 measured spectra and the corresponding total average. The middle panels show the difference with respect to the average values. The bottom panels indicate the standard deviation of 150 measured spectra.

FIG. 37 shows Ψ and Δ changes over time with different values of refractive index of the solution for (a) (b) VS1 and (c) (d) VS2. The dotted lines and arrows indicate the points of ionic concentration change. The black dashed lines indicate the average values of each stage. The semi-filled area error bars represent the 2 times standard deviation (±2σ) of each stage for VS1 and VS2.

FIG. 38 shows histograms for the spectral changes observed during the real-time response of different values of refractive index for (a) Ψ and (d) Δ. Error bars indicate the standard deviation (±σ) of measured spectra. The values 3σ are highlighted by the dashed lines and semi-transparent rectangles.

FIG. 39 shows comparison of the LoD of Optical Vernier Scale system (according to some embodiments of the invention) with other typical and advanced RI sensors reported so far.

FIG. 40 shows an example of functionalizing a sensor surface using the following protocol. In step (i), the sensor is immersed in an ethanolic solution of 11-MUA. In step (ii), the flat sensor chip is assembled to a microfluidic device. In step (iii), the chip surface is activated by the standard EDC/NHS chemistry. In step (iv), SARS-CoV-2 S2 antibodies are immobilized on the surface. In step (v), BSA as an additional blocker of non-specific interactions is pumped in to optimize the sensor specificity. In step (vi), the surface is immersed in a rabbit secondary antibody solution to evaluate the specific binding ability. In step (viii), after rinsing with UPW, the surface is immersed in SARS-CoV-2 spike protein solution of a given concentration.

FIG. 41 shows thickness tolerance analysis of AlN (500 nm) in the multilayer system showing (a) Rₛ, (b) Rₚ, (c) Ψ, and (d) Δ spectra when adjusting the AlN thickness change (δt_{AlN}) from −20 nm to +20 nm. The horizontal dotted lines in (a) and (b) are the guide for R<1% which is considered to be the limit enabling a significant overlap. The areas indicated by the dashed lines highlight ZRPs overlap spectral region.

FIG. 42 shows thickness tolerance analysis of AlN in the multilayer system showing (a) Rₛ, (b) Rₚ, (c) Ψ, and (d) Δ spectra after the AoI tuning at the thickness variations of ±20 nm (δt_{AlN}=±4%). The dotted lines are the guide for R<1%. The dashed areas indicate the ZRPs overlap spectral region.

FIG. 43 shows thickness tolerance analysis of AlN in the multilayer system showing (a) Rₛ, (b) Rₚ, (c) Ψ, and (d) Δ spectra after the AoI tuning at the thickness variations of ±40 nm (δt_{AlN}=±8%) with respect to the reference value t_{AlN}=500 nm. The dotted lines are the guide for R<1%. The dashed areas indicate the ZRPs overlap spectral region.

FIG. 44 shows thickness tolerance analysis of thin Ag layer (t_{Ag1}) in the multilayer system showing (a) Rₛ, (b) Rₚ, (c) Ψ, and (d) Δ spectra when changing the thin Ag thickness by δt_{Ag1} from −6 nm to +6 nm with respect to the reference value t_{Ag1}=20 nm. The dotted lines are the guide for R<1%. The dashed areas indicate the ZRPs overlap spectral region.

FIG. 45 shows thickness tolerance analysis of thick Ag layer (t_{Ag2}) in the multilayer system showing (a) Rₛ, (b) Rₚ, (c) Ψ, and (d) Δ spectra when adjusting its thickness δt_{Ag2} from −10 nm to +10 nm with respect to the reference value t_{Ag2}=48 nm. The dotted lines are the guide for R<1%. The dashed areas indicate the ZRPs overlap spectral region.

FIG. 46 shows a schematic of the TIRE measurement. An ellipsometer or other suitable polarimetric instrument with a Polarization State Generator (PSG) and Polarization State Detector (PSD) enable quantification of Rₚ and Rₛ, such that their ratio

$$tan ( Ψ ) = \sqrt{\frac{{R}_{p}}{{R}_{s}}} ,$$

or other related polarimetric representations such as for examples (N, C, S) and non-zero Muller-Matrix Element (MME) shown in FIG. 23, can report the degree of p- to s-polarized reflection overlap. Note that an added advantage of using the ellipsometric approach is that the relative phase difference Δ also provides sensitivity information (shown also in FIG. 23).

FIG. 47 shows characterization of the multilayer structures using the scanning electron microscope (SEM) and spectroscopic ellipsometry (SE).

FIG. 48 shows the ellipsometry measured the dielectric functions (ε₁ and ε₂) of each layer.

FIG. 49 shows the spectra of a Ψ and b Δ measured at 61.05° AoI after fabrication (solid line), after use and overnight soaking in ethanol (circles), and after 6 months (dots).

FIG. 50 illustrates the optical sensors in thicker systems. Schematic of the corresponding thicker (a) Second embodiment and (d) the Third embodiment, and simulated ellipsometric parameters (b, e) Ψ and (c, f) Δ.

FIG. 51 shows an example of s-polarized reference scale and p-polarized sliding scale to illustrate the idea of the Vernier scale.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Hereinafter, some embodiments of the invention will be described in detail with reference to the drawings.

### I. First Embodiment

Zero-reflection points (ZRPs) have emerged over the past years as powerful strategies to improve the sensitivity and resolution of optical sensors devoted to measure changes in refractive index units (RIU). Whereas current commercial RIU optical sensors range have a range in limit of detection (LoD)~10⁻⁶ to 10⁻⁷ RIU. This embodiment of the invention is based on simple, lithography-free, plasmonic-photonic multilayers with unsurpassed, experimentally demonstrated, LoD~10⁻⁸ to 10⁻⁹ RIU. The effective and simple operation of the sensor relies on: i) synergic interaction between p-polarized surface plasmon polaritons (SPPs) and photonic waveguide (PWG) modes with ii) simultaneous implementation of two orthogonally polarized ZRPs with overlap of s-polarized photonic modes with the coupled p-polarized resonances at a given value of the sensor interrogation variable such as wavelength, angle of incidence, or other; and iii) polarization resolved sensing strategy where the s-polarized ZRP provide a stable reference to boost the sensing performance of the p-polarized ZRP. As a result of the orthogonal polarization ZRP overlap, the Rₚ and Rₛ coefficients naturally form a refinement measuring scale akin to the mechanical Vernier scale, thus this sensing strategy is called Optical Vernier Scale (OVS) sensor. Furthermore, it is possible to enact precise manipulation of ZRPs in order to enable resetting the sensor to its optimal sensing point even after a large change in RIU. The OVS and resetting capabilities are demonstrated for a biosensor of SARS-CoV-2 spike (S2) protein and ampicillin (molecular mass <500 Da) that can track the full functionalization process of the chip surface and then reset to perform dose-dependent detection. This “tune and reset” strategy effectively combines an ultra-low LoD with an exceptionally broad sensing dynamic range.

Two sub-embodiments of the invention are provided. The first sub-embodiment demonstrates the integration of multiple optical phenomena: reflection suppression, phase singularities, and waveguide-coupled surface plasmon resonance (WCSPR). The second sub-embodiment similarly incorporates reflection suppression and phase singularities but different in its approach by utilizing Rabi splitting phenomena. A notable commonality between both embodiments is their employment of spectral interrogation techniques, which uniquely achieve simultaneous ZRPs for both p- and s-polarized light at identical interrogation parameters. This coincidence of polarization-dependent responses represents a significant advancement in optical system design and offers potential applications in sensing and waveguide technologies. The supplementary information of these two sub-embodiments demonstrates the general principles of the device and discusses the effect of the different variables to show: 1) the effect of each variable on device performance and 2) the reliability and robustness of the design.

### Technical Description

A multilayer structure is provided according to an embodiment. The refractive index (RI) functions of dielectric and metal materials are used to achieve two ZRPs with overlapping conditions for s- and p-polarizations at a given value of the interrogation variable such as wavelength (k) and angle of incidence (AoI). Such overlapping conditions are reached by tuning the thickness of the optical waveguide. The optical system more striking result is that it provides an additional degree of freedom for resetting the ZRPs by simply adjusting the AoI, since topologically protected ZRPs can always exist within the parameter space (see supplementary information that discusses the effect of the different variables).

The first invention example demonstrates an advanced hybrid mode that results the interaction between the SPPs and PWG resonances, enabling the ZRPs of s- and p-polarizations coincide, which means the spectra of Rₚ and Rₛ overlap at their minima (refer to the Second and Third Embodiment). The principle lies that, the Rₚ is affected by the coupling of SPPs and PWG modes, while the Rₛ remains uncoupled since SPPs affect only the p-polarization, the s-polarized PWG modes are excited alone and used as the reference. As a result, the ZRPs of the s- and p-polarizations can be adjusted independently and allowed to overlap. Benefiting from the strong coupling, the resulting Rₚ exhibits the Rabi splitting, wherein two distinct polariton states energetically split from the uncoupled SPP and PWG resonances and identified as the lower polariton branch (LPB) and the upper polariton branch (UPB). In some embodiments of the invention, the UPB of Rₚ overlaps with the ZRP of Rₛ, leads to the Fano line-shape in Ψ, indicated as Vernier scale 2 (VS2), and used for small variation sensing; whereas the LPB remains the Lorentzian line-shape, denoted as Vernier scale 1 (VS1), yields better response for larger increment sensing.

The overlap of the ZRPs of Rₚ and Rₛ also makes the phase undergoes ±4π round-trip because of the phase singularity effect, thereby increasing the local phase gradient, which significantly enhances the phase sensitivity and defined as VS2 in Δ; while the other ZRP of Rₚ is not overlap with Rₛ therefore the phase only undergoes ±2π round-trip and defined as VS1 in Δ.

The results indicate that the proposed strategy exhibits remarkable robustness and stability, facilitating several sensing rounds over at least six months period using the same chip.

The experimental results are fully validated by numerical simulations, using both Fresnel equations and the full-vectorial Finite-Difference Time-Domain (FDTD) methods.

The measuring scheme can work on angle or wavelength interrogation, for the proof-of-concept wavelength resolved spectroscopic ellipsometry (SE) is used. SE provides a quantitative measurement of the relative amplitude ratio (Ψ) and phase difference (Δ) of the p- and s-components of light reflected that can be expressed by: tan(Ψ)e^{iΔ}=\tilde{r}ₚ/\tilde{r}ₛ; where Ψ & Δ are the ellipsometric parameters, \tilde{r}ₚ & \tilde{r}ₛ are the Fresnel reflection coefficients, that relate with reflectance following the relations: Rₚ=|\tilde{r}ₚ|² and Rₛ=|\tilde{r}ₛ|², Rₚ and Rₛ are the reflection intensity from these two polarizations.

Novel features of the First Embodiment are provided as below.

1) Simultaneous implementation of two orthogonally polarized ZRPs and wavelength-interrogation enables spectral overlap of s-polarized photonic modes with the coupled p-polarized resonances.

2) Polarization resolved strategy based sensing where the s-polarized ZRP provide a stable reference to boost the sensor performance in terms of the amplitude ratio (Ψ) and phase difference (Δ) of Rₚ and Rₛ thereby naturally forming a refinement measuring scale akin to a Vernier scale.

3) The results demonstrate that the fabrication strategy of the invented sensor is robust and does not require a complex fabrication process to guarantee reproducibility and reliability. The fabricated chip is stable in ambient conditions for at least six months and has been used multiple (>5) times.

4) The broad operating spectral region from visible to near-infrared obtained by tuning the AoI and/or the structural factors and/or the external stimulus.

5) The capability to combine an extreme sensitivity with LoD~10⁻⁸ to 10⁻⁹ RIU over a very broad sensing dynamic range (i.e. ~10⁻⁹ to 10⁻² RIU) by the “tune and reset” strategy.

### Example Features of Some Embodiments of the Invention

1) The overlap of zero-reflection points (ZRPs) for s- and p-polarizations at same value of interrogation variables. There are remarkable benefits once this is achieved because the relative amplitude ratio Ψ and phase difference Δ of Rₚ and Rₛ form an Optical Vernier Scale (OVS). Moreover, it provides the ability to reset the ZRPs by simply adjusting the AoI, since topologically protected ZRPs can always exist within the parameter space. The proposed embodiments claim an advanced hybrid mode that results the interaction between the SPPs and PWG resonances, enabling the ZRPs of s- and p-polarizations coincide. Benefiting from the interaction, such as in the first sub-embodiment, the resulting Rₚ exhibits the Rabi splitting, wherein two distinct polariton states energetically split from the uncoupled SPP and PWG resonances and identified as the LPB and the UPB. One branch of Rₚ overlaps with the ZRP of Rₛ, indicated as VS2, and used for small variation sensing; whereas another branch of Rₚ denoted as VS1, yields better response for larger increment sensing.

2) The optical sensing chips formed by the attractive hybrid plasmonic-photonic platforms based on several planar multilayers that are transparent in one or more bands in the ultraviolet/visible/infrared spectral regions, such as glass, quartz, sapphire, silicon, etc. The support can couple light into the surface plasmon polaritons (i.e. prism, grating, etc.) and attached to the first layer of the multilayer structure. The first layer of the multilayer is formed by a plasmonic material, such as silver (Ag), gold (Au), copper (Cu), aluminum (Al), or a mixture or alloy thereof, and/or other suitable material that can be part of the plasmonic part of the embodiment, on the support. The second layer of the multilayer structure is formed by a photonic material, such as aluminum nitride (AlN), aluminum oxide (Al₂O₃), aluminum oxynitride (AlON), titanium dioxide (TiO₂), silicon nitride (Si₃N₄), silica (SiO₂), etc., and/or other suitable material that can be part of the photonic waveguide part of the embodiment. The third layer of the structure is formed by a plasmonic material, such as silver (Ag), gold (Au), copper (Cu), aluminum (Al), or a mixture or alloy thereof, and/or other suitable material that can be part of the plasmonic part of the embodiment, on the second layer. The fourth layer of the multilayer structure is formed by a photonic material, such as aluminum nitride (AlN), aluminum oxide (Al₂O₃), aluminum oxynitride (AlON), titanium dioxide (TiO₂), silicon nitride (Si₃N₄), silica (SiO₂), etc., and/or other suitable material that can be part of the photonic waveguide part of the embodiment, on the third layer. The thickness of the first layer is no more than 30 nm. The thickness of the second layer is no more than 1,000 nm. The thickness of the third layer is no more than 100 nm. The thickness of the fourth layer is no more than 1,000 nm. The outer layer is exposed to air or solution in contact with the analyte or other forms of the external stimulus, such as temperature, humidity, stress, vibrations, pressure and combinations thereof. The outer layer may also contact other components, such as microfluidic device, electrode, temperature controller, surface modification anchors, etc., for sensing.

3) The ability to reset the sensor to broaden the dynamic range of the sensor. This ability relies on two assumptions; first, the use of optical structures for which Fresnel equations allow small variations in the angle of incidence (AoI, θ), photon energy (E), and polarization without losing the resonance condition and second, the dielectric permittivity (ε₁, ε₂) also vary continuously within a bounded region. In such conditions, a zero-reflection surface can be formed in the (E, ε₁, ε₂) space while relatively small perturbations of the dielectric permittivity will not change the fact that the material dispersion curve always intersects the zero-reflection surface but at slightly different spectral position. Therefore, when the sensing medium continuously shifts the ZRP of Rₚ away from that of Rₛ, they can always re-intersect because the topologically protected zeros can consistently exist by simply adjusting the AoI and/or the structural factors and/or the external stimulus (i.e. temperature, photoelectric, pressure changes, etc. that counteract the effects of increased RI).

4) An optical sensing setup comprising the optical sensing chip that is formed by several multilayer stacks according to feature 2) with polarization resolved strategy, such as ellipsometry, common-path interferometry and/or polarimetry that utilize the information between the two polarizations for sensing. For example, ellipsometry measures the relative amplitude ratio (Ψ) and phase difference (Δ) between the p- and s-polarization of the reflected light, the individual and combined reflectance intensity, the real and imaginary ρ, N, C, S that are the non-zero elements of the isotropic Mueller-Matrix and are related to the Ψ-Δ curves traditionally graphed for ellipsometry. All the above are generally referred as ellipsometric parameters whose values change with internal and/or external perturbations and thus can be used for sensing.

### Example Functions and Applications of Some Embodiments of the Invention

Some embodiments of the invention can be classified as a refractometric sensing device, which plays an important role in the group of sensors since several physical quantities such as concentration, temperature, humidity, and pressure, etc., can be reflected by the change of RI.

Some embodiments of the invention can be used for biosensing. The utility of some embodiments of the invention as a biosensor of SARS-CoV-2 spike protein is evaluated. Moreover, the affinity binding evolution between ampicillin (molecular mass <500 Da), a penicillin-based antibiotic, with its specific aptamer have demonstrated that the sensor signals exhibited a linear response within the concentration range of ampicillin from 1 fM to 1 nM on a logarithmic scale. This novel approach has enabled the identification of biomolecules at extremely low concentrations. Such advancements could revolutionize early disease diagnosis, environmental monitoring, and the study of rare biological events.

### Example Advantages of Some Embodiments of the Invention

1) The photonic s-polarized resonance of the multilayer system provides an internal reference metric as it is insensitive to the external surrounding variations, such that the resulting optical sensor does not require the redundant reference channels.

2) Use of wavelength interrogation with phase-enabled ellipsometry measurement so that some embodiments of the invention can measure the phase difference Δ results in ~100× improvement in sensitivity with respect to the common intensity-only measurements.

3) Ability to simultaneously use several sensing points at the same time to increase the sensitivity and robustness of the sensor. For example, Vernier scale 2 results in higher sensitivity for small changes, whereas Vernier scale 1 yields better response for higher dynamic range.

4) The capability to combine an ultralow LoD (~10⁻⁸ to 10⁻⁹ RIU) over a very broad sensing dynamic range (i.e. 10⁻⁹ to 10⁻² RIU) by the “tune and reset” strategy.

5) Flexibly tune the resonant wavelengths of the optical sensor over a broad spectral range by adjusting the angle of incidence or/and structural parameters or/and external stimulus.

6) The sensing chips are fabricated in a simple manner on an industrial scale, thus are highly competitive from an economic point of view.

### II. Second Embodiment

Lithography-Free Plasmonic-Photonic Metasurface Multilayers with Multiple Zero-Reflection Points for Sensing

Label-free optical biosensors present great potential for clinical diagnosis and food safety applications. However, the sensing performance of conventional label-free sensors fails below commonly used but time-consuming secondary labeling methods. To address this issue, some embodiments of the invention propose a lithography-free plasmonic-photonic metasurface multilayer, in order to achieve the intersection of two orthogonally polarized zero-reflection points. At this intersection, the spectral line-shape of reflection amplitude ratio (Ψ) is significantly narrowed (down to 2 nm full-width-at-half-maximum), along with the emergence of singularities in phase difference (Δ). These spectral features are highly sensitive to changes in the surrounding refractive index, thus enabling high-resolution sensing. This novel approach has achieved an unprecedented phase sensitivity of ~9.8×10⁷°/RIU (refractive index unit) with limit of detection (LoD) estimated to be ~9.5×10⁻⁹ RIU. To validate the biocompatibility of the system, it is demonstrated the bioconjugation between ampicillin (molecular mass <500 Da) with the specific aptamer. The sensor signals exhibit a linear response within the concentration range of ampicillin from 1 fM to 1 nM on a logarithmic scale. Combining advantages of the ultrahigh sensitivity, record-breaking LoD, superior stability, and large surface areas, this sensing platform provides a new strategy for real-time monitoring of small biomolecular interactions.

### Introduction

Optical sensing is a powerful and non-invasive approach with wide-ranging applications in biomedical diagnostics, environmental monitoring, and food safety, among others.^{1,2,3} The sensing strategy aims to detect and quantify the interactions between a target analyte and the selective receptor immobilized on the optical devices. However, when the targets are small and rare in quantities, achieving suitable specificity and sensitivity becomes increasingly challenging. Traditional biosensors rely on the use of fluorescence or secondary amplifying labels to measure biomolecular interactions, but the labeling process is time-consuming, costly, and may result in false negative signals due to the blocking of reactive binding sites.³ An alternative label-free strategy based on plasmonic and photonic platforms^{4,5,6,7} has been extensively investigated to achieve ultra-sensitivity, high stability, and ultra-compact capabilities.

Surface plasmon resonance (SPR) biosensor is so far the most prevalent and well-established label-free detection technology, characterized by the real-time monitoring of biomolecular binding events and high-throughput imaging capabilities. SPR biosensor utilizes surface plasmon polaritons (SPPs), which are the collective oscillations of free electrons along a metal-dielectric interface excited by the incident light with an appropriate wavevector satisfying the resonance condition. The excitation of SPPs generates strong electric field confinement that penetrates the sensing medium to a depth of 30-200 nm, enabling high sensitivity to variations in the surrounding refractive index (RI).³ However, due to the strong radiative losses in metals, a broad linewidth of SPR is a major limitation because it fundamentally hinders the sensing capability, as any practical application demands substantial intensity variations or spectral shifts in the reflection or transmission spectrum. Since its first implementation in biosensing⁸, various improved SPR-based sensing platforms have emerged to increase the RI resolution, allowing the detection of smaller bio-binding events. Progress has primarily focused on pursuing narrower resonance curves for higher precision discrimination, and minimizing reflectivity to reduce the detection noise and achieve phase singularities⁹. Long-range surface plasmon resonance (LRSPR) and waveguide coupled SPR (WCSPR) are proposed, with resonance curves much narrower than conventional SPR and significantly improved sensitivity.¹⁰ The LRSPR has a symmetrical phase profile and exhibits a reduced propagation loss, arising from the out-of-phase coupling of the two SPP modes propagating on opposite interfaces of the metal thin film.¹¹ A LRSPR sensor, by inserting a low RI buffer layer of Teflon AF between the thin metal film and the prism, reports a RI resolution of 2.5×10⁻⁸ refractive index unit (RIU) requiring, however, 1.4 picometer position resolution.¹² Extensive research efforts also demonstrate superior performance in WCSPR systems when the waveguide layer satisfies the following conditions: the RI should be larger than the RI of the sensing medium (typically air or water), and the thickness should be greater than the cut-off thickness to ensure wave propagation via total internal reflection (TIR).^{13,14} Recently, Abdulhalim's group proposed a WCSPR sensor with a high penetration depth of more than 4 m and a sensor accuracy of 10⁻⁷ RIU.¹⁵ Other cutting-edge plasmonic sensors have also achieved a limit of detection (LoD) down to the range of 10⁻⁷ to 10⁻⁸ RIU, include plasmonic surface lattice resonance sensors^{4,16} and quantum-enhanced plasmonic sensors.^{17,18} However, obtaining such resolution necessitates picometer (pm)¹² or millidegrees (mdeg) phase¹⁶ accuracy or a complex quantum-enhanced optical path¹⁷ to determine the sensing parameters.

The emergence of zero-reflection points (ZRPs) opens a novel avenue for enhancing the performance of label-free optical sensors¹⁹⁻²¹. ZRPs refer to the occurrence of zero amplitude and phase singularities in the light reflected from an object at specific photon energies and angles of incidence (AoI). According to Jordan curve theorem²², there always exists at least one intersection point between the zero-reflection line and the material dispersion curve. As a result, the condition for ZRPs generation remains topologically protected within a closed finite space, giving rise to the concept of topological ZRPs.^{23,24} The phase singularities result in a steep π jump in reflection phase spectra, offering high-resolution sensing capabilities.^{20,21} Topological ZRPs have been observed in multilayer stacks^{23,25}, two-dimensional (2D) nanomaterial hybrid systems²⁰, and metasurfaces^{26,27}. While originally demonstrated for p-polarized light, such as p-polarization in a three-dimensional metamaterial²⁸, it is worth noting that topological ZRPs can also manifest in other polarization states, including for example, s-polarization in a short-range-ordered nano-plasmonic layer²⁷, and both polarizations in multilayer stacks^{23,29} and metasurface devices³⁰. Compared to multilayer stacks, metasurfaces are more competitive in sensing applications due to their rough surface nanostructures.³¹

Metasurfaces consist of subwavelength plasmonic or photonic nanostructures, capable of manipulating light properties such as phase, amplitude, and polarization by tailoring the arrangement of the nanostructures.³² The fabrication of metasurfaces mainly relies on established methods such as electron beam lithography, focused ion beam lithography³³, and nanoimprint lithography³⁴. Despite their great potential for advanced applications, the cost-effective fabrication of metasurfaces on a large scale remains a significant challenge. Consequently, lithography-free metasurfaces are attractive due to their advantages of simple fabrication, large scalability, and cost reduction.

According to some embodiments of the invention, a four-layers lithography-free plasmonic-photonic metasurface enabling a 9.5×10⁻⁹ RIU resolution is introduced. The multilayer stack, comprising two metal layers (for example, silver, Ag) and two dielectric layers (for example, Aluminium Nitride, AlN) are intercalated and deposited on a glass substrate by magnetron sputtering. The final configuration, glass/Ag₁/AlN₁/Ag₂/AlN₂, is optimized to experimentally observe the overlap of two mutually orthogonally polarization ZRPs that intersect to create an extremely narrow spectral contrast, 2 nm full-width-at-half-maximum (FWHM), in the polarization response with corresponding phase singularities. The conditions for such ZRPs to arise in this multilayer stack are analyzed and the overlap of these points is discussed in the context of a broader family of hybrid plasmonic-photonic multilayers. In general, the materials that can be used for the stacks are not limited to those considered in this disclosure. Structures composed of various plasmonic and photonic materials can show the same of ZRPs overlap phenomenon, as long as the dispersion properties and thickness are properly selected. The experimental results are validated by numerical calculations, including Fresnel equations (FE) as well as the vectorial Finite-Difference Time-Domain (FDTD) method.

Four main advantages of the proposed sensor design over other plasmonic and photonic platforms are highlighted: (1) The hybridization of SPPs and photonic waveguide (PWG) resonances in p-polarization achieves enhanced penetration depth and low optical loss, which benefits the suppression of reflection and abrupt phase jump. (2) The incorporation of s-polarized PWG modes is well suited for detection by ellipsometry as it eliminates experimental errors in intensity-based schemes such as transmission and reflection, for example, by using the ratio of p- to s-intensities. In addition, the overlap of p- and s-polarized ZRPs leads to significant variations in the amplitude ratio (Ψ) and phase difference (Δ) spectra, which contribute to sensitivity enhancement and facilitate high-resolution sensing. (3) Unlike the smooth surface of traditional SPR sensors, the presence of the metasurface with a large surface area enables the accommodation of a significant number of molecules, thus increasing the interaction between light and target molecules and improving overall sensing performance. (4) The lithography-free metasurface fabrication via magnetron sputtering offers advantages of simplicity, scalability, and cost-effectiveness compared to conventional lithography technology, and elevates stability relative to integrated self-assembly methods²⁶.

To further verify the biocompatibility of the proposed sensing system, it is demonstrated the affinity binding between ampicillin (molecular mass <500 Da), a penicillin-based antibiotic, with its specific aptamer. The sensor signals exhibit a linear response within the concentration range of ampicillin from 1 fM to 1 nM on a logarithmic scale. Combining advantages of ultrahigh sensitivity, record-breaking LoD, superior stability, and large surface area, this biosensing platform holds great promise for the detection of biomolecules for practical real-time clinical diagnosis.

### Results

### Experimental Demonstration of ZRPs Intersection

To experimentally demonstrate the topological ZRPs of both p- and s-polarizations from the metasurface multilayer, spectroscopic ellipsometry (Methods) is used. The spectroscopic ellipsometry simultaneously obtains the amplitude ratio (Ψ) and phase difference (Δ) between the two polarizations and expressed by:

$$tan ( Ψ ) {e}^{i Δ} = {\tilde{r}}_{p} / {\tilde{r}}_{s} \qquad Eq . ( 1 )$$

where \tilde{r}ₚ & \tilde{r}ₛ are the complex Fresnel reflection coefficients for light polarized parallel (p-) and perpendicular (s-) to the plane of incidence, that relate with the corresponding reflectance intensities as: Rₚ=|\tilde{r}ₚ|² and Rₛ=|\tilde{r}ₛ|².

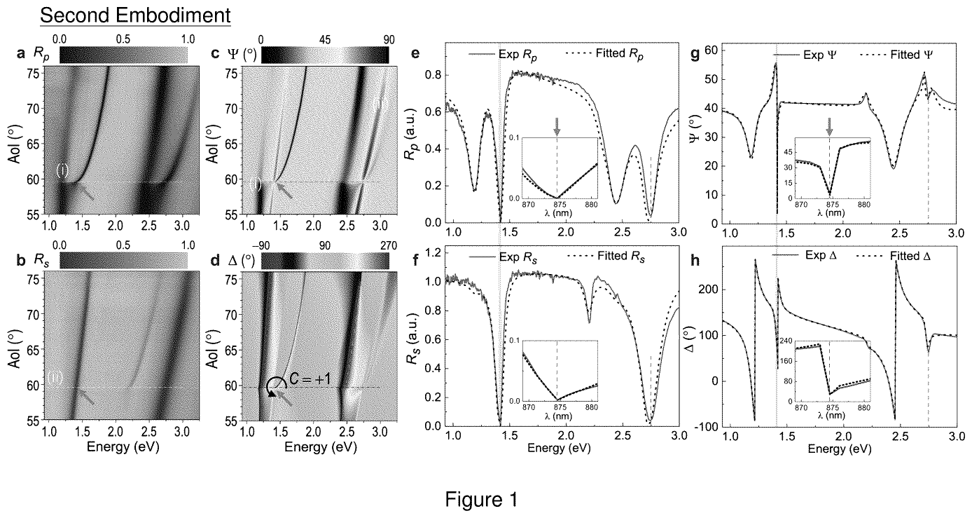

The concept of topological ZRPs is solely dependent on the effective dispersion curve of the material and does not impose any restrictions on the actual geometric shape.²⁰ It is found that the topological darkness phenomenon can be achieved by carefully selecting or designing an unknown film with appropriate optical constants with minimal constraints on the film quality.²⁴ The results show that reflection measured from glass-Ag₁—AlN₁—Ag₂—AlN₂-water stack in the Kretschmann configuration (see Supplementary Note 1) successfully achieves the ZRPs overlap of p- and s-polarized light, as displayed in FIG. 1. The regions (i) in FIG. 1a (Rₚ→0) and FIG. 1c (Ψ→0°) indicate the p-polarized ZRPs, while the regions (ii) in FIG. 1b (Rₛ→0) and FIG. 1c (Ψ→90°) represent the s-polarized ZRPs. Two direct crossings between the p- and s-polarized resonances are observed in Ψ at ~1.418 eV and ~2.748 eV for an angle of incidence (AoI) of 59.60°. Since the p-polarized ZRP has a narrower dip than the s-polarized ZRP, the reflection amplitude ratio, tan(Ψ)=\sqrt{|Rₚ|/|Rₛ|}, results in an extremely sharp minimum when these two orthogonally polarized ZRPs overlap. The resulting Ψ spectrum exhibits an asymmetric line-shape with a rapid transition between a dip and a peak, as shown in the gray region in FIG. 1g. This drastic narrowing spectra with down to 2 nm FWHM contribute to high sensitivity and facilitates high-resolution sensing with ultralow LoD.

However, the Ψ spectrum alone do not yet provide conclusive evidence of achieving a complete ZRP because of experimental errors and instrumental precision. To determine the presence of exact reflection zeros, the corresponding phase difference (Δ) can be combined. The behavior of Δ in FIG. 1d, h further supports the observation of a direct crossing between the p- and s-polarized ZRPs at ~1.418 eV or 874.5 nm, as it exhibits a sharp π phase jump near the ZRPs intersection and accumulates a phase of 2πC, where C represents the non-trivial topological charge associated with the phase singularity.²⁰ The phase singularities possess topological charges of C=+1, revealing the preservation of the total topological charge within the system. In contrast, another intersection at ~2.748 eV lacks a distinct topological charge in the phase map because it does not reach absolute zero. Profiting from a sharp phase jump with the topologically protected feature, the proposed system can offer a greatly improved sensing performance in terms of sensitivity and dynamic range.²⁹

### Mechanism Illustration of Hybrid Plasmonic-Photonic Mode

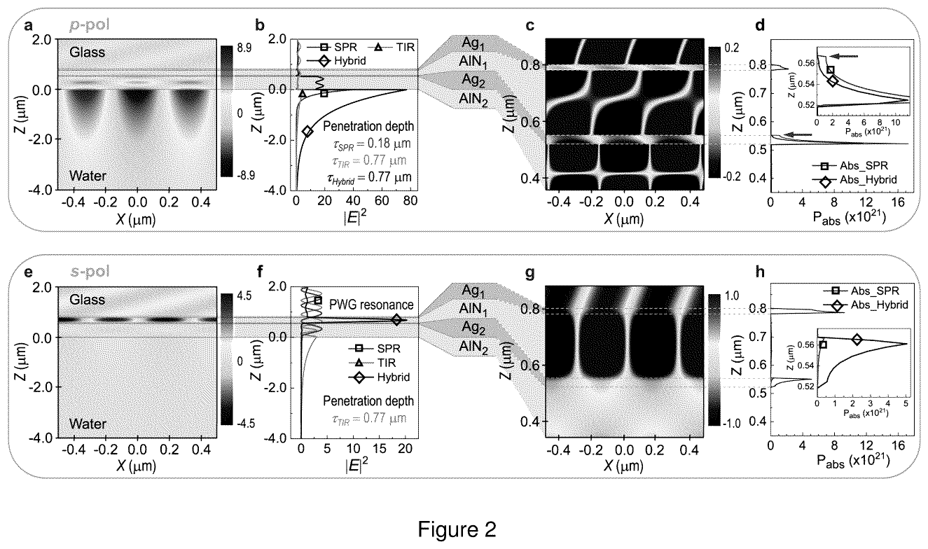

The ZRPs intersection at ~1.418 eV (874.5 nm) and 59.60° AoI exhibit distinct spectral contrasts in both Ψ and Δ, as will be discussed shortly, and are therefore the first focus of this section. To gain a deeper understanding in their nature, the electric fields at this location are calculated using the FDTD method. The resulting near-field distributions in the x-z plane for the proposed device, glass-Ag₁—AlN₁—Ag₂—AlN₂-water, are displayed in FIG. 2. Note that Bloch Boundary Conditions (BBC) is used over the simulation volume (x, y, z) of (1000, 6, 6,000) nm³ to model the optical response to plane waves incident from the glass side in either p- or s-polarization (modelled separately, see Methods section). Under p-polarization, a distinctive evanescent field distribution is observed at the AlN₂-water interface (FIG. 2a) with a corresponding |E_{z}|² line profile (FIG. 2b) decays exponentially on the water side. This phenomenon arises from the existence of a confinement region within the AlN₂ layer where the optical density is highly concentrated, while outside this region, a tail of the optical field extends in the form of an evanescent wave. The electric field line profile can be used to evaluate the penetration depth of the sensor. The depth of penetration is defined as the distance from the surface where the intensity of the evanescent wave decays to 1/e (~37%) of its maximum value. A higher penetration depth indicates an enhanced evanescent field in the sensing medium, indicating a greater interaction volume of the sensor³⁵. FIG. 2b presents a comparative analysis of the evanescence depths for the proposed system, standard SPR (45 nm Ag) and TIR (AlN₂/water). The respective characteristic decay lengths are 0.77 μm, 0.18 μm, and 0.77 μm, respectively. When light propagates from a denser medium (glass/AlN₂) to a less dense medium (water), TIR phenomenon occurs, and all light is reflected, but an evanescent wave is generated in the less dense water medium. Here, the penetration depths of the evanescent waves in TIR and hybrid systems are the same (0.77 μm), but the electric field intensity and absorption power (Supplementary Note 2) of the TIR system are much smaller than that of the hybrid system because there is no silver film. In addition, because the PWG mode in AlN₂ layer is not well confined and no plasmonic material is present, the electric field distributions for p- and s-polarizations exhibit the same TIR behavior, resulting in similar evanescent waves. Therefore, the observed increase in the evanescence depth compared to conventional SPR is attributed to the introduction of the dielectric top layer (AlN₂) whose RI exceeds that of the sensing layer, thereby significantly amplifying the electric field intensity. Similar effects have been demonstrated in WCSPR^{15,36} and nearly guided wave SPR (NGWSPR)^{14,37} systems. The key difference between WCSPR and NGWSPR is the thickness of the additional dielectric film. The WCSPR configuration employs a dielectric-metal-dielectric stack incorporating a thick waveguide layer (typically 400-500 nm) on the metal layer.¹⁵ Whereas the NGWSPR integrates an additional 10-20 nm high RI silicon layer between the metal layer and the analyte medium. Experimental results have shown that these structures effectively enhance both the electric field and penetration depth within the sensing medium, thereby improving the sensitivity of the sensors.¹⁴

The p-polarized mode in the system is a hybridization of plasmonic and photonic mode. This configuration offers a significant advantage by minimizing energy losses through the reduction of direct interaction between light energy and the metal. This is accomplished through the strategic incorporation of a waveguide layer above the Ag₂ layer. In this arrangement, Ag₁ acts as a semi-transparent metallic mirror, allowing efficient light propagation within the AlN₁ layer. This configuration modifies the photonic density of states and consequently alters the radiative damping rate, effectively decreasing the absorption within the Ag₂ layer as indicated by the arrows in FIG. 2d. In summary, due to the addition of high RI dielectric top layer AlN₂, and the reduced loss of Ag₂, the electric field of the hybrid mode demonstrates a maximum at the AlN₂-water interface. As a result, the combination of a plasmonic mode with two PWG modes on both sides enables the reduction in optical losses, the extension of penetration depth, and the enhancement of the electric field, thereby improving the sensing characteristics.

To highlight the unique properties of the hybrid plasmonic-photonic mode, it is compared with the s-polarized electric field distribution. Conversely, under s-polarization (FIG. 2e,f), the electric field resembles the pure PWG resonance case (see Supplementary Note 2), where an AlN₁ cavity formed by two Ag mirrors supports only a PWG mode, implying that all the electromagnetic energy is confined in the AlN₁ layer, with no light transmission into the underlying Ag₂—AlN₂-water structure. This behavior arises because only the p-polarized light can excite the plasmonic modes of the Ag₂ layer. Therefore, the s-polarized ZRP originates solely from the PWG mode, which is insensitive to the surrounding RI changes and can provide a stable self-reference ability. In contrast, the conventional SPR system (45 nm Ag) lacks the PWG resonance under s-polarization, resulting in the absence of self-referencing and the additional ZRPs, but also low absorption of energy (FIG. 2h). To verify these numerical results, a comprehensive investigation of the conventional SPR, pure WCSPR, and pure PWG configurations under p- and s-polarizations is conducted, as presented in Supplementary Note 2. The results show that the hybrid modes have greater evanescent field intensity and penetration depth into the sensing medium, thereby exhibiting higher sensitivity compared to the traditional SPR.

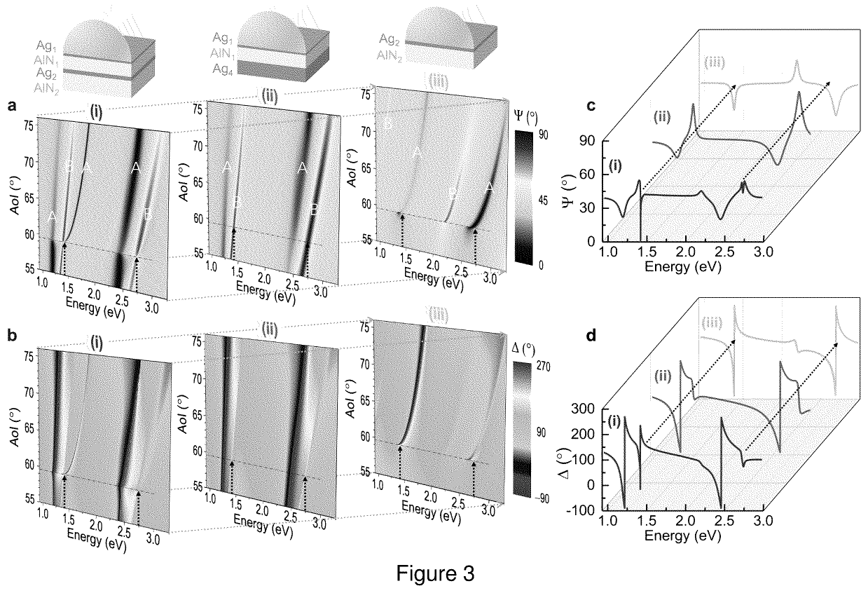

The polarized reflection characteristics from multilayer structures are calculated by solving Fresnel equations for that stack with the help of a commercial software CompleteEASE (J.A. Woollam Co. 5.15h).³⁸ To elucidate the origin of the intersection between p- and s-polarized ZRPs in the glass-Ag₁—AlN₁—Ag₂—AlN₂ multilayer system depicted in FIG. 2, the individual modes that constitute the hybrid plasmonic-photonic mode are examined. Specifically, the pure PWG resonances³⁹ and pure WCSPR^{10,13,35} are calculated and displayed in FIG. 3a,b (ii) and (iii), respectively. For comparison, the fitted results of the hybrid mode are shown in FIG. 3a,b (i). An efficient PWG resonance implementation is achieved in the glass-Ag₁—AlN₁—Ag₄ system. The Ag₁ layer acts as a semitransparent mirror to ensure light is transmitted to the underlying waveguide core layer. A 200 nm-thick Ag₄ layer effectively blocks further transmission. The pure WCSPR mode is obtained in the glass-Ag₂—AlN₂ structure, where the subscripts indicate that the thickness and dispersion curves of all layers remain unchanged from the hybrid system described in FIG. 1 and FIG. 3a,b (i).

FIG. 3 demonstrates that the intersection of p- (regions A in Ψ) and s-polarized resonances (regions B in Ψ) in the hybrid system originates from the overlap of separate WCSPR and PWG modes, as indicated by the black dotted arrows. Even if these individual modes are slightly shifted in the photon energy-incidence angle parameter space, they will still intersect, ensuring the robustness of the topologically protected overlapping effect between two orthogonally polarized ZRPs to external variations, such as roughness, thickness, and temperature fluctuations. If a perturbation is introduced to each mode, the displacement of the ZRPs will only cause a shift of their intersection, but without leading to the vanishment. Supplementary Note 3 demonstrates the effect of adjusting the thickness of each layer to control the relative displacement of individual modes. Supplementary Note 4 verifies the concept that the intersection of ZRPs does not disappear when the thickness of each layer is slightly changed. By manipulating the thickness or optical properties of each layer, the spectral location of the topological ZRPs intersection can be controlled. This generalization enables the extension of the intersection effect to other dielectric materials, as discussed in Supplementary Note 5. Remarkably, even in the presence of defects and voids, the orthogonally polarized ZRPs intersection effect remains universal across all plasmonic-photonic multilayers.

### Characterization of the Metasurface Multilayer

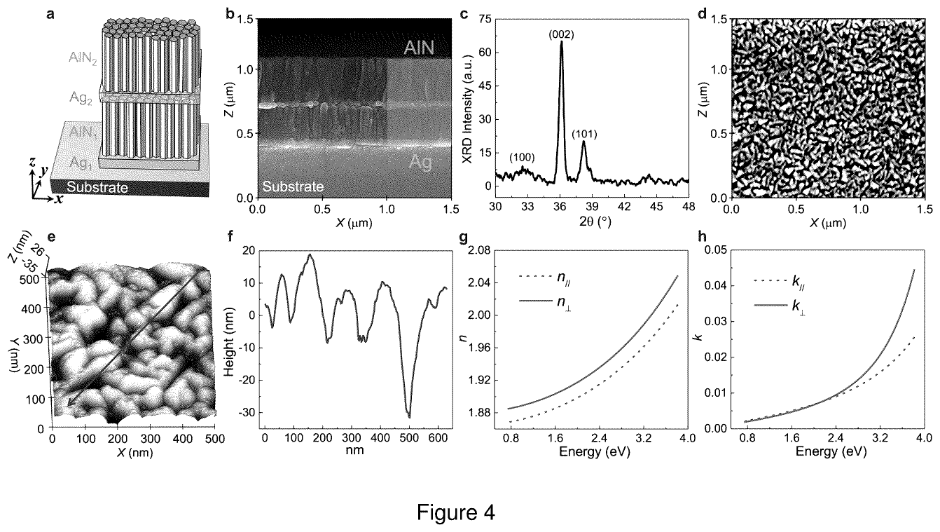

Plasmonic-photonic metasurface multilayers exhibiting ZRPs intersection are fabricated in one-step at room temperature by the sequential deposition of Ag₁, AlN₁, Ag₂, and AlN₂ layers on 1 mm-thick glass substrates via magnetron sputtering (Methods). The hexagonal wurtzite structure and high c-axis orientation of AlN^{40,41} result in a metasurface structure with voids, see illustration in FIG. 4a. A typical cross-sectional scanning electron microscopy (SEM) image of the multilayer in FIG. 4b confirms the presence of columnar growth mode. This observation is consistent with the predictions of the Structure Zone Model for sputtered thin films.⁴⁰ The nominal thickness of the multilayer as measured by the SEM is approximately Ag₁ (25 nm)/AlN₁ (260 nm)/Ag₂ (30 nm)/AlN₂ (330 nm). The crystallization and orientation of the metasurfaces were characterized using the X-ray diffraction (XRD) technique. The XRD spectrum in FIG. 4c displays a prominent peak validating a clear (002)-preferred orientation, which implies the hexagonal structure is perpendicular to the substrate with a pebble-like structure.^{40,41,42} The coexistence of mixed preferred orientations of (002) and (101) leads to different anisotropic growth rates on different lattice planes and contributes to the formation of facet structures and voids.⁴⁰ Next, the morphology of the metasurface multilayer is investigated by SEM and atomic force microscopy (AFM) as shown in FIG. 4d-f. The observed micro- and nano-surface areas indicate that the mixture of AlN and voids possesses a substantial specific surface area. This property enables efficient molecular adsorption, thereby enhancing the interaction between light and target molecules and improving overall sensing performance. The fabrication is through the sequential multilayer deposition, the metasurfaces can offer an expanded reactive area and reduced costs compared to conventional lithography approaches, and provide better stability than the self-assembled metasurfaces methods.

Since the metasurface with high c-axis orientation is a natural optically anisotropic uniaxial material, the anisotropic model is utilized to perform regression analysis on the measured Ψ and Δ spectra using the commercial software CompleteEASE (Methods). In the analysis, layer thickness, surface roughness, and non-uniformity are considered and correlated with the SEM and AFM results, and the fitting procedure aimed to minimize the mean squared error (MSE) as a measure of fitting accuracy. The effective RI of the AlN-voids mixture is determined via the Bruggeman effective medium approximation (EMA).⁴³ Considering the Z direction along the c-axis (refer to FIG. 4a for the reference frame), the in-plane RI is denoted as nₓₓ=n_{yy}=n_{∥}, while the out-of-plane RI is n_{zz}=n_{⊥}. Similarly, the in-plane extinction coefficient is kₓₓ=k_{yy}=k_{∥}, and the out-of-plane is k_{zz}=k_{⊥}.⁴⁴ Through the best-fit regression, the dispersions of the anisotropic RI and the extinction coefficient for both components are derived and presented in FIG. 4g,h, respectively. As expected, the metasurface exhibits uniaxial anisotropy with the out-of-plane RI (n_{⊥}) being higher than the in-plane RI (n_{∥}). The extinction coefficient shows an anisotropic response starting from ~2.4 eV. The obtained results are in reasonable agreement with previous reports.^{44,45}

### Metasurface Multilayers for Sensing

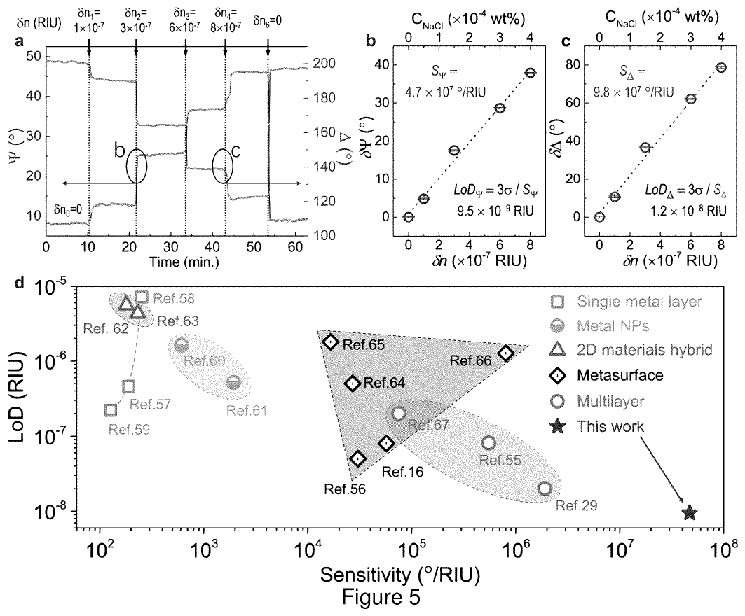

As previously noted, the overlap of p- and s-polarized ZRPs gives rise to an asymmetric line-shape characterized by an exceedingly narrow dip width in Ψ (down to 2 nm), and an abrupt phase jump in Δ. These unique features can serve as highly sensitive indicators for detecting minute variations. It is demonstrated that the plasmonic-photonic metasurface multilayer is an ultra-sensitive sensor that benefits from the sophisticated spectral contrast observed in the vicinity of the ZRPs intersection. FIG. 5 shows a calibration experiment of measuring a batch of sodium chloride (NaCl) in ultrapure water (UPW) with gradient concentrations from 0.00005 wt % to 0.0004 wt %. The corresponding net RI variations (δn) range from 1×10⁻⁷ to 8×10⁻⁷ RIU, as calculated from Refs.^{46, 47}. Bulk sensing response is monitored in real-time by tracking the variations in Ψ and Δ relative to each RI change. A linear fit of the average changes in Ψ and Δ for RI variations, depicted by dashed lines in FIG. 5b,c, yielded an amplitude sensitivity of S_{Ψ}=4.7×10⁷°/RIU and a phase sensitivity of S_{Δ}=9.8×10⁷°/RIU, respectively. Remarkably, the amplitude sensitivity is comparable to the phase sensitivity, which is unusual for other plasmonic sensors.^{3,48} To the best of our knowledge,^{49,50} this is the first experimentally achieved so far. This improvement can be attributed to the exceptionally narrow dip width of Ψ, as well as the synergistic interplay between the p- and s-polarized ZRPs in ellipsometric space. By the definition of Ψ, even minor height changes in the p-polarized ZRP are greatly amplified in Ψ because it is measured against a sharp but steady reference s-polarized ZRP. Noteworthy, both the amplitude and phase sensitivity of our system surpasses that of the cutting-edge phase-sensitive sensors.^{48,50}

Optical sensors are typically evaluated based on their sensitivity and LoD. According to the recommendations of IUPAC⁵¹ and most analytical researchers, LoD can be estimated from the calibration curve using:

$$L o D = 3 σ / S \qquad Equation ( 2 )$$

where σ is the noise level of the signal, 3σ represents the confidence level of measurements greater than 99%, and S is the sensitivity.⁵² This is only accurate when the calibration curve is linear and shows no hysteresis or saturation.⁵³ It is noted that the noise level of commercial ellipsometry under the attenuated total reflection (ATR) method is relatively high, as it is generally designed for the optical characterization of thin films rather than sensing.¹⁶ In the experiments, the standard deviation is obtained by repeatedly measuring a blank sample and different concentrations and performing low-pass filtering.⁹ The noise characterization is displayed in Supplementary Note 7. The results show that the average noise level at each stage is around 0.149° in Ψ and 0.392° in Δ. Consequently, it can be safely derived that the LoDs of the system are LoD_{Ψ}=3σ/S_{Ψ}=9.5×10⁻⁹ RIU and LOD_{Δ}=3σ/S_{Δ}=1.2×10⁻⁸ RIU, while plasmonic sensors normally achieve a LoD of ~10⁻⁶-10⁻⁷ RIU,^{18,54} a few can reach to 10⁻⁸ RIU region.^{16,29,55,56} To highlight the advantages of the system, the LoD and sensitivity of the plasmonic-photonic metasurface multilayer are compared with that of previously reported advanced label-free optical sensors based on single metal layers⁵⁷⁻⁵⁹, metal nanoparticles^{60,61}, two-dimensional (2D) material hybrid systems^{62,63}, metasurfaces^{16,56,64-66}, and mulilayers^{29,55,67}, as depicted in FIG. 5d. The proposed sensor outperforms other optical sensors and thus has great potential in addressing societal needs (e.g. clinical therapy, medicines monitoring) due to its low cost, ease of fabrication, and powerful capabilities.

### Detection of Small Biological Molecules

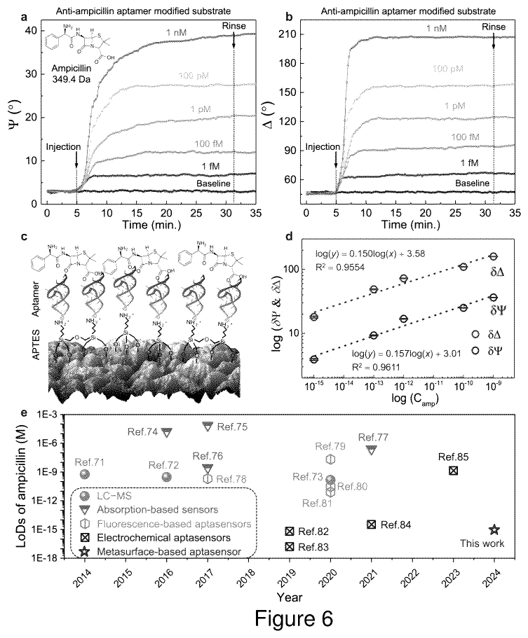

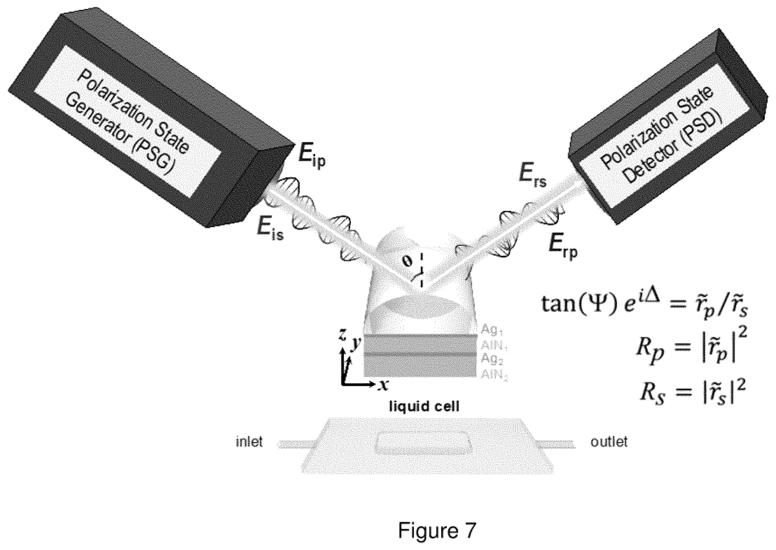

To evaluate the applicability of metasurface multilayers for biosensing⁶⁸, a well-established method involving silane chemistry⁶⁹ and aptamer bioconjugation is employed to immobilize ampicillin (molecular mass=349.4 Da), a penicillin antibiotic, on the sensor surface. This is to be taken only as an example of functionalization (there are countless others and many more will continue to be developed). The anti-ampicillin aptamer probe is used as the biological recognition element. Aptamers are synthetic short sequences of oligonucleotides that can selectively bind to antibiotics and targeted proteins with high affinity due to their conformation and charge distribution.⁷⁰ Briefly, the metasurface is modified with an ethanolic solution of 1 mM (3-aminopropyl)triethoxysilane (APTES) for 30 minutes at room temperature to form positively charged amine linkers. Then the multilayer is washed several times with ethanol and UPW and blow-dried with nitrogen gas to remove any excess molecules. The experimental protocol for ampicillin detection utilizing a metasurface-based aptasensor is implemented as follows: The multilayer is subsequently functionalized with a solution containing 100 nM thiolated anti-ampicillin aptamers overnight. The specific sequence is CACGGCATGGTGGGCGTCGTGTTTTTTTTTTTTTTT-3′ with the thiol groups on the 3′ end. The anti-ampicillin aptamers are immobilized on the metasurface based on electrostatic attraction between the thiolated ends and aminosilane. Subsequently, the device is ready for ampicillin detection assays. UPW is delivered to the microfluidic chamber at a controlled flow rate of 0.1 mL/min, facilitated by a syringe pump, while the Ψ and Δ signals are recorded in real-time, as illustrated in FIG. 6a,b. After signal stabilization (~5 min), different concentrations of ampicillin are injected into the chamber and incubated for 25 minutes. To verify the efficacy of the bioconjugation results, the chamber is thoroughly flushed with UPW. The signals remain unchanged or even increase after UPW rinse, indicating successful bio-binding interactions and the metasurface's ability to accommodate large numbers of molecules. FIG. 6d demonstrates a linear correlation between sensor signals and ampicillin concentration ranging from 1 fM to 1 nM on a logarithmic scale. Multiple measurements are conducted for each ampicillin concentration to ensure reproducibility. Notably, both amplitude and phase changes observed at 1 fM concentration exceed the baseline noise levels depicted in FIG. 6a,b, confirming a LoD of lower than 1 fM. To evaluate the detection performance, a comparative analysis is conducted against previously reported ampicillin detection techniques, including liquid chromatography-mass spectrometry (LC-MS)⁷¹⁻⁷³, absorption-based sensors⁷⁴⁻⁷⁷, fluorescence-based aptasensors⁷⁸⁻⁸¹, and electrochemical aptasensors⁸²⁻⁸⁵. The performance of the developed sensor is either significantly superior to or comparable to the reported ampicillin detection methodologies.⁸⁶ The results elucidate the superb performance of the developed sensor, especially its excellent LoD for low molecular weight analytes (<500 Da). These characteristics make this sensor a powerful tool for antibiotic residue detection and clinical diagnostic applications.

### Discussion

The embodiments of the invention demonstrate an optical sensing platform that utilizes the intersection of topological ZRPs for p- and s-polarizations. Such an intersection leads to a significant narrowing of amplitude ratio (Ψ) spectra down to 2 nm FWHM, as well as the presence of phase singularity in phase difference (Δ) as observed through SE. These achievements are based on a lithography-free, plasmonic-photonic metasurface multilayer. The greatly enhanced spectral contrasts both in Ψ and Δ exhibit ultrahigh sensitivities and reduced LoDs. The experimentally measured sensitivities are S_{Ψ}=4.7×10⁷°/RIU for Ψ and S_{Δ}=9.8×10⁷°/RIU for Δ, respectively. The estimated LoDs for the proposed system are LoD_{Ψ}=3σ/S_{Ψ}=9.5×10⁻⁹ RIU and LoD_{Δ}=3σ/S_{Δ}=1.2×10⁻⁸ RIU, which are one or two orders of magnitude better than previously developed label-free optical sensors. The suitability of the metasurface multilayer is evaluated for biosensing applications involving ampicillin with a molecular mass of less than 500 Da. Through the implementation of aptamer bioconjugation, the proposed aptasensor demonstrates a LoD of lower than 1 fM. By leveraging the superb LoD, stability, and large surface area of metasurface architecture, the proposed sensor based on topological ZRPs intersection opens new avenues for the development of versatile platforms for ultrasensitive biosensors.

### Methods

### Sample Fabrication

In some embodiments, the plasmonic-photonic metasurface multilayer is fabricated in one-step at room temperature by the sequential deposition of Ag₁, AlN₁, Ag₂, and AlN₂ layers on 1 mm-thick glass substrates via magnetron sputtering (PRO Line PVD 75, Kurt J. Lesker). The Ag layers are deposited using direct current sputtering of the Ag target and Argon gas at 3 mTorr. The AlN thin films are deposited by direct current reactive magnetron sputtering using an Al target in a mixed gas ambient of 8.3 sccm of N₂ and 11.8 sccm of Argon at 4 mTorr. Supplementary Table 1 summarizes the deposition parameters.

### Ellipsometry Measurements

The polarized reflectivity spectra (Rₚ and Rₛ) and ellipsometry parameters (Ψ and Δ) are obtained in the attenuated total reflection (ATR) geometry using a BK7 glass half-cylindrical prism (14 mm radius) via the variable-angle spectroscopic ellipsometry (M-2000DI, J.A. Woollam Co.). The ellipsometry is also used to determine the thicknesses and optical constants (n and k) of the as-fabricated metasurface multilayer. The simulation of ellipsometric data and regression fit are performed using the commercial software CompleteEASE (J.A. Woollam Co. 5.15h).

### FDTD Simulation

The near-field distribution of the multilayer is simulated by the FDTD solution software package (Lumerical, 2021 R2.3). The optical properties of each layer are obtained by ellipsometry. A plane wave light source is injected into the multilayer structure from the prism side. In the direction of light propagation, a perfectly matched layer boundary condition is applied. In the plane perpendicular to the light propagation direction, periodic Bloch boundary conditions (BBC) are applied over the simulation region (x, y, z) of (1000, 6, 6,000) nm³ to model the optical response to incident plane waves in either p- or s-polarizations separately. The mesh size is chosen as 1 nm after convergence tests. A power and profile monitor are placed along the light propagation direction to visualize the electric field distribution in the (x, z) cross-section of the multilayer.

### Scanning Electron Microscopy

The cross-section and surface structures after a thin gold coating are characterized by scanning electron microscopy (SEM, ZEISS EVO 18). Thickness and voids analysis are conducted by ImageJ and are presented in Supplementary Note 8.

### Atomic Force Microscopy

The surface morphology of the metasurface is characterized using an atomic force microscope (AFM, MultiMode 8-HR Bruker) in a tapping mode at ambient conditions. Images of the metasurface are taken with 500×500 nm and a scan rate of 0.1 Hz, after that data are analyzed by NanoScope Analysis 3.00.

### X-Ray Diffraction

X-ray diffractometer (XRD, D2 PHASER Bruker) is used to characterize the crystallization and orientation of the metasurface. The XRD pattern is taken at ambient conditions by 20-scan over the range of 30°-80° with a step of 0.050 and accumulation time of 1 second, after that data were analyzed by MDI Jade 6.5.

### Supplementary Information for the Second Embodiment

### Supplementary Note 1: The Optical System

The experimental set-up is based on the attenuated total reflection (ATR) geometry using a BK7 glass half-cylindrical prism (14 mm radius) via the variable-angle spectroscopic ellipsometry (M-2000DI, J.A. Woollam Co.). A half-cylinder glass prism is used as the coupler to excite the surface plasmon polariton (SPP). Ellipsometry measures the p- to s-ratio of polarization intensities and their relative phase difference, corresponding to the ellipsometric angles Ψ and Δ. Although ellipsometry is more complex, it offers two significant advantages over standard surface plasmon resonance (SPR) techniques: (i) the extra s-polarization signals provide self-reference capability for the overall measurements, and (ii) it enables a phase measurement.¹ An ellipsometer or other suitable polarimetric instrument with a Polarization State Generator (PSG) and Polarization State Detector (PSD) enable quantification of Rₚ and Rₛ, such that their ratio

$$tan ( Ψ ) = \sqrt{\frac{{R}_{p}}{{R}_{s}}} ,$$

or other related polarimetric representations such as for example (N, C, S), can also be used.

### Supplementary Note 2: Electric Field Distribution

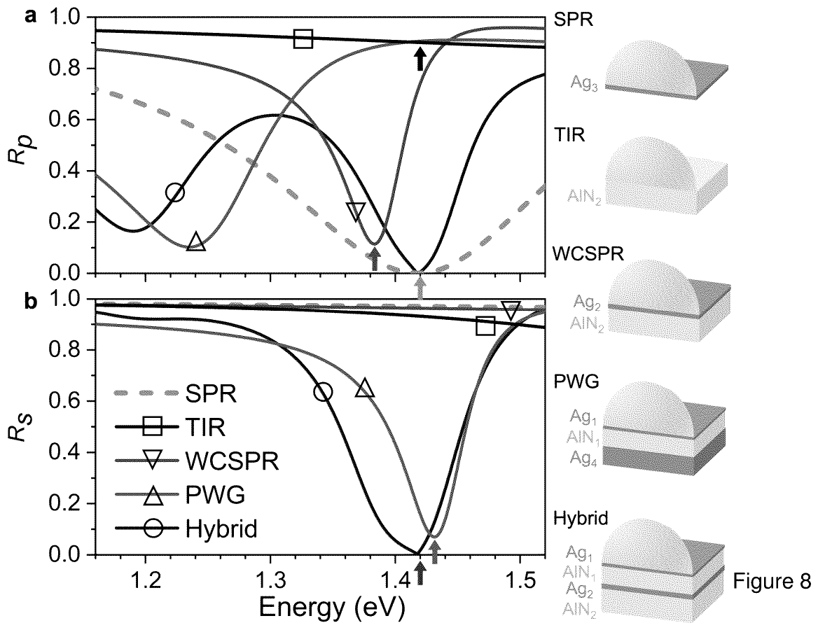

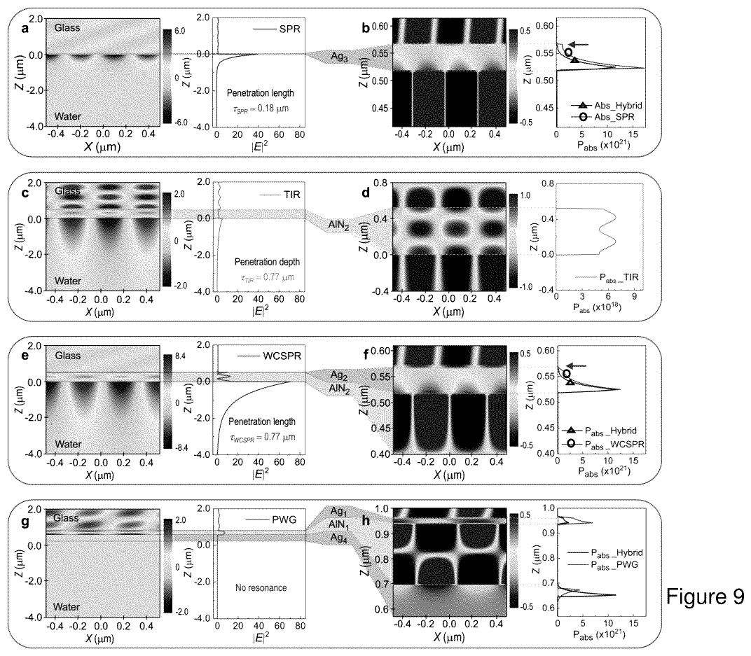

For comparative analysis, the simulated polarized reflectivity spectra and electric field distributions for p- and s-polarizations of the conventional SPR (Ag₃, 45 nm), pure total internal reflection (TIR), pure waveguide coupled SPR (WCSPR), and pure photonic waveguide (PWG) systems at similar wavelength and angle of incidence (AoI) are presented. The conventional SPR system (glass-Ag₃-water) exhibits lower evanescent field intensity and a smaller penetration depth (~0.18 μm) into the water medium, along with the largest absorption in the metal layer (the curve with circle in FIG. 9 b). The electric field distribution of pure TIR system (glass/AlN₂/water) are shown in FIG. 9 c, and the penetration depth (0.77 μm) of the evanescent wave is obtained. As expected, this value is the same as the penetration depth of the hybrid system because it depends only on the nature and AoI of the AlN₂/H₂O interface, however, also as expected, the electric field intensity and absorption power of the TIR system are much smaller than that of the hybrid system because there are no silver films supporting SPR effects. The pure WCSPR mode is obtained in the glass-Ag₂—AlN₂-water structure, where the subscripts indicate that the thickness and dispersion curves of all layers remain unchanged from the hybrid system described in the main text. The WCSPR exhibits comparable electric field intensity and decay length to the hybrid system. However, due to the absence of Ag₁ and AlN₁ layers, the coupling effect of WCSPR is weakened. The absorption in the Ag₂ metal layer is slightly larger than that of the hybrid system, especially on the glass side, similar to the conventional SPR system, as indicated by the arrows in FIG. 9 e,f. The pure PWG system is investigated in the glass-Ag₁—AlN₁—Ag₄ (200 nm)-water structure. However, the p-polarized PWG mode is weak because, as shown in the main FIG. 1 and FIG. 8, this wavelength and AoI cannot excite the p-polarized PWG resonance without changing the thickness of AlN₁. A few electromagnetic energy is stored in the AlN₁ region (FIG. 9 g,h). Therefore, under p-polarization, the hybrid system exhibits the greatest evanescent field intensity and penetration depth into the sensing medium, thereby demonstrating higher sensitivity compared to the traditional SPR and WCSPR system.²

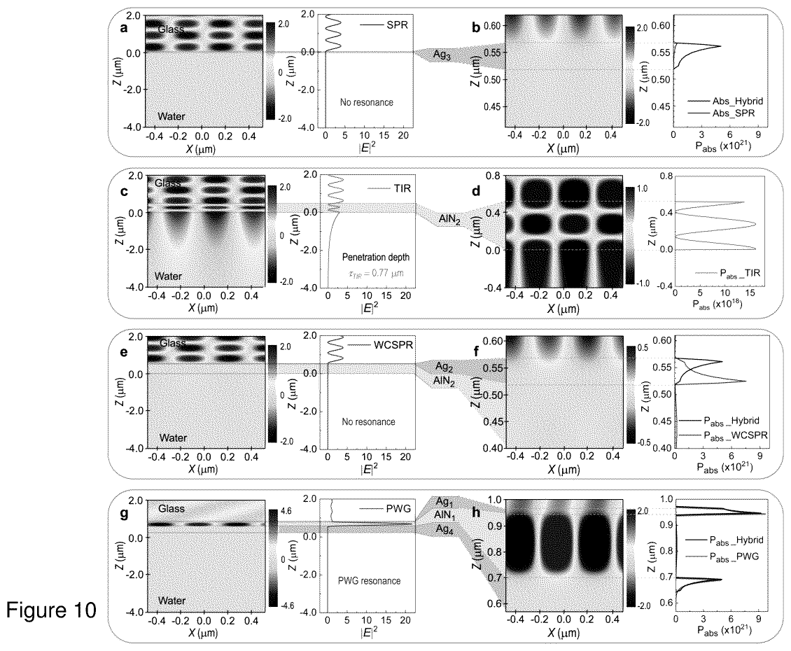

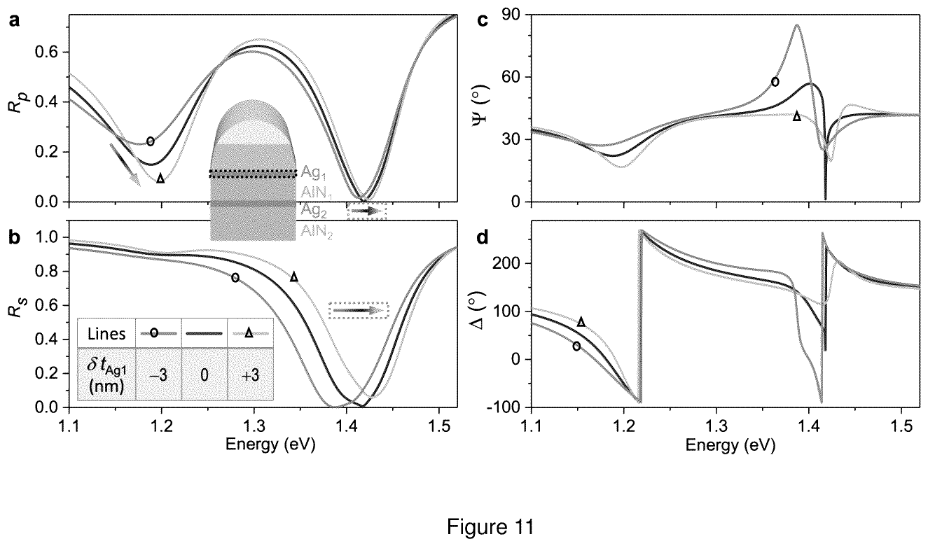

The conventional SPR system (glass-Ag₃-water) exhibits no resonance under s-polarization, resulting in the absence of self-referencing and additional zero-reflection points (ZRPs), but also low energy absorption (FIG. 10 b). In the pure TIR system (FIG. 10 c,d), because the s-polarized wave has not been attenuated in Ag₁, the electric field distributions for both p- and s-polarizations now extend into the water, exhibit the same TIR behavior, and result in similar evanescent decay length. The pure WCSPR mode (glass-Ag₂—AlN₂-water) also shows no resonance under s-polarization, but the absorption of Ag₂ layer increases because of the polarization charge generated by dielectric discontinuity at the material interfaces. The s-polarized electric field of pure PWG resonance case (glass-Ag₁—AlN₁—Ag₄-water) closely resembles that of the hybrid system, with only a PWG mode appearing in the AlN₁ layer. Hence, the electric field distributions confirm that the presence of p-polarized WCSPR & PWG modes, and s-polarized PWG modes in the hybrid system.

### Supplementary Note 3: Thickness Adjustments

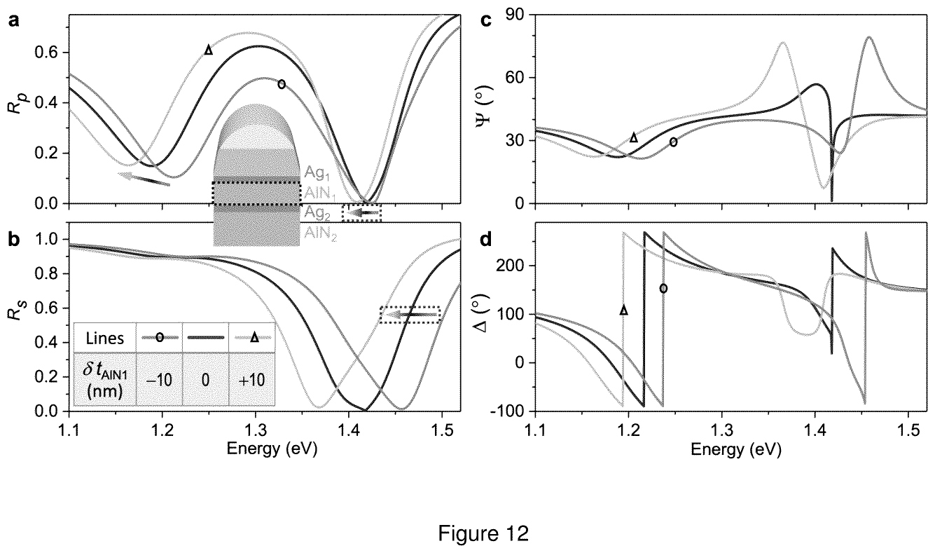

In the novel system described in the main text, the precise thickness of each layer is crucial for the design, because dispersion considerations are fundamental to achieving the overlap of p- and s-polarized ZRPs at a given photon energy (E) and AoI. To understand the thickness effect of each layer, simulations are performed to reveal the relationship between the displacement of dips and layer thickness for each polarization at 59.60° AoI. The Ag₁ layer (25 nm) is first investigated, and the corresponding changes in reflectance spectra Rₚ, Rₛ, and ellipsometric parameters Ψ, Δ are examined. As shown in FIG. 3 of the main text, the lower energy dip of the hybrid system comes from the hybrid PWG mode, while the higher energy dip comes from the hybrid WCSPR mode. The results show that as the Ag₁ thickness increases, all dips shift toward higher photon energies (i.e., the wavelength is blue-shifted), with the hybrid PWG mode experiencing a more significant change compared to the hybrid WCSPR mode. However, when the thickness of AlN₁ is increased (FIG. 12), contrary to the case for the Ag₁ layer, all dips move toward lower photon energies, that is, the wavelength is red-shifted. The degree of displacement for the hybrid PWG mode is also greater than that of the hybrid WCSPR mode. Therefore, by appropriately adjusting the thickness of Ag₁ and AlN₁, the left and right displacements of Rₚ and Rₛ can be controlled.

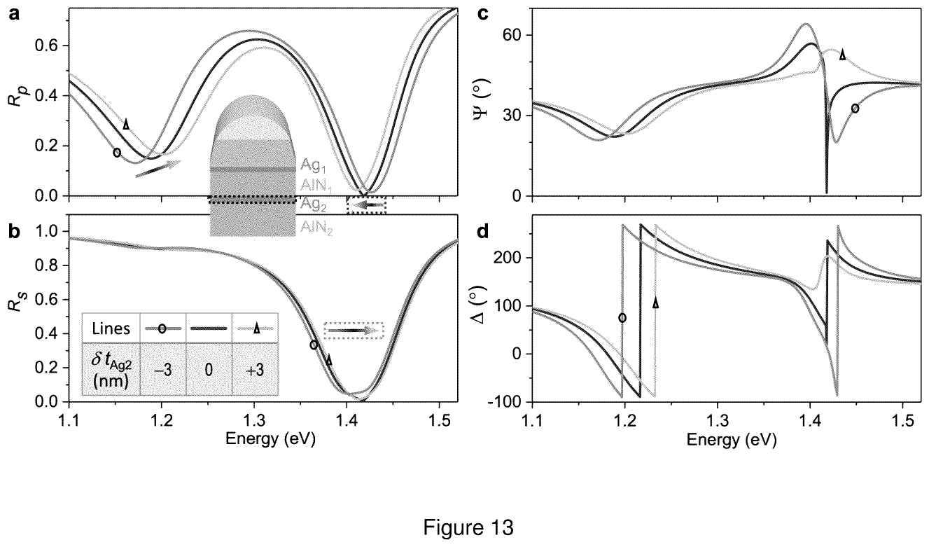

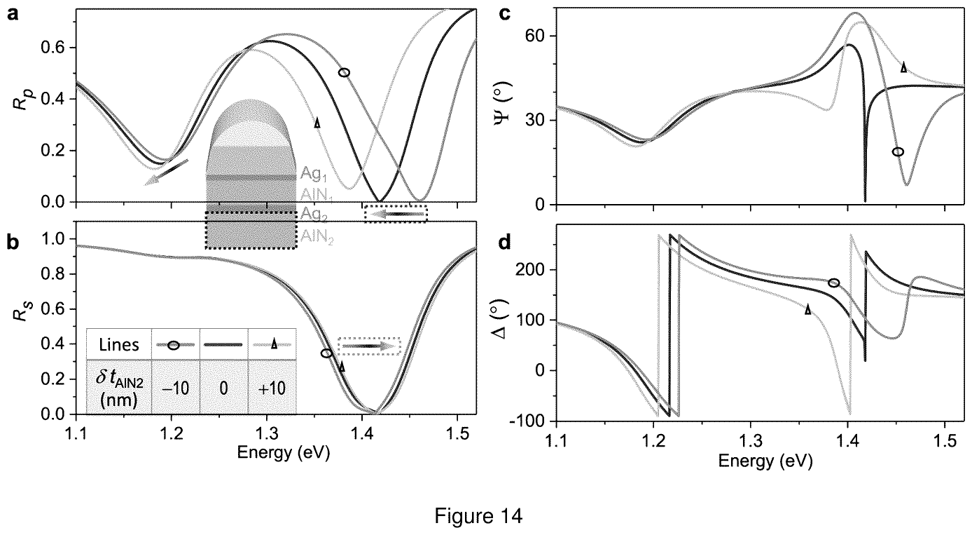

Upon increasing the thickness of Ag₂ and AlN₂ (FIGS. 13 and 14), the PWG mode in the Rₛ possesses an almost negligible blue-shift, while the Rₚ undergoes a significant change. When the Ag₂ thickness is altered, the hybrid WCSPR mode experiences a red-shift, whereas the hybrid PWG mode undergoes a more pronounced blue-shift. Conversely, when the AlN₂ thickness is changed, both the hybrid WCSPR and the PWG mode exhibit a red-shift, with the hybrid WCSPR mode experiencing a more significant shift. Therefore, overlap of p- and s-polarized ZRPs can be achieved by inversely adjusting the thickness of Ag₂ and AlN₂.

### Supplementary Note 4: Thickness Tolerance Analysis

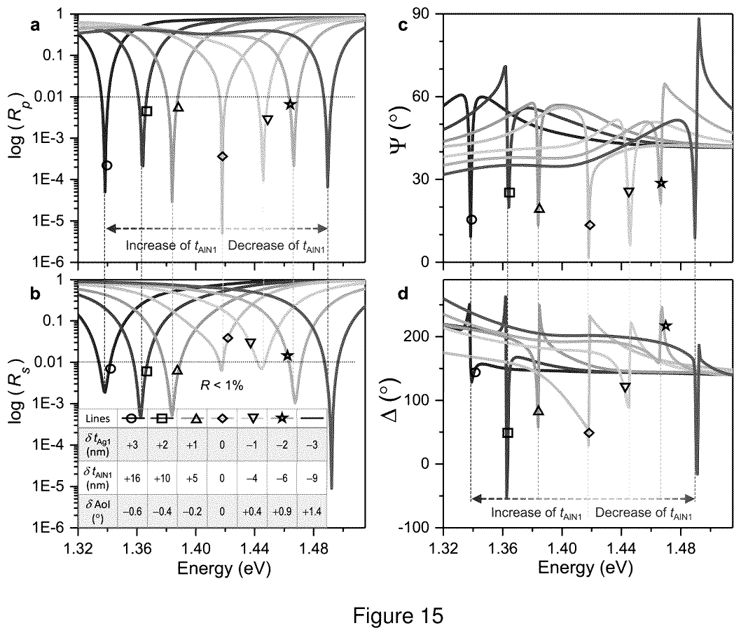

Because a zero-reflection surface can be formed in the hybrid system, such that small perturbations of the multilayer parameters (small changes in film thickness or dielectric permittivity) will not change the fact that the two orthogonally polarized ZRPs intersect at slightly different spectral position and AoI. The thickness tolerance analysis of Ag₁—AlN₁ two layers (25 nm-260 nm) are investigated at original incident angle of 59.60°, and the corresponding changes in reflectance spectra Rₚ, Rₛ, and ellipsometric parameters Ψ, Δ are examined, as shown in FIG. 15. The criterion for the existence of the ZRPs is defined as Rₘᵢₙ<1%. When the thickness perturbation is introduced to Ag₁—AlN₁ layer, the displacement of the ZRPs will only cause a shift of their intersection in the parameter space, but without leading to their disappearance. This behavior occurs because hybrid PWG modes are primarily supported in Ag₁—AlN₁—Ag₂ layers, and changing the thickness only affects the spectral position of the PWG mode, while fine tuning of Ag₁ can balance the amplitude. Consequently, AoI can be adjusted to obtain the overlap conditions of p- and s-polarized ZRPs. In these conditions, it can be concluded that the thickness tolerance for the Ag₁—AlN₁ two layers are relatively relaxed by tuning the AoI. A discussion on the tolerance of Ag₂—AlN₂ is in the next section.

### Supplementary Note 5: Dielectric Materials Analysis

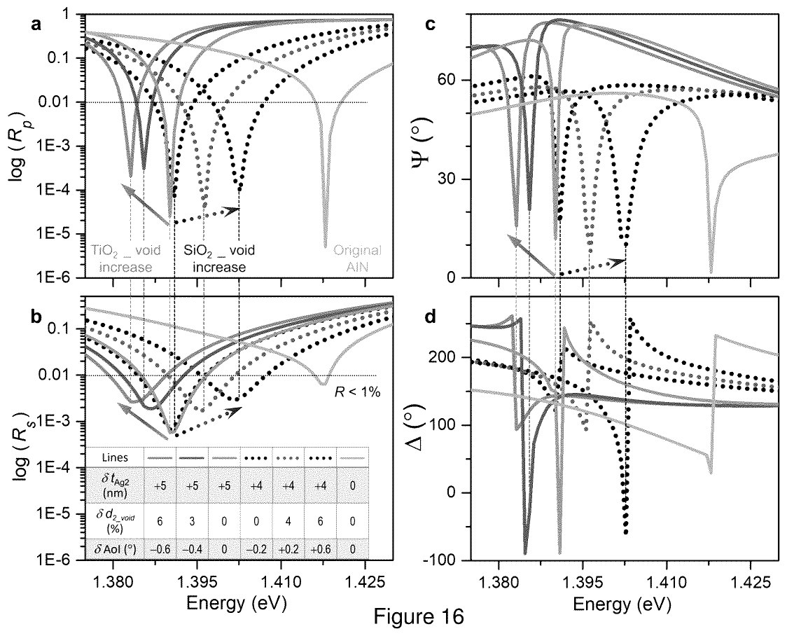

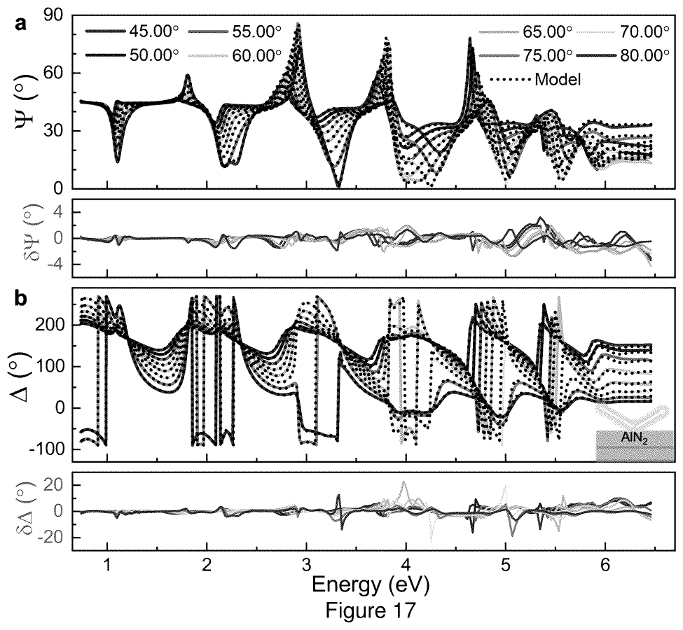

By manipulating the thickness or optical properties of each layer, the spectral location of the topological ZRPs intersection can be controlled. This generalization enables the extension of the intersection effect to other dielectric materials, as discussed in FIG. 16. The top dielectric material (dielectric₂, d₂) is changed from AlN (330 nm) to TiO₂ (293 nm) and SiO₂ (680 nm) at original incident angle of 59.600 to demonstrate the diversity of the design. The corresponding changes in reflectance spectra Rₚ, Rₛ, and ellipsometric parameters Ψ, Δ are examined. The effective refractive index (RI) of the d₂-voids mixture is controlled via the Bruggeman effective medium approximation (EMA). The criterion for the existence of the ZRPs is defined as Rₘᵢₙ<1%. When the void perturbation is introduced to d₂ layer, the displacement of the ZRPs will only cause a shift of their intersection in the parameter space, but without leading to their disappearance, AoI can be adjusted to re-align the p- and s-polarized ZRPs. Therefore, the orthogonally polarized ZRPs intersection effect remains universal across all plasmonic-photonic multilayers.

### Supplementary Note 6: Fitting of Ellipsometric Data

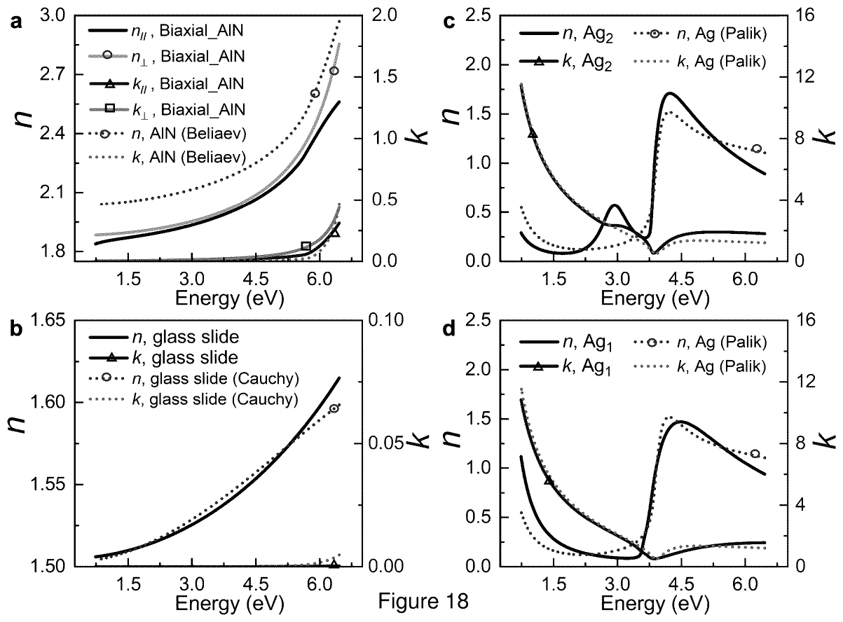

The fitted thickness of the multilayer only, without the prism, agrees well with the result measured from the cross-sectional SEM image, Ag₁ (25 nm)/AlN₁ (260 nm)/Ag₂ (30 nm)/AlN₂ (330 nm). The fitted surface roughness (~22.4 nm) is consistent with morphology measured by AFM. Based on these results, it is concluded that the fitting data are reliable for describing the optical properties, as shown in FIG. 18.

Some embodiments use Tauc-Lorentz oscillators

$$ε ( E ) = {ε}_{∞} + {ε}_{TL}^{′} + i {ε}_{TL}^{″} = {ε}_{∞} + \frac{2}{π} {\int }_{{E}_{g}}^{∞} \frac{ξ {ε}_{TL}^{″} ( ξ )}{{ξ}^{2} - {E}^{2}} d ξ + {iH}_{{E}_{g}} ( E ) \frac{1}{E} \frac{{AE}_{0} {Γ ( E - {E}_{g} )}^{2}}{{( {E}^{2} - {E}_{0}^{2} )}^{2} + {Γ}^{2} {E}^{2}}$$

to describe the electronic interband transition, Drude oscillator

$${ε}_{Drude} = \frac{- {ℏ}^{2}}{{ε}_{0} ρ ( τ {E}^{2} + i ℏ E )}$$

models to describe the metallic response at low photon energies, and Lorentz oscillators

$${ε}_{Lorentz} = \frac{{A}_{L}^{2}}{- {E}_{{L}^{2}} - {E}^{2} - i {Γ}_{L} E}$$

to describe the material absorption and silver plasmon polariton transitions^{3,4}, where ε_{∞} is a contribution in the dielectric function of high energy interband transition, v.p. is the Cauchy principal part of the integral with an additional fitting parameter ε_{∞} that is included, E is photon energy, E_{g} is optical band gap, H_{E}_{_{g}}(E) is Heaviside step function equal one if E>E_{g} and zero otherwise, E₀ is the optical transition energy at certain energy positions, A is amplitude, Γ is the spectral broadening parameter, h is reduced Planck's constant, ε₀ is vacuum permittivity, ρ is resistivity, and Ψ is scattering time. The uniaxial anisotropic response of AlN is analyzed by the anisotropic model. The regression fit of ellipsometric data is performed using the commercial software CompleteEASE (J.A. Woollam Co. 5.15h).⁵

SUPPLEMENTARY TABLE 1
The summary of deposition parameters of thin films.

| | Deposition | | | Power | |
|---|---|---|---|---|---|
| Thin | pressure | N₂:Ar flow | | density | Deposition |
| film | (mTorr) | (sccm) | Source | (W/cm²) | rate* (nm/s) |
| Ag | 3 | 0:20.1 | DC | 0.44 | 0.1 |
| AlN | 3 | 8.3:11.8 | RF | 3.3 | 0.05 |

*The deposition rate is calculated from the thickness measured by ellipsometry divided by deposition time.

### Supplementary Note 7: Noise Characterization

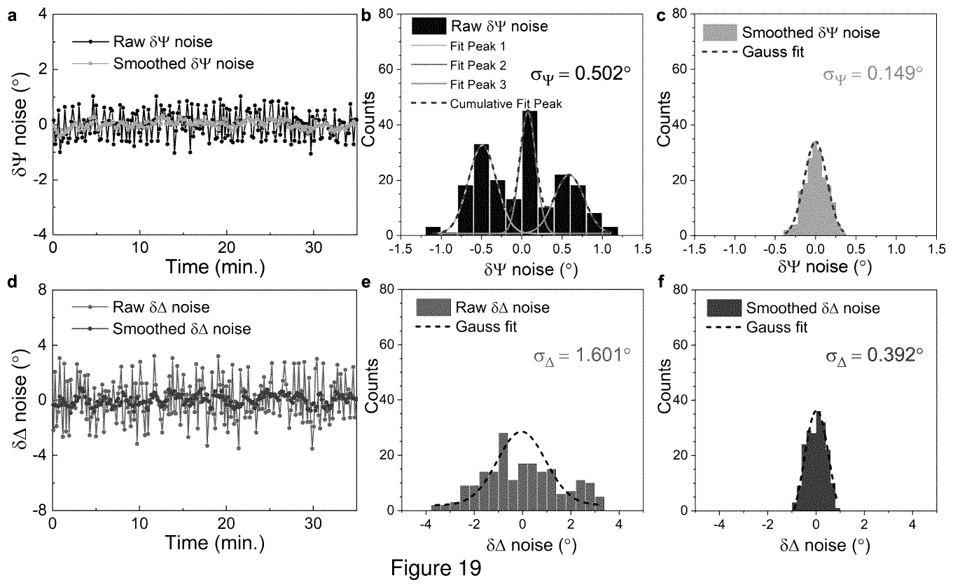

FIG. 19 presents the characterization of system noise under an ultrapure water medium. The dataset consists of 200 data points collected over 35 minutes. As shown in FIGS. 19 b and e, the raw data distribution exhibits a standard deviation of 0.5020 for Ψ and 1.601° for Δ. This is because commercial ellipsometers operating under the ATR method typically have relatively high noise levels, as they are primarily designed for the optical characterization of thin films rather than sensing applications.⁶ Due to the existence of digital signal receivers⁷ and bandwidth limitations, multiple discrete clusters are observed within the data distribution. After applying a smoothing filter, the standard deviation is significantly reduced to 0.1490 for Ψ and 0.392° for Δ. Consequently, the experimental noise level (3σ) is estimated to be 0.447° for Ψ and 1.1760 for Δ, respectively.

### Supplementary Note 8: SEM Image Analysis

The cross-section and surface structures after a thin gold coating are characterized by scanning electron microscopy (SEM, ZEISS EVO 18). Thickness and voids analysis are conducted by ImageJ, also known as Fiji, an open-source image processing software developed by the National Institutes of Health (NIH). To obtain the thickness of each layer, the cross-section SEM image (Main FIG. 4b) is analyzed by ImageJ. After converting the pixel size unit to metric units, the thickness is measured 5 times and presented in Supplementary Table 2.

SUPPLEMENTARY TABLE 2
The summary of each layer thickness measured by SEM.

| Measurements | Ag₁ (nm) | AlN₁ (nm) | Ag₂ (nm) | AlN₂ (nm) |
|---|---|---|---|---|
| 1 | 27.0 | 268.8 | 30.2 | 334.9 |
| 2 | 25.2 | 276.5 | 33.4 | 326.9 |
| 3 | 25.6 | 251.2 | 25.6 | 333.1 |
| 4 | 26.0 | 262.6 | 27.9 | 330.2 |
| 5 | 24.2 | 243.5 | 34.9 | 327.0 |
| Average | 25.6 | 260.5 | 30.4 | 330.4 |
| StDev | 0.9 | 11.9 | 3.4 | 3.2 |

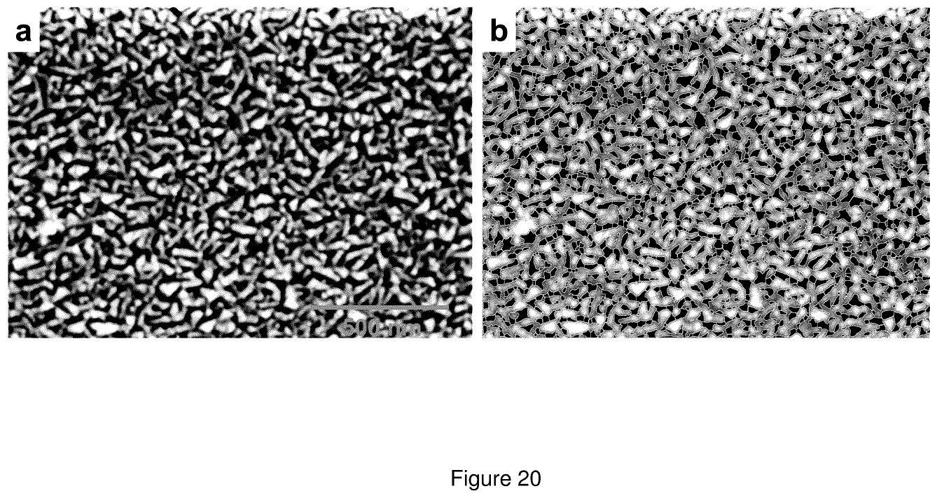

An innovative automated approach was employed for void estimation of the metasurface. The method comprises five primary steps: (1) conversion of pixel size units to metric units; (2) image segmentation; (3) morphological filtering to separate connected voids; (4) verification; (5) extraction of statistics from the detected voids.⁸ The algorithm utilizes a histogram-based thresholding technique to segment SEM images (Main FIG. 4d) into voids and non-void areas. A series of morphological filters are then applied to isolate connected voids, enabling the measurement of individual void dimensions and proportions. The analysis result, as shown in FIG. 20, demonstrates that the algorithm accurately identifies the boundaries where voids exist. The void proportion of metasurface is approximately 36%, with an average void size of 298.656 nm².

### III. Third Embodiment

Optical Venier Scale Sensing with Ultralow Limit-of-Detection and Large Dynamic Range by Tuning of Zero-Reflection Points

Optical sensors using zero-reflection points (ZRPs) enable excellent sensitivity due to the accompanying phase singularities and the steepest slope of the reflectivity curve. Here, the collaborative manipulation of three ZRPs in a simple platform formed by a lithography-free, metal-dielectric-metal structure with unsurpassed, experimentally demonstrated, limit of detection ≈2×10⁻⁸ refractive index unit is reported. The sensor relies on: i) strong coupling between p-polarized surface plasmon polariton and photonic waveguide, leading to reflection suppression, Rabi splitting and phase singularities; ii) simultaneous implementation of two orthogonally polarized ZRPs, enabling spectral overlap of s-polarized photonic modes (Rₛ) with the coupled p-polarized resonances (Rₚ); and iii) ellipsometry-based sensing where the s-polarized ZRPs provide a stable reference to boost the sensor performance in terms of the amplitude ratio and phase difference of Rₚ and Rₛ thereby naturally forming a refinement measuring scale akin to a Vernier scale. Remarkably, the precise manipulation of ZRPs enables resetting the sensor to its optimal sensing point. The capability is demonstrated for a biosensor of SARS-CoV-2 spike (S2) protein that can track the full functionalization process then reset to perform dose-dependent detection of the S2 protein. Some embodiments of the invention provide a new strategy for the development of optical sensors and perfect light absorbers.

### 1. Introduction

The complete suppression of reflection, sometimes known as point of darkness or reflection zero, is a subject of intense research in the study of parity-time metamaterials,^{[1,2]} topological darkness,^{[3,4]} perfect absorption materials,^{[5,6,7]} Brewster angle,^{[8,9]} and prism-coupled surface plasmon resonance (SPR),^{[10-12]} among others. This is because the zeros of the response function exhibit enhanced sensitivity due to the accompanying phase singularities^{[3]} and the steepest slope of the reflection curve.^{[11]} The information, encoded in the changes upon reflection of the electric field's amplitude, phase, and polarization, provides exquisite levels of detail on changes in the environment or the reflecting media itself. To date, however, the realization of reflection zeros requires careful design and control of experimental conditions, and the fabrication of complex structures, including, for example, two-dimensional (2D) materials assembly,^{[5,13]} advanced lithography techniques,^{[3-14]} or precise multilayer stacks.^{[6,15]} A simple planar multilayer with less than 4 layers is used to achieve the zero-reflection points (ZRPs) based on the principle of asymmetric Fabry-Pérot cavity.^{[15]} As expected, the reflection zeros in these optical systems are only observed under a very specific set of conditions, such as a certain incident angle and for specific spectral position and polarization states. To alleviate these limitations, a simpler thin film of organic molecules demonstrate all-optical control of the reflection zero induced phase singularities, using reversible photoisomerization to modify the molecules' permittivity and create a transition from weakly- to strongly-coupled regime thus enabling an on/off switch control of the point of darkness.^{[16]} Separately, an exciting path for tunability of the point of darkness is highlighted that relies on topologically protected reflection zeros arising from large resonances.^{[17]} This approach relies on two assumptions; first, the use of optical structures for which Fresnel equations allow small variations in the angle of incidence (AoI, θ), photon energy (E), and polarization without losing the resonance condition, and second, the dielectric permittivity (ϵ1, ϵ2) also vary continuously within a bounded region. In such conditions, a zero-reflection surface can be formed in the (E, ϵ1, ϵ2) space while relatively small perturbations of the dielectric permittivity will not change the fact that the material dispersion curve always intersects the zero-reflection surface but at slightly different spectral position.^{[7,17]} To date, the successful design and application of these and related strategies rely on single point of darkness, whereas the simultaneous use of multiple darkness points to achieve complex spectra for sensing has not yet been achieved.

Another strategy is the use of exceptional points (EPs) in non-Hermitian optical systems,^{[18]} because of the abrupt phase transitions and superior sensitivity when the EPs are located at ZRPs.^{[19]} Such extreme sensitivity arises in the vicinity of EPs, where perturbations leading to the lifting or retrieving of EPs degeneracies result in the splitting or merging of eigenenergies, which scale as ϵ^{1/N} to the perturbation (ϵ) in a system of N-eigenmodes.^{[20]} Therefore, splitting at an EP is exceedingly sensitive for a sufficiently small perturbation (ϵ<<1).^{[21]} Nevertheless, such sensors still suffer from a narrow sensing dynamic range, since each detection shifts the system away from the EP, therefore the sensitivity gradually decreases as the number of detections increases. This restricts the sensing dynamic range with an EP-enabled sensitivity unless the system is brought back to the EP after each detection.^{[18]}

Some embodiments of the invention experimentally demonstrate a lithography-free platform formed by a three-layer metal-dielectric-metal (MDM) structure that enables efficient control of one ZRP for s-polarization and two for p-polarization. It is shown that the ZRPs positions can be designed, using accurate knowledge of the optical properties of the multilayers' components, to enable the synergic collaboration of the surface plasmon polariton (SPP) and photonic waveguide (PWG) modes enabling: i) experimental observation of Rabi splitting^{[22-24]} and phase singularities that confirm the interaction between the SPP and PWG resonances corresponds to the strong coupling regime; ii) synchronous operation of the three ZRPs positions resulting in two optical Vernier sensing mechanisms akin to the concept invented by Pierre Vernier in 1631, for the use of a secondary scale in measuring instruments; iii) extreme sensitivity with a limit of detection (LoD)≈2×10⁻⁸ refractive index unit (RIU); and iv) ability to reset the Vernier scales to their optimal sensing operation points, via AoI tuning while keeping track of the total accumulated RIU change. The capability to combine an ultralow LoD over a very broad sensing dynamic range by this “tune and reset” strategy has not been experimentally performed up to now. The experimental results are fully validated using numerical simulations, using Fresnel coefficients as well as by the full-vectorial Finite-Difference Time-Domain (FDTD) method. It is shown that the proposed strategy is highly robust and stable, allowing multiple sensing rounds over at least six months period using the same chip. As a practical application, it is demonstrated the real-time monitoring of the complete functionalization process followed by a “tune and reset” step to enable real-time detection of SARS-CoV-2 spike (S) protein as the prime target for COVID virus sensing.^{[25]} Some embodiments of the invention unravel new opportunities for optical sensors,^{[26-28]} strong light-matter interaction related systems,^{[29]} complete light absorbers^{[30]} and reflectors,^{[31]} phase modulators,^{[32]} pyroelectric detectors,^{[33]} optical frequency combs,^{[34]} and hyperspectral imaging,^{[35]} among others.

### 2. Results

### 2.1. Optical Vernier Scale (OVS)

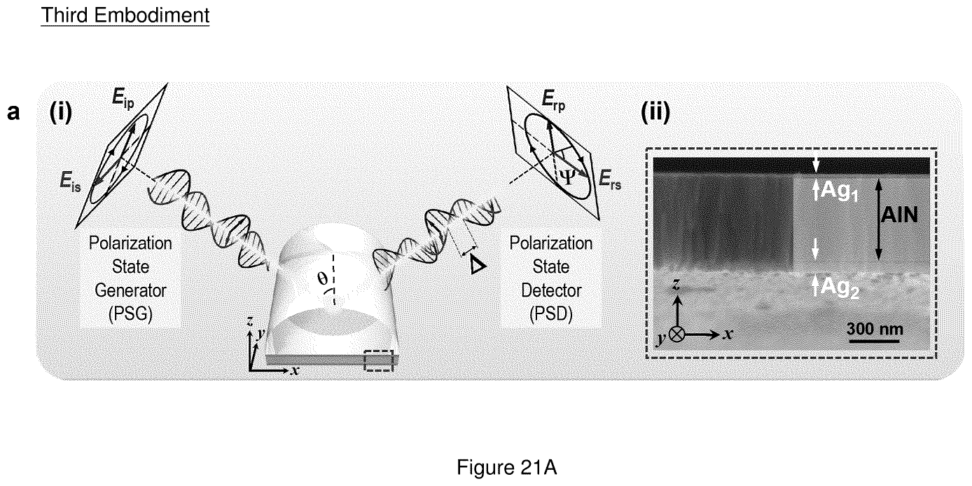

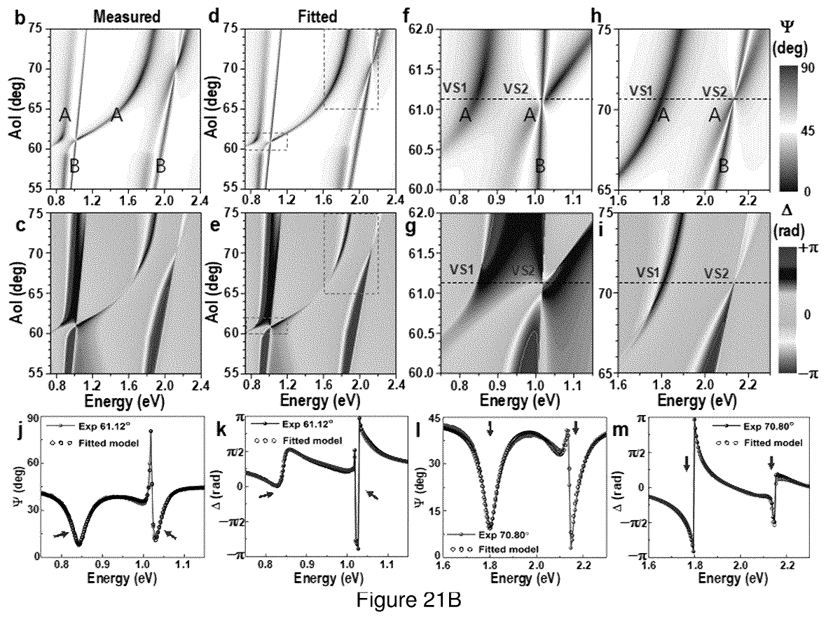

The proposed optical Vernier sensor associated with multiple ZRPs operates within the parameter space of a coupled multimode system. The challenge to optimize its capabilities resides in understanding and using the full operating parameters, including structural parameters and dispersion of the materials used, besides the usual parameters of spectral range and incident angles. To examine the reflected light properties from the multilayered structures, the ellipsometric parameters Ψ and Δ are utilized. The unique advantage of this strategy is the simultaneous determination of the reflected light amplitude ratio and phase information. A second advantage is that the use of spectral interrogation enables the collaborative and synergic use of multiple ZRPs. The ellipsometric measurement geometry of light reflected from a sample is shown in FIG. 21A, where light with a known initial polarization state is reflected by the sample. This leads to changes in the s- and p-components that can be quantified, assuming isotropic media, by changes in the amplitude ratio, Ψ, and phase difference, Δ, expressed by:^{[36]}

$$tan ( Ψ ) {e}^{i Δ} = {\tilde{r}}_{p} / {\tilde{r}}_{s} \qquad ( 1 )$$

where \tilde{r}ₚ & \tilde{r}ₛ are the complex Fresnel reflection coefficients of p- and s-polarized plane waves, that relate with reflectance as: Rₚ=|\tilde{r}ₚ|² and Rₛ=|\tilde{r}ₛ|², where Rₚ and Rₛ are the power, or intensity, reflection coefficients for p- and s-polarizations, respectively.

To experimentally demonstrate the Optical Vernier Scale (OVS) system, a simple three-layered structure, a thick aluminum nitride (AlN) embedded in a pair of asymmetric silver (Ag) thin films, is fabricated as displayed in FIG. 21A (ii). The refractive index (n) of AlN is typically above 2 from visible to near-infrared (NIR) range,^{[37]} which enables a large index contrast with Ag mirror (normally n<0.6), thus facilitating efficient PWG mode confinement.^{[38]} The SPP refers to a hybrid longitudinal electromagnetic (EM) wave propagating at a Ag/water interface composed of a charge density wave in the metallic side and an electric field in the water medium.^{[11]} The SPP propagates parallel along the interface for distances on the order of tens to hundreds of micrometers, and the amplitude of the electric field is maximum at the metal surface and decays evanescently in the z-direction with a 1/e decay length on the order of few hundred nanometers.^{[39]} The nominal thickness of the multilayer as measured by side-view scanning electron microscopy (SEM) is close to Ag₁ (20 nm)/AlN (500 nm)/Ag₂ (48 nm). FIG. 21B b-e presents measured and fitted (Fresnel approach) ellipsometric parameters Ψ and Δ for the MDM structure from 55° to 75° AoI. A very good agreement is obtained. It is observed two anti-crossing behaviors, also known as the Rabi splitting,^{[23,24]} for p-polarized ZRPs (A regions, Ψ→0°) and two crossings of p- and s-polarized ZRPs (A and B regions, Ψ→0° and 90°). The minimum value of Ψ drops dramatically in the anti-crossing regions, with the lowest point going below 0.3° (comparable to the experimental error). These Rabi splitting features are only available for p-polarized reflection due to the plasmonic nature of the underlying SPP modes, whereas the s-polarized reflection retains the properties of PWG resonances thereby enabling the ability to fine-tune the positions of ZRPs in p-polarization with respect to that in s-polarization via AoI control. The corresponding phase difference, Δ, also shows anti-crossing behaviors in p-polarization; however, nodal points in Δ arise when the ZRPs of Rₚ and Rₛ intersect because of the simultaneous presence of phase singularities. The dispersion plots reveal that by tuning the incident angles, the intersections of Rₚ and Rₛ occur at two regions (i.e., ≈61.12°, 1.0 eV and ≈70.80°, 2.1 eV), creating direct crossings in Ψ and nodal points in Δ, respectively. Since the fact that the ratio of reflection intensities is tan(Ψ)=\sqrt{Rₚ/Rₛ}, the zero-intensity of Rₚ gives a sharp minimum in Ψ, while the zero-intensity of Rₛ provides the sharp maximum in Ψ, when the two orthogonally polarized ZRPs overlap, the resulting spectra exhibits an asymmetric line-shape that resembles a Fano line-shape with a rapid change between a dip and a peak, as shown in FIG. 21B j,l. Additionally, a Lorentzian line shape in Ψ spectra results from the second ZRP in p-polarization. In the proposed measuring scheme, the Lorentzian profile acts as the primary scale of the spectroscopic Vernier scale (denoted as VS1), whereas the Fano profile acts as the ultrasensitive sliding Vernier scale (denoted as VS2). The increased sensitivity of VS2 arises from the sharp asymmetric Fano line-shape that produces a much larger spectral contrast for similar refractive index change in the sensing media; this larger contrast benefits as Rₛ provides a fast-modulated internal reference to measure small changes in Rₚ. Meanwhile, a sharp phase change occurs in A spectra due to the undefined reflected phase in the vicinity of ZRPs, as shown in the FIG. 21B k,m. When the minima of Rₚ and Rₛ intersect, their phase singularities overlap, giving a sophisticated spectral signature with more data points than phase singularities.

In brief, the spectra of Ψ and Δ simultaneously exhibit the OVS effect owing to the advanced hybrid modes, where Rₚ splits into two polariton states, one acting as a primary scale, VS1, while the second polariton state intersects with the ZRP of Rₛ and together construct a finer reading scale in Ψ and Δ spectra, denoted as VS2, which works analogous to a Vernier scale, hence the name ‘Optical Vernier Scale’. The spectral positions of Vernier scales, VS1 and VS2, can be controlled by the thicknesses of the MDM layers, the optical constants of each layer, as well as the incident angles.

### 2.2. Strong Coupling of Plasmonic and Photonic Modes

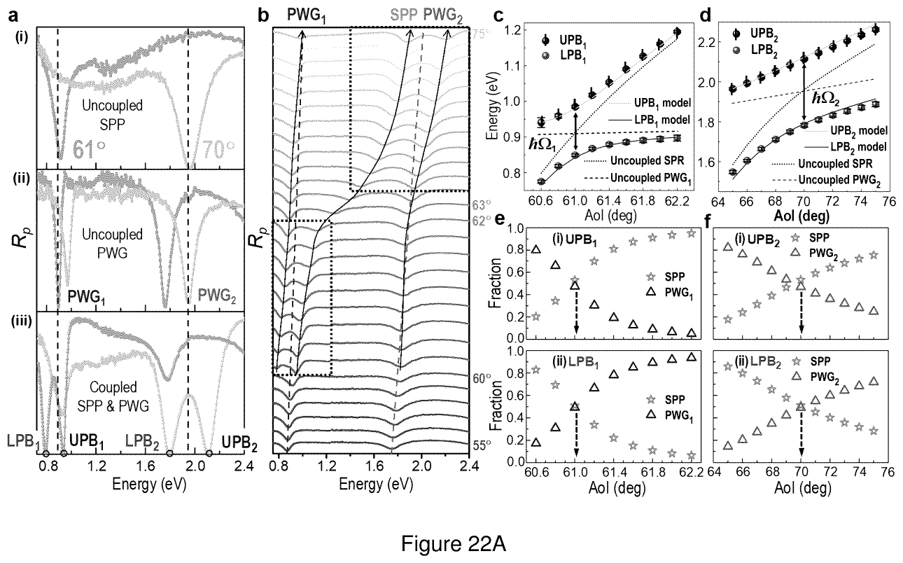

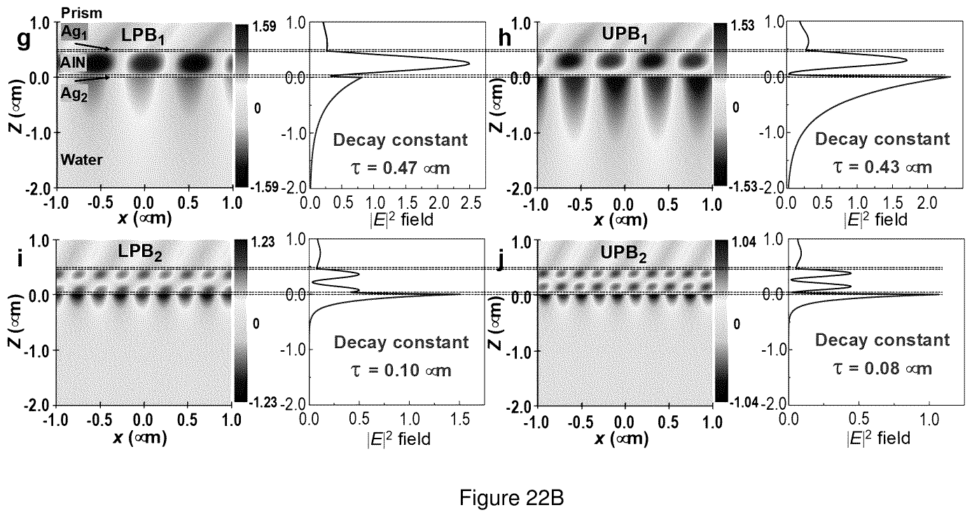

For non-magnetic materials in a planar system, the ZRPs in Rₚ and Rₛ are essentially non-degenerate.^{[17]} In the proposed case, however, the hybridization of plasmonic and photonic modes in p-polarized reflection is of major importance as it offers an indispensable tool to flexibly tune the p- and s-polarized ZRPs separately. FIG. 22A a presents the measured p-polarized reflectivity spectra of i) an unperturbed SPR mode, ii) an unperturbed PWG mode, and iii) the SPP & PWG coupled mode at ≈61° and ≈70° AoI, respectively. A direct comparison reveals that the coupled system exhibits two distinct polariton states energetically split from the unperturbed SPR and PWG resonances and identified as the lower polariton branch (LPB) and the upper polariton branch (UPB). The p-polarized reflectance of the coupled system from 550 (bottom) to 750 (top) AoI is shown in FIG. 22A b. The resonant energies at each incident angle are extracted from Lorentz fits of the experimental data and the lower and upper polariton energies are plotted as a function of AoI as shown in FIG. 22A c,d, respectively. The error bars originate from the standard deviation and Lorentz fitting. The solid curves are theoretical fits of the polariton branches with a coupled oscillator model (see Methods). Interestingly, resulting from the wide angular dispersion of SPP, the UPB1 at lower AoI (FIG. 22A c) turns into the later LPB2 (FIG. 22A d) as the AoI increases. This gives rise to the hybrid system supporting two coupling states, thereby two distinct anti-crossing regions appear at 60.6°-62.2° AoI and 64.0°-76.0° AoI, respectively. The calculated coupling strengths are g₁=(E_{UPB1}−E_{LPB1})/2=68±4 meV and g₂=(E_{UPB2}−E_{LPB2})/2=166±6 meV.^{[40]} The experimental full width at half maximum (FWHM) of the unperturbed SPP are (γ_{SPP1}=83±6 meV, γ_{SPP2}=142±8 meV), while the corresponding FWHM values for the unperturbed PWG are (γ_{PWG1}=45±5 meV, γ_{PWG2}=77±8 meV). These values satisfy the criterion for the formation of strong coupling:^{[40]}

$${g}^{2} > \frac{{γ}_{SPP}^{2} + {γ}_{PWG}^{2}}{2} \qquad ( 2 )$$

with calculated values
g₁²=4,624±16>(γ_{SPP1}²+γ_{PWG1}²)/2=4,457±20 meV² and g₂²=27,556±36>(γ_{SPP2}²+γ_{PWG2}²)/2=26,093±128 meV². We further derive the Rabi splitting of hΩ_{Rabi1}=135±7 meV and hΩ_{Rabi2}=330±8 meV, which also satisfies the strong coupling condition of 2ℏΩ_{Rabi}>γ_{SPP}+γ_{PWG}.^{[16,23,24]} The detailed coupled oscillator model parameters of the proposed system are presented in Table S1 (Supporting Information). The contributions from the SPP and PWG components are calculated for both polariton branches and are shown in FIG. 22A e,f. The coupling strength is highest at 61.00° and 70.00° AoI, where the contributions of SPP and PWG are equal, and this is the most valuable initial operating position for sensing as the ZRPs of coupled Rₚ and uncoupled Rₛ will nearly overlap. To further investigate the successful implementation of the hybridization, the longitudinal component of electric field distribution (Eₓ) (refer to FIG. 21A for the reference frame) of the coupled system at each polariton state is simulated using the FDTD method as shown in FIG. 22B g-j. The unique electric field distribution of SPP is clearly observable at the Ag/water medium interface, as well as the exponential decay on the sensing media side highlighted by the line in |E|² profile with decay constants. An enhanced light-matter interaction and multimode fields within the AlN layer, and the slight phase retardations across the thin Ag₁ layer are observed in the electric field distribution. To validate these numerical results, we compare the spectral dependence of Ψ and Δ calculated from the FDTD method against the experimental data and its Fresnel equations model as shown in Note 1 (Supporting Information). The polarized reflection characteristics from planar multilayer structures can be calculated using Fresnel equations and a matrix transfer algorithm.^{[16,17,41,42]} The FDTD method applied to SE,^{[43-45]} is capable of simulating the ellipsometric response of multilayer structures with sub-nm accuracy when appropriate care is done in using realistic dispersion relationships [n(λ), k(λ)], calculated from ellipsometry measurements and minimizing well-identified potential sources of errors that include convergence and numerical stability issues present in the FDTD method at large angles of incidence. Using this strategy, the conventional SPR and uncoupled optical waveguide configurations are investigated, and are compared with the proposed MDM coupled system in Note 2 (Supporting Information). The proposed approach is general and can be extended to additional spectral resonances as shown in Note 3 (Supporting Information). By varying the layer thickness, the simulation results yielded four Rabi splitting and eight Vernier scales. The theoretical and numerical simulations both support the conclusion that SPP and PWG resonances are successfully coupled based on the experimental observations. The phase singularities are also observed at the anti-crossing regions confirming the operation in the strong coupling regime (displayed in Note 4, Supporting Information).

### 2.3. Optical Vernier Scale (OVS) for Sensing

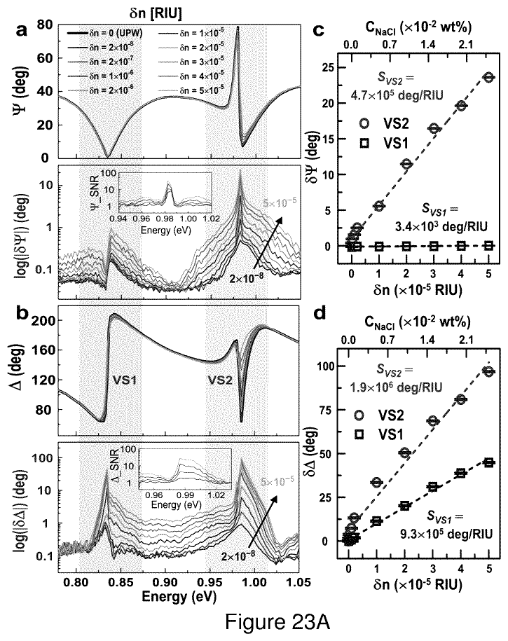

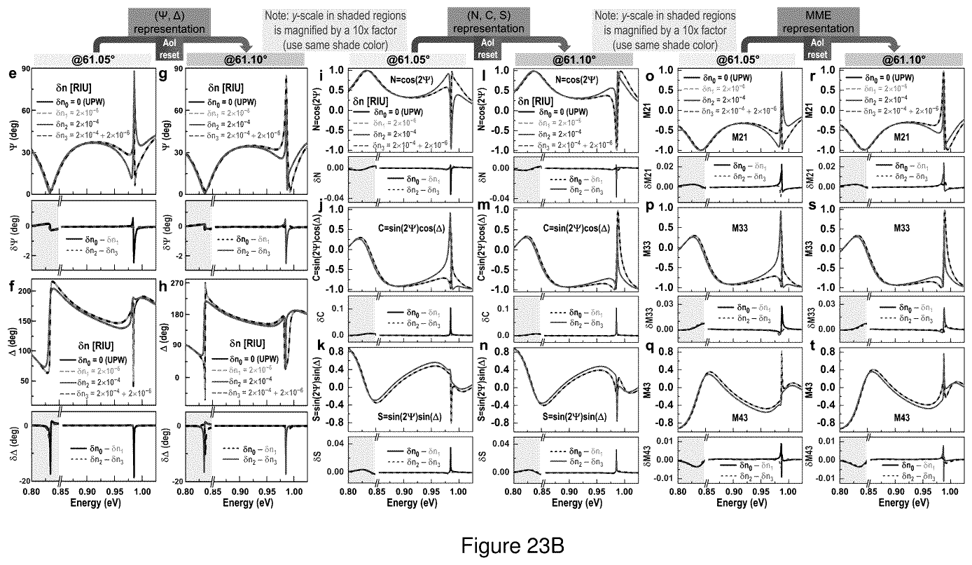

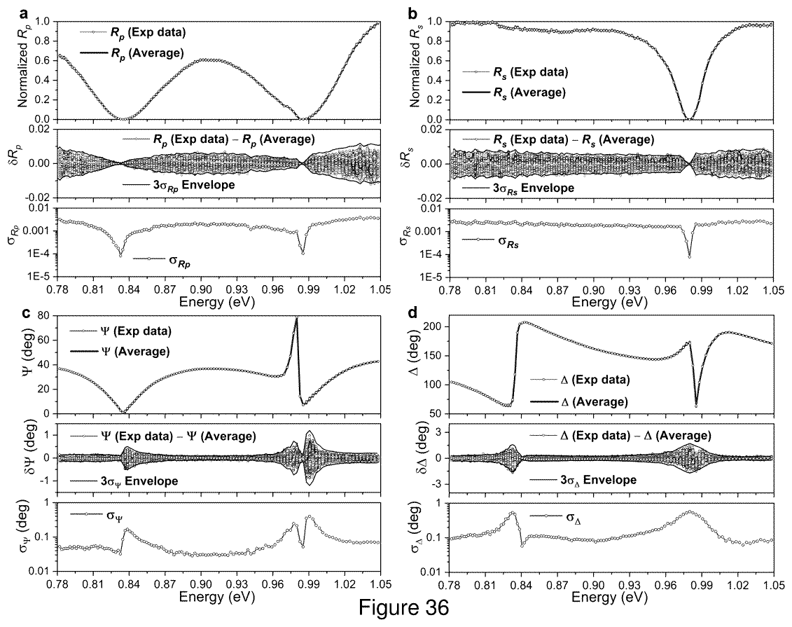

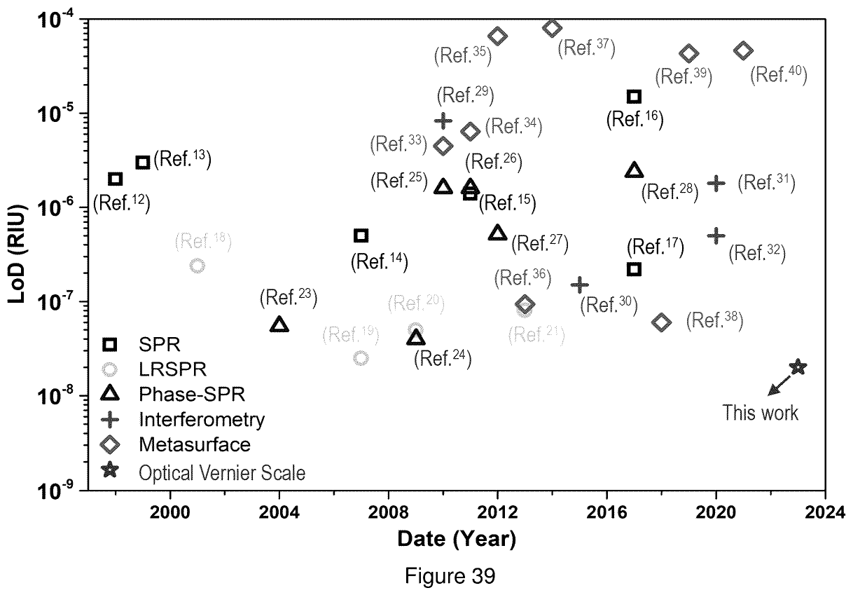

As mentioned earlier, when the ZRPs of Rₚ and Rₛ overlap, a sharp asymmetric Fano line-shape appears in Ψ and a sophisticated signature occurs in Δ, both of which can serve as the secondary scales for identifying extremely small perturbations. To validate the advantages of the OVS, the RIU dependence of the proposed system is determined using different concentrations (0.000015 wt. % to 0.025 wt. %) of sodium chloride (NaCl) and record Ψ and Δ for each solution (see FIG. 23A a,b). The corresponding net RI variations range from δn=2×10⁻⁸ to 5×10⁻⁵ RIU, as calculated from refs.^{[46, 47]} As predicted, the VS2 of both Ψ and Δ exhibit a more pronounced dependence on the RI value of the sensing medium when compared to VS1. This is because, when the RI of the sensing media changes, the height and position of the ZRPs of Rₚ change, while Rₛ remains still. From its definition, tan(Ψ)=\sqrt{Rₚ/Rₛ}, it can be confirmed that small changes in Rₚ are greatly amplified in Ψ because Rₚ is measured against a sharp but steady near-zero reference Rₛ. Multiple phase singularities occur in Δ due to the overlap of ZRPs. Therefore, both the amplitude ratio (Ψ) and phase difference (Δ) of VS2 vary drastically under the dual effects of near-zero reflection and corresponding overlap conditions, and the sensitivity and resolution of the sensor are greatly improved. The insets in FIG. 23A a,b show the signal-to-noise ratio (SNR) of VS2 of the measured spectra below δn=2×10⁻⁶ RIU. The SNR is calculated as the ratio of the spectral change over the root-mean-square deviation (RMSD or standard deviation) value of the noise floor of the corresponding spectral region. The standard deviations are obtained from 150 repetitive measurements in water and are presented in FIG. 36 (Supporting Information). Plasmonic sensors are usually compared using their LoD or sensitivity per RIU in various regimes. Some plasmonic sensors can achieve a LoD of ≈10⁻⁶-10⁻⁷ RIU.^{[48]} The LoD of the proposed system as reported in FIG. 23A a-d is ≈2×10⁻⁸ RIU, which is an excellent LoD reported so far as shown in FIG. 39 (Supporting Information). Noteworthy, the slopes of the linear fits shown in FIG. 23A c,d indicate the VS2 has an amplitude sensitivity of 4.7×10⁵ deg RIU⁻¹, and a phase sensitivity of 1.9×10⁶ deg RIU⁻¹ and thus operates in a regime not reached by the previous plasmonic sensors^{[4,12,26,49-53]} nor the phase-sensitive interferometry.^{[54]} The VS1 has an amplitude sensitivity of 3.4×10³ deg RIU⁻¹, and a phase sensitivity of 9.3×10⁵ deg RIU⁻¹. Accordingly, the amplitude sensitivity of VS2 is 138 times larger than that of VS1, and the phase sensitivity of VS2 is 20 times larger than that of VS1. Interestingly, the amplitude sensitivity of VS2 exhibits sufficient sensitivity to measure the small changes in the range below 10⁻⁶ RIU rather than in the intensity or wavelength interrogations limit.^{[55]} The detailed sensor characteristics of the proposed system are displayed in Note 6 (Supporting Information). The improvement of performance can be seen as resulting from the synergistic collaboration between the p- and s-polarized resonances in ellipsometric space and the inherently high SNR of ellipsometry itself. In fact, the main point of the described sensing method is the overlap of p- and s-polarized ZRPs and is not restrictive to ellipsometry. Instead, ellipsometry and other polarimetric methods can be used. Furthermore, while the ellipsometric representation based on (Ψ, Δ) provides a convenient intuitive visualization of the effect of p- and s-polarizations overlap, the sensing method is not restricted to this representation. Therefore, alternative representations or variables derived upon the polarization changes, for example, ρ, N, C, S, and non-zero Mueller-Matrix elements, can also be used. The OVS system provides an additional degree of freedom to “tune and reset” the sensor operation and return to its highest sensing operation point while keeping track of the total sensing media RI changes, thus providing a wide dynamic range while capable of maintaining ultralow LoD. This capability is enabled because the topologically protected zeros can consistently exist by simply adjusting the AoI. As shown in FIG. 23B e-t, simulated Ψ, Δ, N, C, S, and non-zero Muller-Matrix Element (MME) display narrow spectral features in ultrapure water (UPW, black solid line) medium at 61.05°, which facilitates easy tracking of very small perturbations (δn₁=2×10⁻⁶ RIU, light dashed line); as expected when the sensing media RIU changes increases to, for example, 2×10⁻⁴ RIU, the original ZRP in Rₚ changes its intensity. As a result, the Ψ, Δ, N, C, and S spectra lost their exquisite spectral signatures, and the sensitivity is reduced. In these conditions, the spectral changes resulting from an additional change of 2×10⁻⁶ RIU are greatly decreased. However, by adjusting the incident angle of excitation from 61.05° to 61.10°, the ZRPs of Rₚ and Rₛ can be re-aligned which retrieves the narrow features in Ψ, Δ, N, C, and S, as well as the high sensitivity to small RIU variations as demonstrated by the clear changes observed for δn₂-δn₃ curves (FIG. 23B g,h,l,m,n,r,s,t) in the new conditions (AoI=61.10°, and δn₂=2×10⁻⁴ RIU), thus securing the ultralow LoD throughout the entire large dynamic range.

The synergistic collaboration of both Vernier scales also can be used in this OVS system, since VS1 enables a p-polarization sensing that can effectively track large variations, while VS2 realizes a superb sensing ability for extremely small changes, which can remarkably expand the dynamic range, for example, 10⁻³ to 10⁻⁸ RIU, without sacrificing high sensitivity and wide dynamic range due to being limited by a relatively narrow angular variation or spectral shift range.

### 2.4. Biosensing Application Example

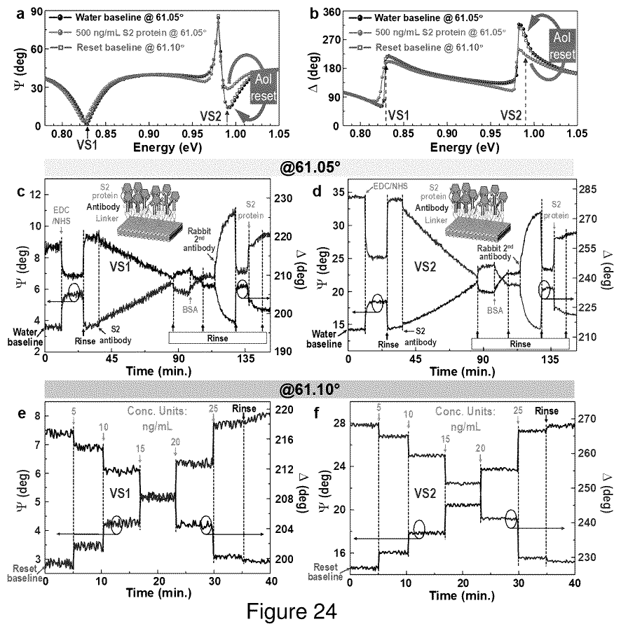

The advantage of the “tune and reset” capability is demonstrated using the dose-dependent detection of the SARS-CoV-2 spike (S2) protein. In this proof of concept, the full functionalization process of the chip surface is tracked, and followed by a “reset” step to adjust the system to the optimal sensing mode of operation to perform dose-dependent monitoring of the S2 protein. The S protein is a prime target for live virus detection because of its abundance of SARS-CoV-2 virion.^{[25}] Since the top layer of the proposed multilayer is a silver film, bio-surface modification is possible. This is to be taken only as an example of functionalization (there are countless others and many more will continue to be developed). The sensor chip is first incubated in an ethanolic solution of 10 mM 11-mercaptoundecanoic acid (MUA) overnight at room temperature to form a self-assembled monolayer denoted linker. Then the activated surface is functionalized with an anti-S2 antibody by standard Schiff-base chemistry via Ethyl-3-(3-dimethylaminopropyl)carbodiimide/N-hydroxysuccinimide (EDC/NHS) (refs. [56-58] and Note 7, Supporting Information). After the blocking of non-specific binding sites by bovine serum albumin (BSA), the sensor specificity and sensitivity for the S2 protein are evaluated as shown in FIG. 24c,d. It is worth noting that the ZRPs are lifted after functionalization, and to ensure the sensing capability, we “reset” the Vernier scale to the original sensing condition by tuning the incident angle from 61.05° to 61.10°, then perform a real-time dose-dependent detection of the S2 protein (5, 10, 15, 20, 25 ng mL⁻¹). The results show that VS2 (FIG. 24f) always has a higher SNR compared to VS1 (FIG. 24e). Multiple measurements are taken for each concentration of the spike protein and it is noted that both the amplitude and phase changes for 5 ng mL⁻¹ are higher than the noise level in FIG. 24e,f, confirming a LoD of lower than 5 ng mL⁻¹. The demonstrated performance with LoD<5 ng mL⁻¹ is better than or comparable to reported works on SARS-CoV-2 (anti-)spike protein detection.^{[25,59,60]} Therefore, the proposed VE system shows comparable performance in biosensing applications including the detection of pathogen proteins.

### 3. Discussion

The ZRPs are demonstrated to exhibit enhanced sensitivity in sensing. According to some embodiments of the invention, it is experimentally realized the precise manipulation of the ZRPs conditions for both s- and p-polarizations, as well as the strong coupling between SPP and PWG resonances. This is achieved based on the judicious selection of the thickness in the lithography-free, three-layer, MDM structure. The thickness tolerance analysis is presented in Note 8 (Supporting Information). Analogous to the Vernier system used in calipers, which greatly improves the resolution and lowers the measurement uncertainty by overlapping two mechanical scales, the resulting OVS creates a sophisticated secondary scale that greatly improves the sensitivity and resolution of the sensor. The LoD of the proposed system is ≈2×10⁻⁸ RIU, representing the superb LoD reported so far. In addition, the strength of the “tune and reset” capability, thanks to the topologically protected zeros, is demonstrated for a biosensor of S2 protein that can track the entire functionalization process of the chip surface, then “reset” to the highest sensing point and perform dose-dependent monitoring of the S2 protein with a LoD better than 5 ng mL⁻¹.

It is expected that the proposed MDM multilayer can efficiently integrate with other strategies, including the use of 2D nanomaterials with large adsorption energy, such as graphene,^{[61,62]} transition metal dichalcogenides,^{[17]} antimonene;^{[63]} or the application of machine learning powered instruments^{[Γ]} equipped with advanced analysis algorithms and systems to accurately extract the spectral information and enable real-time high-throughput screening; and compact designs such as the employment of plasmonic nanoparticles^{[65]} and metasurface,^{[66]} can further optimize the sensitivity and introduce new functionalities (e.g., enriched surface area and volume,^{[67]} imaging sensors,^{[68]} and combination with surface-enhanced Raman scattering,^{[69]} among others). The approach proposed is also compatible with multiplexing strategies, facilitated by the broad operating spectral range, potentially providing independent measurements in the near-infrared and visible spectral regions, thereby distinguishing multiple analytes with different dispersion or functionalizations.^{[70]} From a broader perspective, the proposed strategy holds great implications in addressing societal needs, such as clinical diagnostics, pollution monitoring, among others.

### 4. Methods

Sample Fabrication: The multilayer stacks are fabricated in one-step at room temperature by the sequential deposition of Ag, AlN, and Ag layers on 1 mm-thick glass substrates via DC and RF magnetron sputtering (PRO Line PVD 75, Kurt J. Lesker) using 99.99% pure Ag and 99.9995% pure Al targets (Kurt J. Lesker). The Ag layers are deposited using DC sputtering (0.45 W cm⁻²), Ag target and Argon gas, 99.99% pure, at 3 mTorr. The AlN thin films are deposited by RF reactive magnetron sputtering (3.3 W cm⁻²) using a 99.9995% pure Al target in a mixed gas ambient of 8.3 sccm of nitrogen and 11.8 sccm of Argon. The sputtering chamber is pumped to a base pressure of less than 1×10⁻⁷ Torr prior to any sputtering. The multilayer thicknesses are confirmed through side-view SEM images (JSM 6335F, JEOL). Table S4 (Supporting Information) summarizes the deposition parameters of Ag and AlN thin films. The substrate cleaning and target pre-sputtering are displayed in Note 9 (Supporting Information).

Ellipsometry Measurements: The ellipsometry parameters (Ψ and Δ) and the polarized reflectivity spectra as a function of photon energy (E) are obtained using angle-resolved total internal reflection ellipsometry (TIRE) over a broad spectral range of 0.73-3.5 eV (≈350-1700 nm) via the variable-angle high-resolution spectroscopic ellipsometry (M-2000DI, J.A.Woollam Co.) using a BK7 glass half-cylindrical prism (14 mm radius). The optical system illustration is shown in Note 10 (Supporting Information). For the angular scan measurements, the angular resolution is set to 0.01° The ellipsometry is also used to determine the thicknesses and dielectric functions (ϵ1 and ϵ2) of the as-fabricated multilayers. The simulation of ellipsometric data (Ψ, Δ, Rₛ and Rₚ) and regression fit are performed using the commercial software CompleteEASE (J.A. Woollam Co. 5.15 h). The results of the dielectric functions and relevant reference values are presented in Note 11 (Supporting Information).

Coupled Oscillator Model: The dispersion of the resulting hybrid plasmonic-photonic modes can be modelled using a coupled oscillator model:^{[16,23,24]}

$$( \begin{matrix}{E}_{SPP ( θ )} + i {γ}_{SPP ( θ )} & g \\ g & {E}_{PWG ( θ )} + i {γ}_{PWG ( θ )}\end{matrix} ) ( \begin{matrix}α \\ β\end{matrix} ) = E ( \begin{matrix}α \\ β\end{matrix} ) \qquad ( 3 )$$

Here, E_{SPP} and E_{PWG} are the uncoupled SPP and PWG modes energies, γ_{SPP} and γ_{PWG} are the damping rates of the two modes. θ is the angle of incidence and E represents the eigenvalues corresponding to the energies of the hybrid polariton modes, g is the coupling strength. α and β construct the eigenvectors and represent the weighting coefficients of the SPP and PWG for each hybrid polariton state, where |α|²+|β|²=1. The eigenvalues are given by:

$$E ( θ ) = ( 1 / 2 ) [ {E}_{SPP ( θ )} + {E}_{PWG ( θ )} + i ( {γ}_{SPP ( θ )} + {γ}_{PWG ( θ )} ) / 2 ] \pm {g}^{2} + {( 1 / 4 ) [ {E}_{SPP ( θ )} - {E}_{PWG ( θ )} - i ( {γ}_{SPP ( θ )} - {γ}_{PWG ( θ )} ) ]}^{2} \qquad ( 4 )$$

$$where the Rabi splitting is given by :$$

$${ℏΩ}_{Rabi} = 2 \sqrt{{g}^{2} - ( 1 / 4 ) {( {γ}_{SPP} - {γ}_{PWG} )}^{2}} at {E}_{SPP} = {E}_{PWG} \qquad ( 5 )$$

### Supplementary Information for the Third Embodiment

### Supplementary Note 1: Modelling of the Structures

Numerical simulations of the ellipsometric data (Ψ & Δ) and polarized reflectance (Rₛ & Rₚ) are performed using the commercial software CompleteEASE (J.A. Woollam Co. 5.15h), based on Fresnel equations (FE) and matrix transfer formalism, as well as the Finite-Difference Time-Domain (FDTD) method (Lumerical 2021 R2.3).

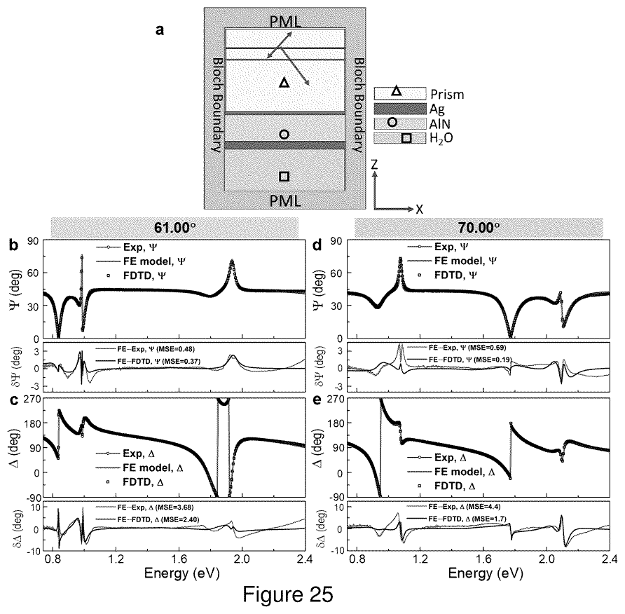

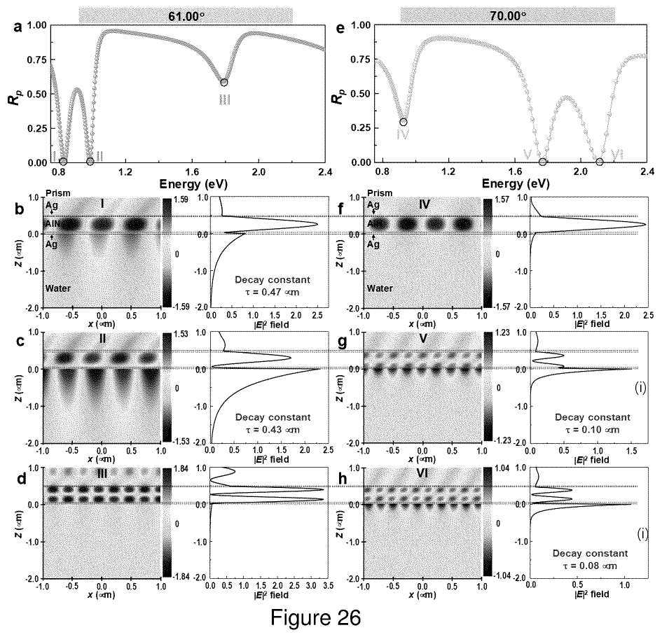

In the present case of planar samples, (Ψ, Δ) calculation by the FDTD method provides a quantitative confirmation of the accuracy of the FDTD modelling results^{1,2,3}, and more importantly for the case at hand, it enables calculation of the electric field distribution in the proposed structure. The film parameters and dispersion relations match those retrieved from the FE best-fitting optical model to the experimental data while two FDTD modelling geometries are used. The first one, used to calculate the (Ψ, Δ) spectral response of the system in an efficient manner, uses a relatively small volume (x,y,z) of (6, 6, 3,000) nm³ and periodic Bloch boundary conditions (BBC) at the ±x, ±y boundaries of the simulation region (FIG. 25). In this case, the use of periodic BBC in x, y ensures the correct calculation of the spectral Ψ and Δ. The second geometry uses a larger volume (2,000, 6, 3,000) nm³ for the visualization of the E-field distribution in the (x,z) cross-section of the multilayer (FIG. 26). In both cases, the thickness of the dielectric layer (AlN) is 488.51 nm, measured by ellipsometry, and the Ag layer contacts with the prism side is 17.96 nm while the other Ag layer adjacent to the H₂O medium is 48.72 nm, respectively. Two incident angles are considered, namely 61° and 70°. To validate the FDTD results the spectral dependence of Ψ and Δ are shown in FIG. 25b-e against the experimental data and the FE modelling.

### Supplementary Note 2: Electric Field Distribution

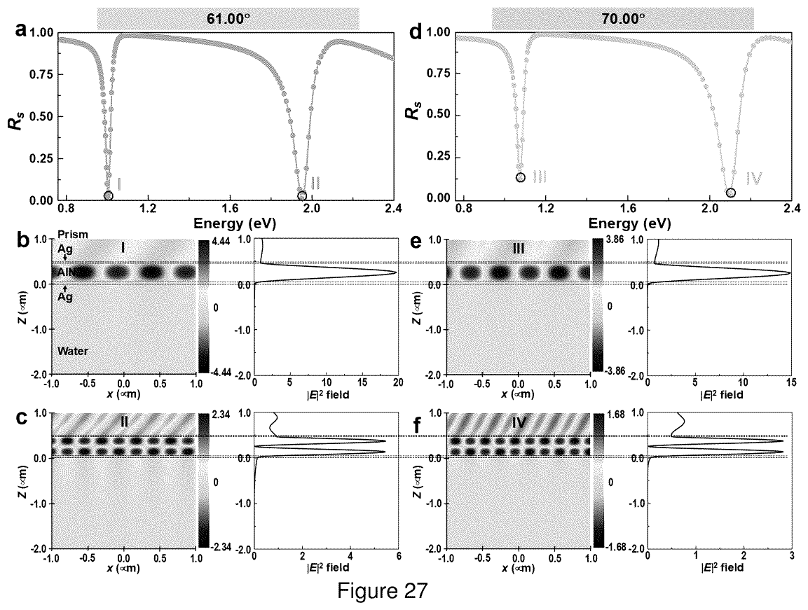

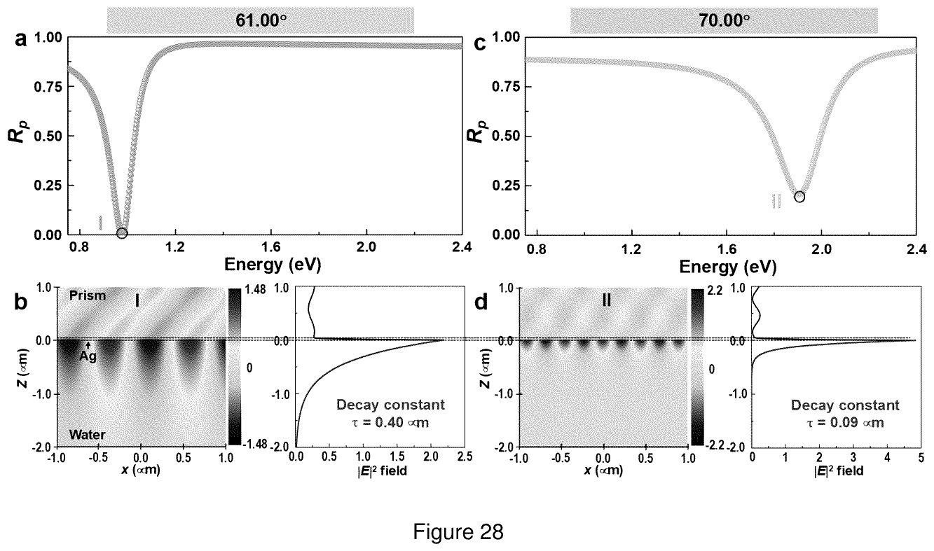

The simulated E-field distributions confirm that the hybridization of the surface plasmon polariton (SPP) with the multimode photonic waveguide (PWG) modes can occur at both 61° and 700 incident angles. Accordingly, two distinct anti-crossing regions appear in the coupled system as described in the main text. The calculated p-polarization electric field distributions of the coupled system are presented in FIG. 26 at the points of reflectivity minima for 61° and 700 incidence angles (I to III) and (IV to VI), respectively. The unique features of the coupled SPP and PWG modes are clearly observed including well-defined photonic waveguide modes with modal number m=1 at 610 and photon energies (0.83 eV and 0.98 eV) corresponding to wavelengths (1493.78 nm and 1265.14 nm) in FIG. 26b, c, respectively; whereas photonic modes with modal number m=2 are observed at 700 and photon energies (1.77 eV and 2.1 eV) corresponding to wavelengths (700.47 nm and 590.4 nm) in FIG. 26g, h (curved lines in the regions (i) in |E|² profile). The SPP nature of the coupled mode is evidenced by i) the longitudinal component of E-field (Eₓ) dominated character of the resonance, indicating that the light wave propagates along the film surface; ii) the exponential decay on the sensing media side highlighted by the line in |E|² profile with decay constants for modes m=1 and m=2; iii) the confined surface modes only exist under p-polarized incident light. Significantly, the photonic and plasmonic modes are in-phase for the lower polariton branches LPB₁ and LPB₂ (points I and V, respectively in FIG. 26b, g) and are out-of-phase for the upper polariton branches UPB₁ and UPB₂ (points II and VI, respectively in FIG. 26c, h). All coupled modes have great potential in sensing and their ability to sense different depth profiles will be the subject of a future publication. Some embodiments of the invention, however, focus on the sensing potential at low angle of incidence (AoI) noting that |E|² is largest for the out-of-phase mode m=1. The electric field distribution of the proposed multilayer system under s-polarized incident light and that of the uncoupled surface plasmon resonance (SPR) system under p-polarized incident light are also simulated and shown in FIG. 27 and FIG. 28, for comparison.

### Supplementary Note 3: Conceptual Illustration

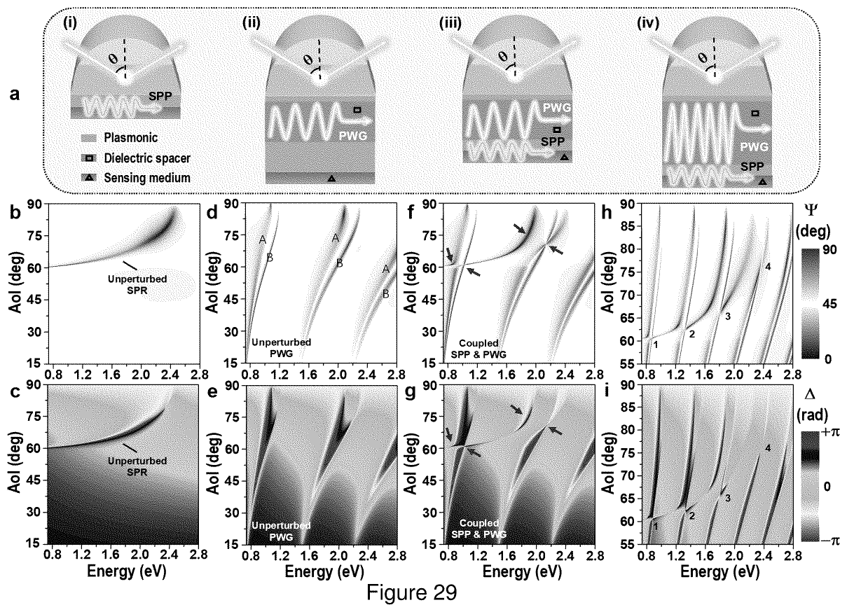

To illustrate how the Vernier effect associated with zero-reflection is created, four configurations of planar structures supporting (i) an unperturbed SPR mode, (ii) an unperturbed PWG mode, (iii) the coupled surface plasmon polariton (SPP) & PWG modes, and (iv) coupled mode with a thicker AlN are investigated, see FIG. 29a. The SPP configuration is composed of a plasmonic metal film (silver, 48 nm-thick) adjacent to a semi-infinite dielectric sensing medium (water) on one side and a semi-cylindrical dielectric prism on the incident side. The second structure, an uncoupled optical waveguide, consists of a dielectric film (aluminum nitride, 500 nm-thick) embedded in an array of asymmetric paired metal mirrors (silver, 20 and 200 nm, respectively), leading to the excitation of multimode PWG resonances inside the core layer. The thin 20 nm-thick silver (Ag₁) film acts as a semitransparent mirror to ensure light is transmitted to the underlying waveguide layer while also serving as a waveguide mirror. The 200 nm-thick Ag layer effectively blocks the transmission to the sensing media. The third configuration has a similar structure as the second one, but with reduced thickness of the bottom Ag layer (Ag₂, 48 nm-thick) thereby enabling the emergence of SPP at the metal/sensing-medium interface. The very thin (<20 nm), semi-transparent Ag layer is kept in the third configuration, as it guarantees the efficiency of the waveguide, but it is not a highly reflective metal mirror, considering that zero-reflection is critical in our system. The ellipsometric parameters Ψ and Δ of these three configurations are simulated from 15° to 90° AoI, and the resulting dispersion plots are shown in FIG. 29b-g. The expected SPR is clearly observed in configuration (i) as a notable decrease in p-polarized reflectivity (dark, Ψ→0°) and has a strong angular dependence. In contrast, in configuration (ii), the aluminum nitride (AlN) film sandwiched between two Ag layers of lower refractive index (RI) supports both s- and p-polarization resonances and exhibits six PWG modes in the spectral range of 0.75 eV to 2.8 eV, three for Rₚ(dark regions A, Ψ→0°) and three for Rₛ (dark regions B, Ψ→90°). Instead, the hybrid modes of SPP and PWG are realized in configuration (iii) due to the SPP mode at the bottom Ag/medium interface and the PWG in the AlN layer. When the excitation conditions are satisfied for both states, the two modes superimpose and their energies split from those of non-interacting oscillators, revealing anti-crossing behavior on their dispersion plots. The proposed strategy can be generalized to create additional spectral reflection zeros as illustrated in configuration (iv) where the AlN thickness has been increased to 1000 nm to create four s- and four p-PWG modes in the 0.8 to 2.4 eV spectral range while keeping other parameters constant. The resulting Ψ and Δ maps for coupled SPP & PWG modes of configuration (iv) are depicted in FIG. 29h, i. For better comparison, Ψ and Δ spectra are plotted from 55° to 90° AoI, which exhibits four Rabi splitting and eight Vernier scales, respectively.

In some embodiments, regarding the case (iv) coupled mode with a thicker AlN, the sensor can also work for thickness of AlN>1,000 nm. If the thickness of AlN is larger than 1,000 nm the sensor provides multiple spectral sensing points and enables multispectral and multiplexing functions.

### Supplementary Note 4: Phase Singularities

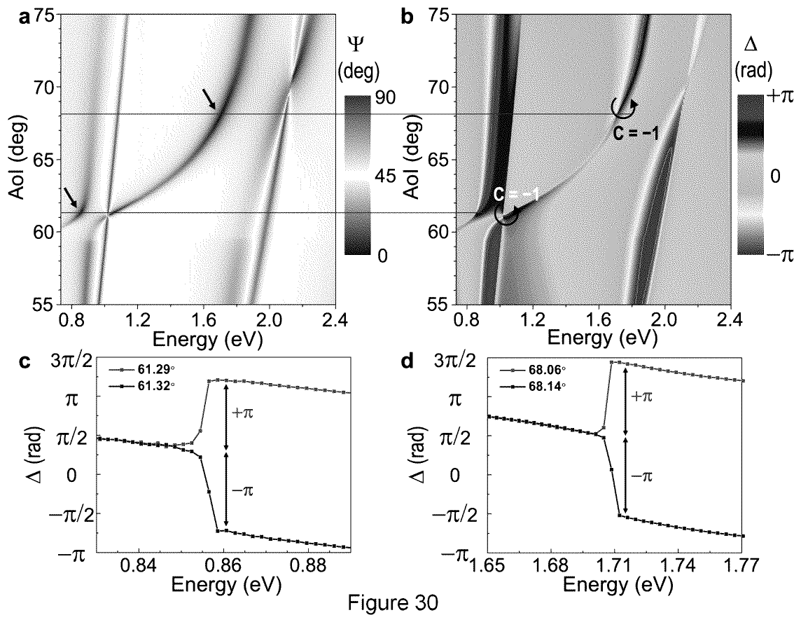

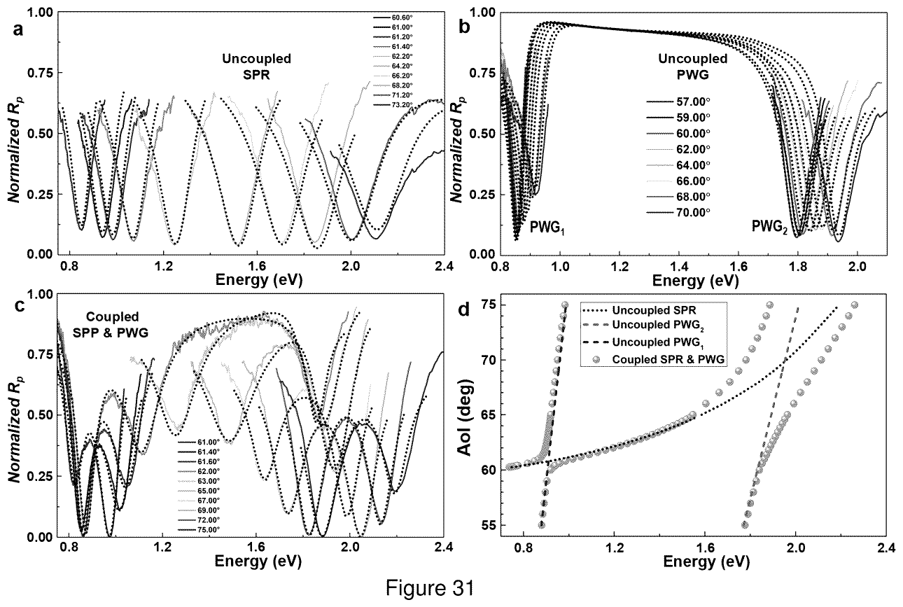

Phase singularities occur when the amplitude of reflected light is zero and its phase becomes undefined4. In the main text, we focus on the overlap between the zero-reflection points (ZRPs) of Rₛ and Rₚ, but we also experimentally observe the phase singularities at the anti-crossing regions confirming the operation in the strong coupling regime. In close vicinity of reflectionless points, the phase becomes singular and has an opposite π-gradient for angles slightly below (61.29° or 68.06°) and above (61.32° or 68.14°) the darkness points, as shown in FIG. 30.

### Supplementary Note 5: Lorentz Fit Resonance

To perform the coupled oscillator model, the resonant energies (E) and width (7) are required. A Lorentz function is used to fit the crosscuts of the experimentally measured p-polarized reflectivity spectra at each incident angle and extract the needed information (E and γ). Different angular resolutions were chosen for fitting based on the angular dependence of SPR. In the proposed case, it is found two hybridization states, and the corresponding parameters can be found in Supplementary Table 1 including all values calculated E_{SPP}, E_{PWG}, γ_{SPP}, γ_{PWG}, g, and hΩ_{Rabi}. It is noted that the proposed system satisfies both definitions of strong coupling, g2>((γ_{SPP})²+(γ_{PWG})²)/2, and 2hΩ_{Rabi}>γ_{SPP}+γ_{PWG}, accordingly report both of them.

SUPPLEMENTARY TABLE 1
Coupled oscillator model parameters.

| AoI region | E_{SPP} (eV) | E_{PWG} (eV) | γ_{SPP} (me V) | γ_{PWG} (meV) | g (meV) | hΩ_{Rabi} (me V) |
|---|---|---|---|---|---|---|
| 60.6°-62.2° | 0.912 ± 0.003 | 0.899 ± 0.005 | 83 ± 6 | 45 ± 5 | 68 ± 4 | 135 ± 7 |
| 64.0°-75.0° | 1.958 ± 0.006 | 1.955 ± 0.002 | 142 ± 8 | 77 ± 8 | 166 ± 6 | 330 ± 8 |

### Supplementary Note 6: Sensor Characteristics

1) Experimental Sensitivity Test for Rₚ and Rₛ

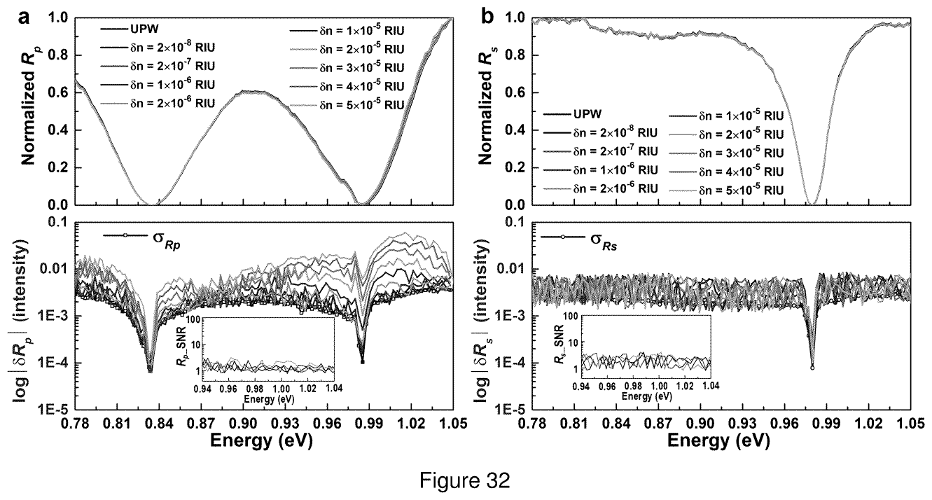

As mentioned in the main text, the inherent RI sensitive nature of plasmonic resonances is only available for Rₚ. In contrast, the s-polarized photonic resonances act as a stable internal reference metric because of its narrow width and insensitivity to the sensing media RI variations. The experimental sensitivity test of Rₚ and Rₛ are shown in FIG. 32 in order to compare with that of Ψ and Δ (FIG. 23A a, b). The signal-to-noise ratio (SNR) shown in the insets reveal the insufficient sensing ability of Rₚ and Rₛ for changes below 2×10⁻⁶ RIU, while Ψ and Δ in the main text have significant sensing capabilities for the same variation.

### 2) Dynamic Range

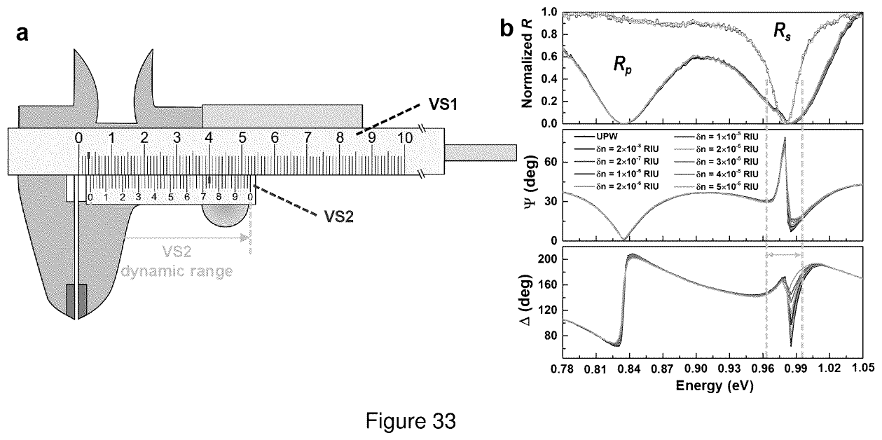

The enhanced sensitivities of VS2 originate from the ZRPs overlap of Rₚ and Rₛ. Changing the sensing media RI values, Rₛ remains constant, whereas the ZRPs of Rₚ lift and shift, the dynamic sensing range will then be limited by both strong coupling and overlapping conditions. As shown in FIG. 33, any small changes in the ZRPs overlapping range of Rₚ and Rₛ will be pronouncedly amplified in the ellipsometric spectra. If the ZRP of Rₚ no longer intersects the dip of Rₛ, the sensitivity will be greatly reduced, see FIG. 23B e-t. However, the OVS system can “reset” the Vernier scale by simply adjusting the AoI (as shown in the main text), providing a broad dynamic range while maintaining its exceedingly high sensitivity. Nonetheless, it is pointed out that the proposed Vernier system is primarily designed for identifying small perturbations due to the superior sensitivity of the VS2. Whereas for larger variations, the VS1 can be used for sensing.

### 3) Effective Spectral Range

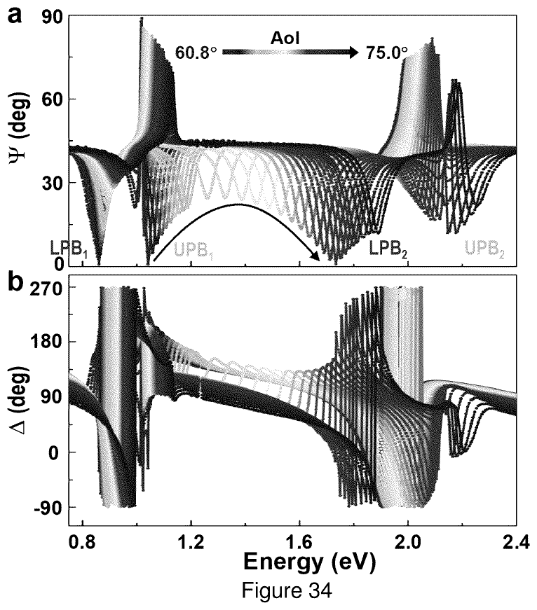

Benefiting from the wide angular dependence of SPR and multimode of PWG, the proposed optical Vernier system has a broad spectral range for sensing. Therefore, multiple spectral positions can be simultaneously used to improve the sensitivity and robustness of the sensor. The Ψ and Δ spectra (FIG. 34) show that the proposed system is capable of sensing in the range of 0.8 eV to 2.4 eV and requires only the adjustment of incident angles (60.8° to 75.0°).

### 4) Resolution

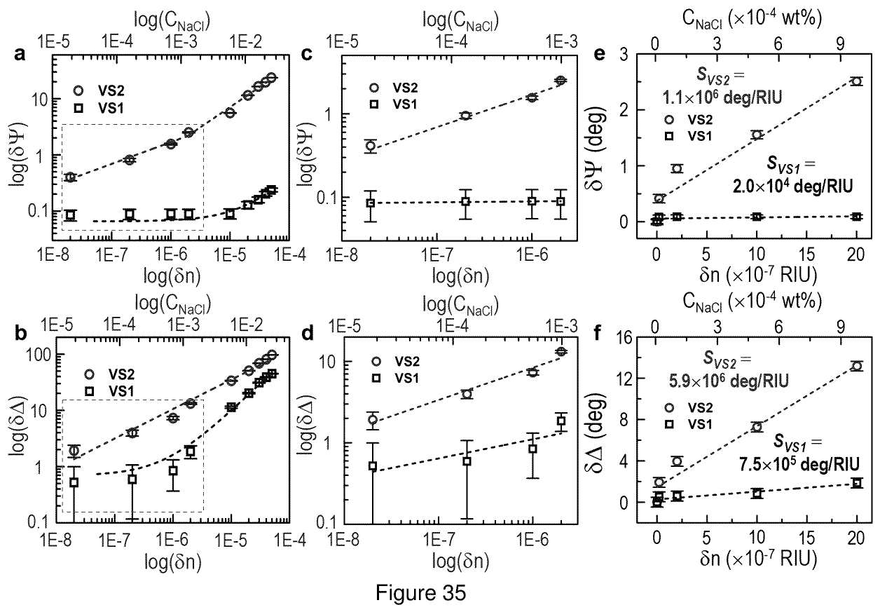

The highest sensitivity occurs at the first four measurements (see FIG. 35 c-f, δn=2×10⁻⁸ to 2×10⁻⁶ RIU) and then gradually decreases as each detection shifts the system away from the optimal coupling and overlapping conditions. The VS2 has a best amplitude sensitivity of 1.1×10⁶ deg/RIU, and a phase sensitivity of 5.9×10⁶ deg/RIU. The VS1 has an amplitude sensitivity of 2.0×10⁴ deg/RIU, and a phase sensitivity of 7.5×10⁵ deg/RIU. The results also show that the proposed system operates in a regime not reached by previous plasmonic sensors^{5,6,7,8}.

The noise levels of Rₛ, Rₚ, Ψ and Δ during in-situ measurements in UPW are presented in FIG. 36. It is clear that the standard deviation of each spectrum significantly decreases around the ZRPs. The definition of the limit of detection (LoD) varies slightly among regulatory bodies and standards organizations.⁹ The Clinical and Laboratory Standards Institute (CLSI), for example, defines LoD as “the lowest analyte concentration likely to be reliably distinguished from the limit of blank (LoB) and at which detection is feasible.”¹⁰ The LoB represents the concentration, below which 95% of measurement signals lie, when repeatedly measuring a blank sample. The remaining 5% represents the false-positive rate, indicating the occurrence of positive measurement signals in the absence of the analyte.¹¹ According to the 68-95-99.7 rule, working at 95.45% confidence, the LoB is:

$$L o B = {Average}_{blank} + 2 {σ}_{blank}$$

where σ is the standard deviation, and

$$L o D = L o B + 2 {σ}_{low conc . sample}$$

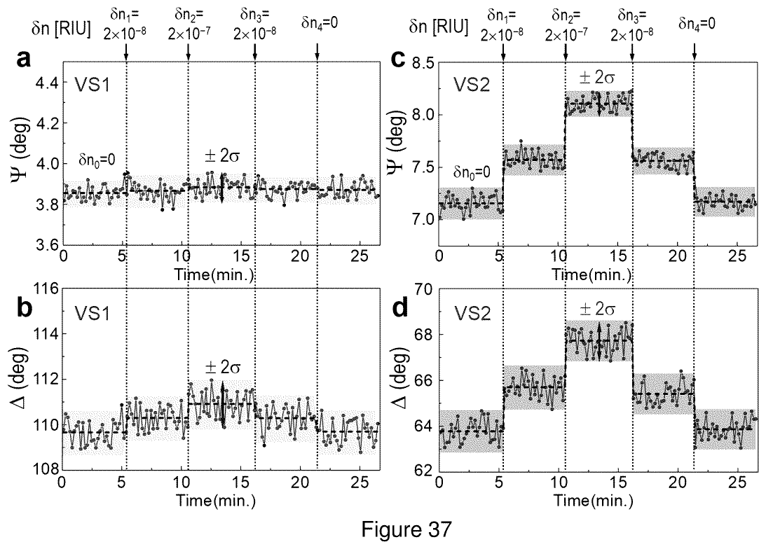

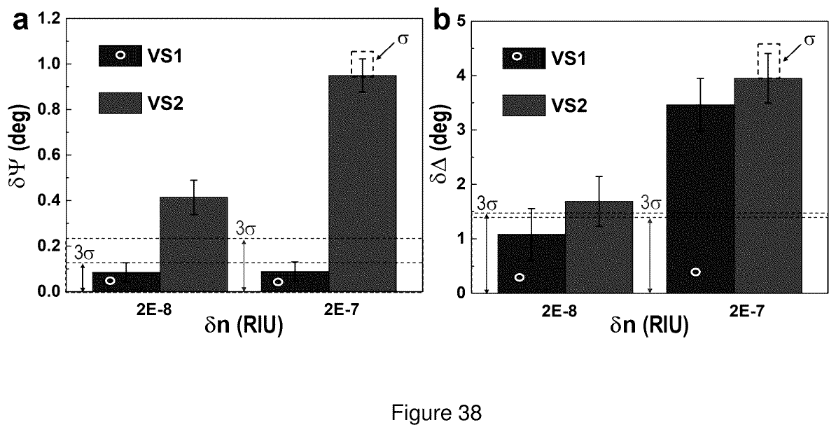

We recorded the sensing spectrum curves over 25 min of injection of different concentrations of ionic solutions, 2×10⁻⁸ RIU and 2×10⁻⁷ RIU, respectively. The collection time for each experimental point is 5 seconds, the sensogram is presented in FIG. 37. For the change of δn=2×10⁻⁸ RIU, the average value changes in VS2 are greater than the LoD calculated, as shown in Supplementary Table 2, and larger than the 3 times sigma, as shown in FIG. 38. The results show that it is evident that a RI variation as small as 2×10⁻⁸ RIU is reliably measured by the OVS system. Compared with other advanced RI sensors (FIG. 39), including SPR^{12,13,14,15,16,17}, long range SPR (LRSPR)^{18,19,20,21,22}, phase-sensitive SPR^{23,24,25,26,27,28}, interferometry^{29,30,31,32} and metasurface/nanostructured device^{33,34,35,36,37,38,39,40}, the proposed OVS system may be advantageous in that it offers superb LoD, high sensitivity, wide working range, ease of fabrication and versatility. It is noted that our LoD is also limited by current operation conditions and future instrumentation developments, such as minimizing beam distortion and aberrations in the coupling prism to improve the current noise in the ellipsometric angles of ~0.1° to ~0.01° or better can potentially achieve 10 times, or better, improvement in LoD.

### Supplementary Table 2: The Parameters of Real-Time Measurement Results.

| deg | VS1_Ψ | VS1_Δ | VS2_Ψ | VS2_Δ |
|---|---|---|---|---|
| 2σ_{blank} | 0.070 | 0.998 | 0.152 | 0.932 |
| Average_{blank} | 3.856 | 109.650 | 7.156 | 63.776 |
| LoB_{blank} | 3.926 | 110.648 | 7.308 | 64.708 |
| 2σ_{(2×10-8 RIU)} | 0.086 | 0.958 | 0.148 | 0.968 |
| Average_{(2×10-8 RIU)} | 3.866 | 110.30 | 7.569 | 65.693 |
| LOD_{(2×10 -8 RIU)} | 4.012 | 111.606 | 7.456 | 65.676 |

### Supplementary Table 3: The Sensitivities of OVS.

| | | Sensitivity | Highest sensitivity* |
|---|---|---|---|
| | Vernier scale | (×10⁵ deg/RIU) | (×10⁶ deg/RIU) |
| Ψ | 2 | 4.74 | 1.10 |
| | 1 | 0.09 | 0.02 |
| Δ | 2 | 19.40 | 5.90 |
| | 1 | 9.32 | 0.75 |

*The highest sensitivities are calculated from the first four measurements at 61.05°.

### Supplementary Note 7: Surface Bio-Functionalization

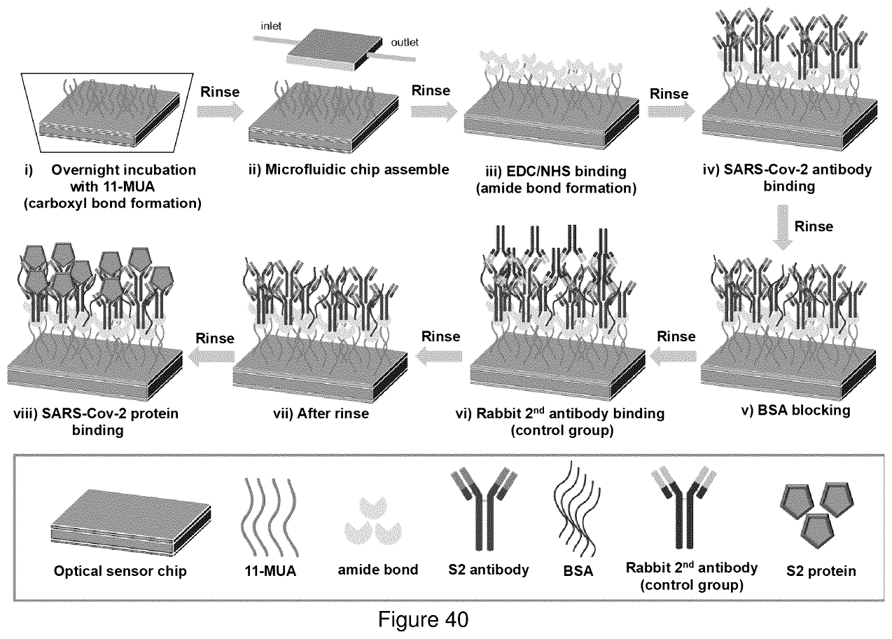

This is to be taken only as an example of functionalization (there are countless others and many more will continue to be developed). It is in no way restrictive of the proposed sensor operation. According to FIG. 40, the sensor chip is first incubated in an ethanolic solution of 10 mM 11-mercaptoundecanoic acid (MUA) (Sigma Aldrich, 450561) overnight at room temperature to form a self-assembled monolayer (SAM) denoted linker. The chip surface is then cleaned with pure ethanol and water twice and blow-dried with nitrogen gas to ensure a completely moisture-free film surface. After this step, the chip surface is modified with carboxyl groups and is ready to be incorporated into the microfluidic channel for the surface functionalization of a mouse monoclonal antibody (mAb) against the SARS-CoV-2 spike protein S2 (Thermo Fisher, MA5-35946) and the in-situ measurement of S2 protein (RayBiotech, 230-01103).

Once the microfluidic device is assembled, UPW (Invitrogen, 10977015) is delivered to the microfluidic channel by a syringe pump at a flow rate of 0.2 mL/min while the Ψ and Δ signal baseline of UPW are recorded in real-time. When the signal is stabilized (~5-10 min), a 1:1 mixture solution of 10 mM EDC (Thermo Fisher, 22980)/NHS (Sigma Aldrich, 130672) (Ethyl-3-(3-dimethylaminopropyl)-carbodiimide/N-hydroxysuccinimide) is injected into the device to activate the surface⁴¹. Briefly, the carboxyl ends of the MUA are activated by reaction with EDC/NHS mixture for 25 mins. After that, UPW is then injected to remove weakly bonded and nonspecific molecules. The SARS-CoV-2 spike protein S2 (mAbs) at a concentration of 15 g/mL is subsequently pumped into the device and then incubated for 1 h. Next, the surface is rinsed with UPW, and followed by 5 g/mL bovine serum albumin (BSA) (Sigma Aldrich, A8531) solution for 10 min to block the remaining free surface and prevent non-specific interactions. After incubation, the functionalized surface is further rinsed with UPW for 10 min. The surface is next immersed in 5 g/mL rabbit secondary antibody solution to test the sensor specificity.

After the removal of the rabbit secondary antibody by rinsing with UPW, the specific interaction and dose-dependent response (FIG. 24) of S2 protein is monitored in terms of the cumulative binding on the film surface. The stock SARS-CoV-2 spike protein is diluted in UPW with concentrations of 5, 10, 15, 20, 25 ng/mL. The stock concentration is based on the datasheet provided by the supplier (RayBiotech, 230-01103). The entire bioconjugation process is carried out at room temperature. The time required to reach the saturation for the bio-binding depends on the efficiency of the surface functionalization, and especially the binding efficiency between the antibodies and the target protein, rather than entirely on the Vernier performance itself.

### Supplementary Note 8: Thickness Tolerance Analysis

In this novel optical sensor, it is important for the design to use the precise thickness of each layer, because dispersion considerations are fundamental to achieve ZRPs overlapping conditions for both s- and p-polarizations at a given photon energy (E) and AoI. However, there are remarkable benefits once this is achieved because the relative amplitude ratio Ψ and phase difference Δ of s- and p-polarized reflectance form an OVS system, as explained in the main text.

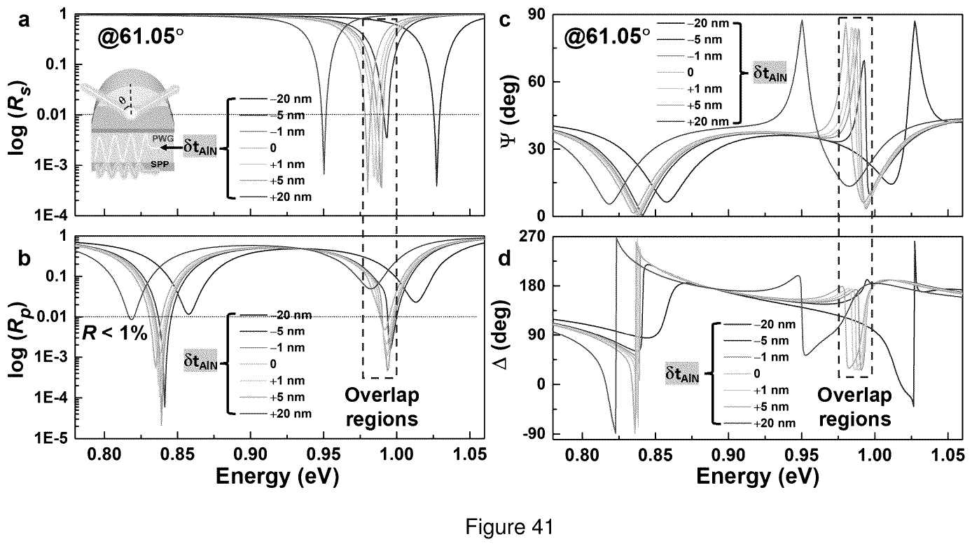

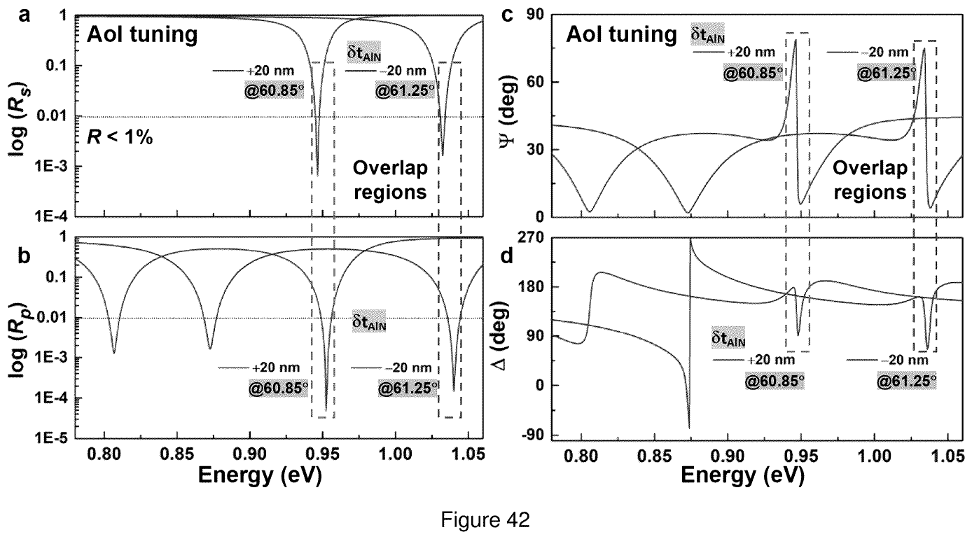

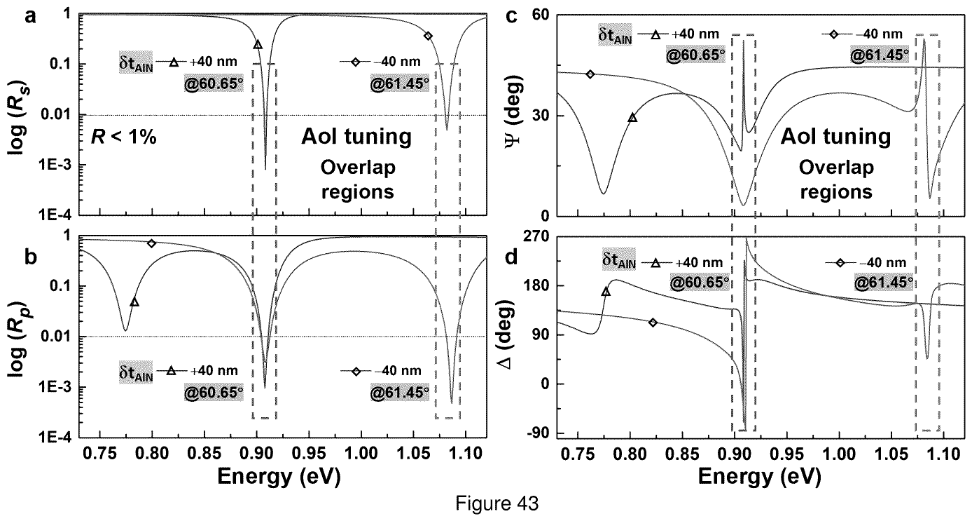

To verify the thickness tolerance, the simulations are performed to reveal the ZRPs generation and overlapping, as a function of each layer's thickness. The thickest layer, the AlN middle layer (500 nm), and the corresponding changes in Rₛ, Rₚ, Ψ, Δ spectra are first investigated when its thickness is changed as shown in FIG. 41. The criterion that Rmin<1% represents the existence of the ZRPs is defined. [Main text Ref. 6, Ref. 14] Because a zero-reflection surface can be formed in the parameter space, see Refs. 7 and 17 in the main text, such that small perturbations of the multilayer parameters (small changes in dielectric permittivity or film thickness) will not change the fact that the material dispersion curve intersects the zero-reflection surface albeit at slightly different spectral position and AoI. In these conditions, it is concluded that the thickness tolerance for the AlN layer is ±1% assuming the AoI (@61.05°) is fixed. It is noted however, that the ZRPs, and the ZRP overlap condition can be regained, by tuning the AoI even with thickness changes as large as dt_{AlN}=±4% or dt_{AlN}=±8% as shown in FIG. 42 and FIG. 43, respectively. This occurs because AlN has low optical propagation losses [main text Ref. 37], and therefore changing the AlN thickness simply shifts the PWG's modes spectral position without significantly changing their amplitude. As a consequence, the ZRPs remain, and it is possible to tune the AoI to adjust the angle-dispersive SPP mode so that the ZRPs of Rₛ and Rₚ overlap. In conclusion, if the AoI can be tuned the thickness tolerance of the AlN layer relaxes and can reach up ±8% or more. We emphasize that tolerance studies are intended only to indicate a guidance for designing an operation at a given AoI and wavelength combination. A different AlN thickness changes the PWG resonance conditions; namely wavelength and AoI, as demonstrated in FIG. 42 and FIG. 43 and also inferred from FIG. 29 showing there will be some crossing of the unperturbed SPR with the unperturbed PWG at the new AlN thickness.

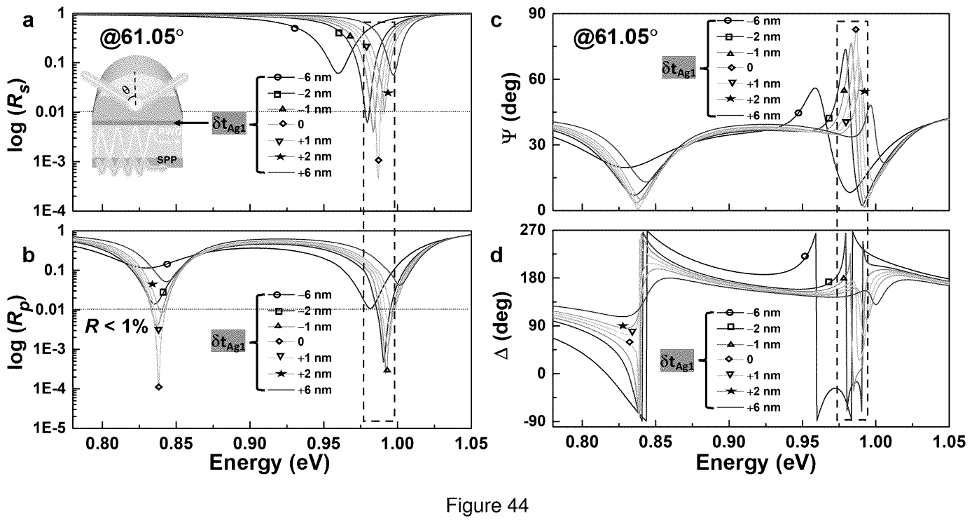

The same analysis is performed for the thin silver (Ag) layer. It is found, FIG. 44, that the thickness tolerance of the thin Ag layer is ±~10%. In this case, larger thickness fluctuations of the thin Ag layer result in ZRP changes that cannot be overcome by AoI tuning. This is because the thin Ag layer's critical function as a semitransparent mirror and waveguide: too thin and the waveguide mode efficiency will be reduced whereas if it becomes too thick then not enough light will be available to support the PWG and SPP modes. That is to say that both cases change the relative amplitudes of PWG and SPP modes and as a consequence it is not possible to simultaneously regain the ZRPs overlap via AoI tuning.

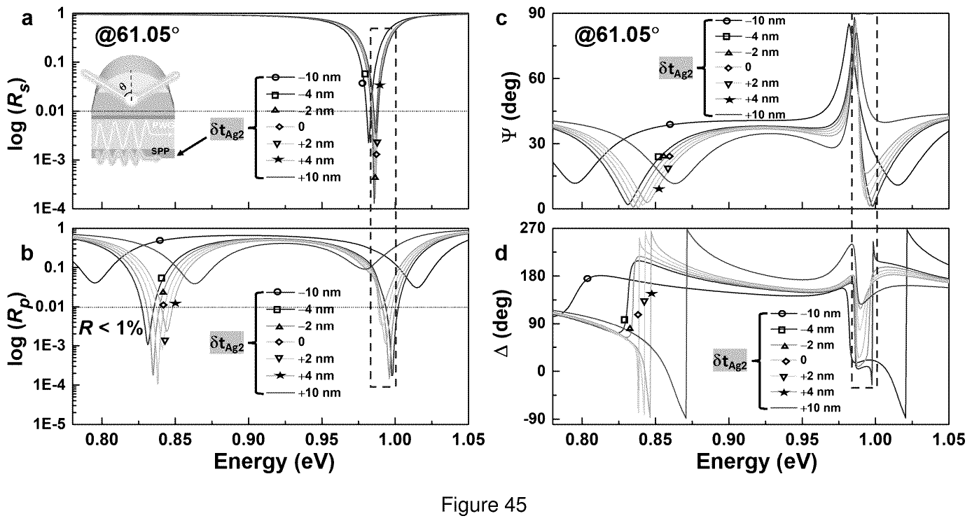

For the thick Ag layer, even though we try to adjust the AoI after changing the thickness, the angular dispersion speed of SPP mode is much higher than that of PWG mode, it is difficult to regain the ZRPs and the overlap. Moreover, the sensitivity of the surface plasmon resonance has a certain strict requirement on the metal thickness⁴². Therefore, the thickness tolerance is only given at a fixed angle. As shown in FIG. 45, the thickness tolerance of the thick Ag layer is ±8%.

### Supplementary Note 9: Deposition Parameters

The MDM multilayers are prepared in standard microscope glass slides used as substrates. First, the 1-mm thick glass substrate is cleaned with decon-90 then UPW under sonication for 10 min using UPW rinse between each step. This is followed by blow-dry with nitrogen gas (N2) to ensure a completely moisture-free surface. The target pre-sputtering is performed for 5 minutes prior to film deposition.

### Supplementary Table 4: The Summary of Deposition Parameters of Thin Films.

| | Deposition | | | Power | Deposition |
|---|---|---|---|---|---|
| Thin | pressure | N₂:Ar flow | | density | rate* |
| film | (mTorr) | (sccm) | Source | (W/cm²) | (nm/s) |
| Ag | 3 | 0:20.1 | DC | 0.44 | 0.1 |
| AlN | 3 | 8.3:11.8 | RF | 3.3 | 0.05 |

*The deposition rate is calculated from the thickness measured by ellipsometry divided by deposition time.

### Supplementary Note 10: The Optical System

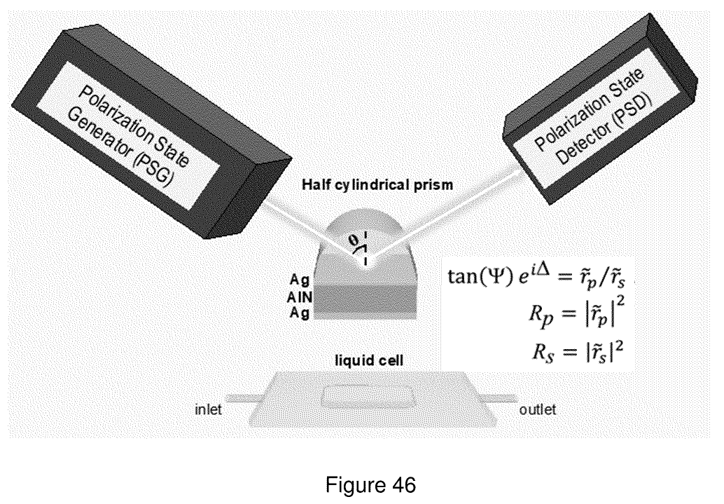

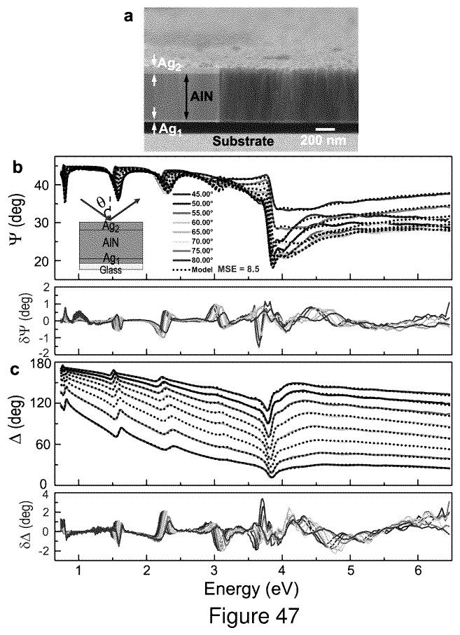

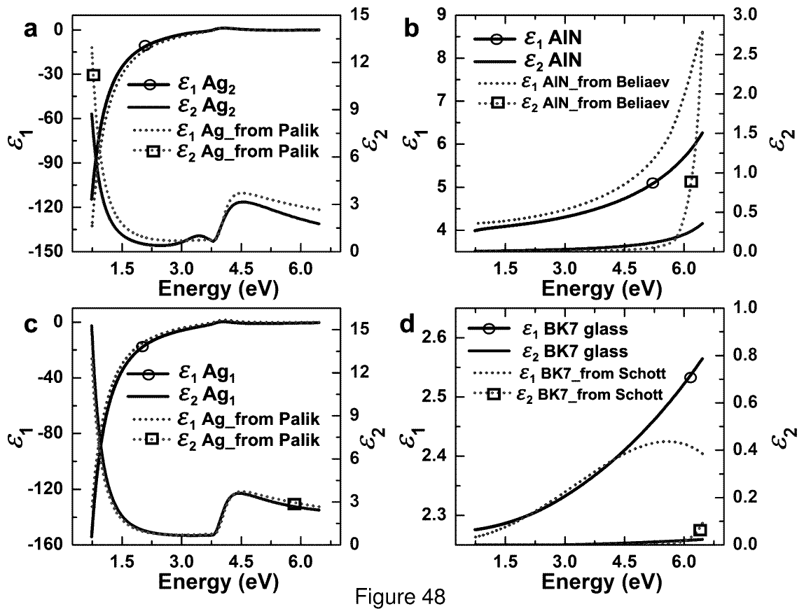

The experimental set-up is based on the TIRE configuration⁴³, as shown in FIG. 46, where a half-cylinder glass prism is used as the coupler to excite the SPP, thus it shares many similarities with SPR-based technique⁴⁴. However, a main difference is that in SPR commonly only the intensity information for p-polarized reflection is used, whereas TIRE measures the p- to s-ratio of polarization intensities and their relative phase difference, corresponding to the ellipsometric angles Ψ and Δ. In principle then, while TIRE is thus more complex it offers two significant advantages over standard SPR techniques: (i) the complex polarization ratio provides self-reference capability for the overall measurements greatly decreasing noise level; and (ii) it enables a phase measurement strategy. In particular, the complex ratio notably minimizes amplitude noise related to the light source fluctuations enabling TIRE measurements of the amplitude ratio (Ψ) and phase difference (Δ) with low LoD as a high SNR is obtainable⁴⁵. An ellipsometer or other suitable polarimetric instrument with a Polarization State Generator (PSG) and Polarization State Detector (PSD) enable quantification of Rₚ and Rₛ, such that their ratio

$$tan ( Ψ ) = \sqrt{\frac{{R}_{p}}{{R}_{s}}} ,$$

or other related polarimetric representations such as for example (N, C, S), can also be used.

### Supplementary Note 11: Characterization

The successful fabrication of the multilayered structure is verified by the cross-section SEM image and ellipsometry measurements of the multilayer films without the prism. The total thickness of the MDM multilayer film is around 560 nm, making the structure an attractive candidate for compact, integrated optical chips.

In addition to the thickness extraction discussed above, the pair of ellipsometric parameters, Ψ and Δ, also allows the extraction of optical constants of each layer. We use Tauc-Lorentz oscillators

$$ε ( E ) = {ε}_{∞} + {ε}_{TL}^{′} + i {ε}_{TL}^{″} = {ε}_{∞} + \frac{2}{π} v . p . {\int }_{{E}_{g}}^{∞} \frac{{ξε}_{TL}^{″} ( ξ )}{{ξ}^{2} - {E}^{2}} d ξ + {iH}_{{E}_{g}} ( E ) \frac{1}{E} \frac{{AE}_{0} {Γ ( E - {E}_{g} )}^{2}}{{( {E}^{2} - {E}_{0}^{2} )}^{2} + {Γ}^{2} {E}^{2}}$$

to describe the electronic interband transition, Drude oscillator

$${ε}_{Drude} = \frac{- {ℏ}^{2}}{{ε}_{0} ρ ( τ {E}^{2} + i ℏ E )}$$

models to describe the metallic response at low photon energies, and Lorentz oscillator

$${ε}_{Lorentz} = \frac{{A}_{L}^{2}}{- {E}_{L}^{2} - {E}^{2} - i {Γ}_{L} E}$$

describe the material absorption and silver plasmon polariton transitions^{46,47}, where ε_{∞} is a contribution in the dielectric function of high energy interband transition, v.p. is the Cauchy principal part of the integral with an additional fitting parameter ε_{∞} that is included, E is photon energy, E_{g} is optical band gap, H_{Eg} (E) is Heaviside step function equal one if E>E_{g} and zero otherwise, E₀ is the optical transition energy at certain energy positions, A is amplitude, Γ is the spectral broadening parameter, h is reduced Planck's constant, ε₀ is vacuum permittivity, ρ is resistivity, and Ψ is scattering time. The regression fit of ellipsometric data is performed using the commercial software CompleteEASE (J.A. Woollam Co. 5.15h).

### Supplementary Table 5: Parameters of the Oscillators Describing Thick Ag Layer.

| Layer | Oscillators | Parameters | | | |
|---|---|---|---|---|---|
| Thick Ag | Tauc-Lorentz | A (eV) | Γ (eV) | E₀ (eV) | E_{g} (eV) |
| | | 419.93 ± 0.51 | 0.79 ± 0.08 | 3.81 ± 0.02 | 3.76 ± 0.01 |

| | | | |
|---|---|---|---|
| Lorentz | A_{L} (eV) | Γ_{L} (eV) | E_{L} (eV) |
| | 0.92 ± 0.1 | 0.83 ± 0.05 | 3.47 ± 0.04 |

| | | |
|---|---|---|
| Drude | ρ (Ohm · cm) | τ (fs) |
| | 6.33 × 10⁻⁶ ± 4.18 × 10⁻⁷ | 12.07 ± 0.28 |

| Layer | Oscillators | Parameters | | | |
|---|---|---|---|---|---|
| AlN | Tauc-Lorentz | A (eV) | Γ (eV) | E₀ (eV) | E_{g} (eV) |
| | | 754.41 ± 2.69 | 32.86 ± 0.73 | 6.61 ± 0.45 | 7.76 ± 0.03 |

| | | | |
|---|---|---|---|
| Lorentz | A_{L} (eV) | Γ_{L} (eV) | E_{L} (eV) |
| | 6.55 ± 0.02 | 0.81 ± 0.04 | 8.09 ± 0.06 |

### Supplementary Table 7: Parameters of the Oscillators for Thin Ag Layer.

| Layer | Oscillators | Parameters | | | |
|---|---|---|---|---|---|
| Thin Ag | Tauc-Lorentz | A (eV) | Γ (eV) | E₀ (eV) | E_{g} (eV) |
| | | 271.29 ± 3.43 | 0.39 ± 0.02 | 4.28 ± 0.01 | 3.95 ± 0.01 |

| | | | |
|---|---|---|---|
| Lorentz | A_{L} (eV) | Γ_{L} (eV) | E_{L} (eV) |
| | 4.36 ± 0.27 | 15.49 ± 0.15 | 14.64 ± 0.38 |

| | | |
|---|---|---|
| Drude | ρ (Ohm · cm) | τ (fs) |
| | 4.17 × 10⁻⁶ ± 1.4 × 10⁻⁷ | 14.18 ± 0.53 |

### Supplementary Table 8: Parameters of the Oscillators for BK7 Glass.

| Layer | Oscillators | Parameters | | | |
|---|---|---|---|---|---|
| BK7 | Tauc-Lorentz | A (eV) | Γ (eV) | E₀ (eV) | E_{g} (eV) |
| glass | | 59.36 ± 0.11 | 0.94 ± 0.79 | 19.57 ± 0.67 | 2.39 ± 0.06 |

### Supplementary Note 12: Multilayer Stability

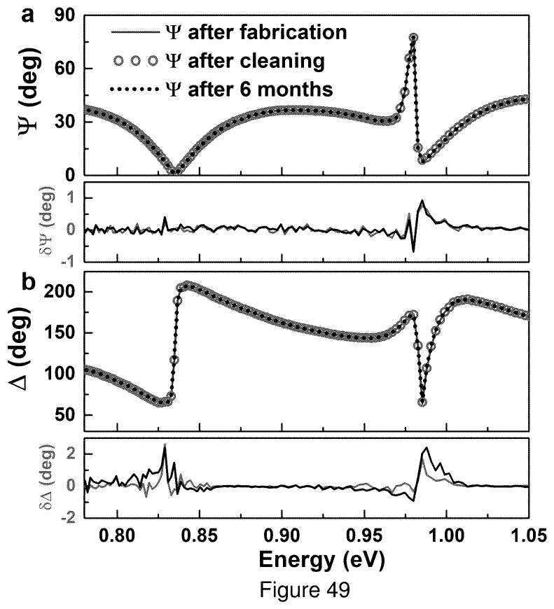

To examine the degradation of the sensor, we have regularly recorded the Ψ and Δ spectra of the multilayer after fabrication and after use. To clean the chip surface after the bioconjugation for reuse, the multilayer film is immersed to pure ethanol overnight. The removal of the biomolecules on the surface is verified through the Ψ and Δ spectra. After overnight soaking, the cleaned sensor matches smoothly with the initial unfunctionalized sensor and is ready for reuse. The Ψ and Δ spectra are shown in FIG. 49. As can be seen, there is no considerable change in the spectra and incident angle after 6 months.

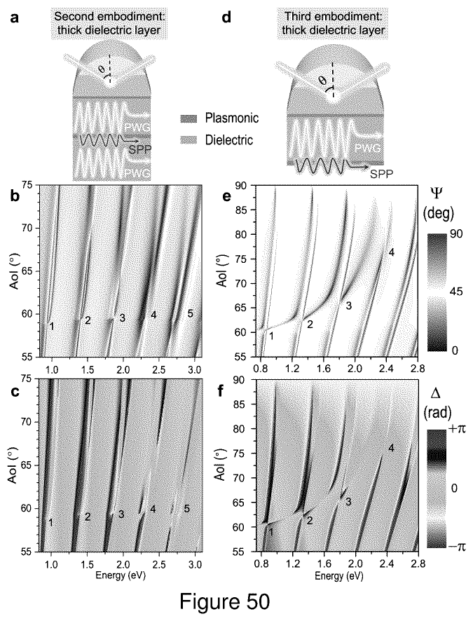

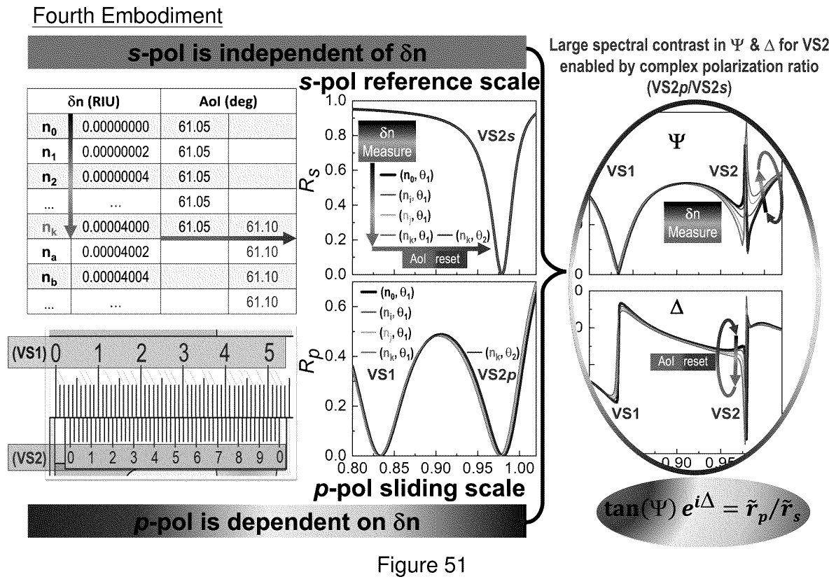

The Second embodiment and the Third embodiment with thicker dielectric layer thickness are summarized with reference to FIG. 50. According to FIG. 50, the Second embodiment (a, b, c) and Third embodiment (d, e, f) also work for the case where the dielectric layer thickness is very thick. In some examples, the thickness of the dielectric layer may be larger than 1000 nm, or can even larger than 5000 nm. Moreover, the thicker system provides multiple spectral sensing points and enables multispectral and multiplexing functions.

### IV. Fourth Embodiment

OVS Sensing with Ultralow Limit-of-Detection and Large Dynamic Range by Tuning of Zero-Reflection Points

This embodiment provides simultaneous implementation of two orthogonally polarized ZRPs and spectral overlap of s-polarized photonic modes with the coupled, p-polarized resonances; and polarimetry-based sensing where the relatively insensitive s-polarized ZRPs provide internal references to boost the sensor performance in terms of the amplitude ratio (Ψ) and phase difference (Δ) of the s- and p-polarized reflectance thereby naturally forming a refinement measuring scale akin to a Vernier scale. Remarkably, the precise manipulation of the double ZRPs (Rₚ and Rₛ) via the AoI control enables a second metric that yields ultrahigh sensitivity and can be reset to the original spot over a large dynamic range. This capability is enabled because the topologically protected zeros can consistently exist by simply adjusting the AoI.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features. Some embodiments of the invention may lack one or more of these optional features.

### REFERENCES

All referenced literatures throughout this disclosure are incorporated herein by reference in their entirety, which include the following references:

### 1. Reference for the First Embodiment

[1] Y. Zhang, M. T. Phoo, Y. Foo, X. Li, Y. W. Lam, and J. A. Zapien, “Vernier Ellipsometry Sensing with Ultralow Limit-of-Detection and Large Dynamic Range by Tuning of Zero-Reflection Points,” Laser & photonics reviews, vol. 18, no. 7, 2024.

### 2. References for the Second Embodiment

1. Xu, Y. et al. Optical Refractive Index Sensors with Plasmonic and Photonic Structures: Promising and Inconvenient Truth. Adv Opt Mater 7, 31-33 (2019).
2. Altug, H., Oh, S. H., Maier, S. A. & Homola, J. Advances and applications of nanophotonic biosensors. Nat Nanotechnol 17, 5-16 (2022).
3. Kabashin, A. V., Kravets, V. G. & Grigorenko, A. N. Label-free optical biosensing: going beyond the limits. Chem Soc Rev 52, 6554-6585 (2023).
4. Kravets, V. G., Kabashin, A. V., Barnes, W. L. & Grigorenko, A. N. Plasmonic Surface Lattice Resonances: A Review of Properties and Applications. Chem Rev 118, 5912-5951 (2018).
5. Jing, J. Y., Wang, Q., Zhao, W. M. & Wang, B. T. Long-range surface plasmon resonance and its sensing applications: A review. Opt Lasers Eng 112, 103-118 (2019).
6. Minopoli, A., Acunzo, A., Della Ventura, B. & Velotta, R. Nanostructured Surfaces as Plasmonic Biosensors: A Review. Adv Mater Interfaces 9, (2022).
7. Ahmadivand, A. & Gerislioglu, B. Photonic and Plasmonic Metasensors. Laser Photon Rev 16, 1-34 (2022).
8. Liedberg, B., Nylander, C. & Lunström, I. Surface plasmon resonance for gas detection and biosensing. Sensors and Actuators 4, 299-304 (1983).
9. Zhu, S. et al. Label-free biosensing with singular-phase-enhanced lateral position shift based on atomically thin plasmonic nanomaterials. Light Sci Appl 13, (2024).
10. Lee, K. S., Lee, T. S., Kim, I. & Kim, W. M. Parametric study on the bimetallic waveguide coupled surface plasmon resonance sensors in comparison with other configurations. J Phys D Appl Phys 46, (2013).
11. Berini, P. Long-range surface plasmon polaritons. Adv Opt Photonics 1, 484 (2009).
12. Slavik, R. & Homola, J. Ultrahigh resolution long range surface plasmon-based sensor. Sens Actuators B Chem 123, 10-12 (2007).
13. Hayashi, S., Nesterenko, D. V. & Sekkat, Z. Waveguide-coupled surface plasmon resonance sensor structures: Fano lineshape engineering for ultrahigh-resolution sensing. J Phys D Appl Phys 48, (2015).
14. Shrivastav, A. M. et al. Engineering the penetration depth of nearly guided wave surface plasmon resonance towards application in bacterial cells monitoring. Sens Actuators B Chem 345, (2021).
15. Bajaj, A. et al. Biofilm growth monitoring using guided wave ultralong-range Surface Plasmon Resonance: A proof of concept. Biosens Bioelectron 228, (2023).
16. Danilov, A. et al. Ultra-narrow surface lattice resonances in plasmonic metamaterial arrays for biosensing applications. Biosens Bioelectron 104, 102-112 (2018).
17. Dowran, M., Kumar, A., Lawrie, B. J., Pooser, R. C. & Marino, A. M. Quantum-enhanced plasmonic sensing. Optica 5, 628 (2018).
18. Lee, C. et al. Quantum Plasmonic Sensors. Chem Rev 121, 4743-4804 (2021).
19. Malassis, L. et al. Topological darkness in self-assembled plasmonic metamaterials. Advanced Materials 26, 324-330 (2014).
20. Ermolaev, G. et al. Topological phase singularities in atomically thin high-refractive-index materials. Nat Commun 13, 1-9 (2022).
21. Tselikov, G. I. et al. Topological Darkness: How to Design a Metamaterial for Optical Biosensing with Ultrahigh Sensitivity. ACS Nano 17, 19338-19348 (2023).
22. Hales, T. C. The Jordan Curve Theorem, Formally and Informally. The American Mathematical Monthly 114, 882-894 (2007).
23. Song, H. et al. Dispersion Topological Darkness at Multiple Wavelengths and Polarization States. Adv Opt Mater 5, 1-8 (2017).
24. Cusworth, E., Kravets, V. G. & Grigorenko, A. N. Topological Darkness in Optical Heterostructures: Prediction and Confirmation. ACS Photonics 10, 3715-3722 (2023).
25. Tsurimaki, Y. et al. Topological Engineering of Interfacial Optical Tamm States for Highly Sensitive Near-Singular-Phase Optical Detection. ACS Photonics 5, 929-938 (2018).
26. Baraldi, G., Garcia Pardo, M., Gonzalo, J., Serna, R. & Toudert, J. Self-Assembled Nanostructured Photonic-Plasmonic Metasurfaces for High-Resolution Optical Thermometry. Adv Mater Interfaces 5, 1-7 (2018).
27. Svedendahl, M., Verre, R. & Kall, M. Refractometric biosensing based on optical phase flips in sparse and short-range-ordered nanoplasmonic layers. Light Sci Appl 3, (2014).
28. Toudert, J. et al. Plasmonic Optical Interferences for Phase-Monitored Nanoscale Sensing in Low-Loss Three-Dimensional Metamaterials. ACS Photonics 2, 1443-1450 (2015).
29. Zhang, Y. et al. Vernier Ellipsometry Sensing with Ultralow Limit-of-Detection and Large Dynamic Range by Tuning of Zero-Reflection Points. Laser Photon Rev 2300801, 1-10 (2024).
30. Paniagua-Dominguez, R. et al. Generalized Brewster effect in dielectric metasurfaces. Nat Commun 7, (2016).
31. Nugroho, F. A. A. et al. Inverse designed plasmonic metasurface with parts per billion optical hydrogen detection. Nat Commun 13, (2022).
32. High, A. A. et al. Visible-frequency hyperbolic metasurface. Nature 522, 192-196 (2015).
33. Hsiao, H. H., Chu, C. H. & Tsai, D. P. Fundamentals and Applications of Metasurfaces. Small Methods 1, 1-20 (2017).
34. Chen, W. et al. Large-Area Nanoimprinted Colloidal Au Nanocrystal-Based Nanoantennas for Ultrathin Polarizing Plasmonic Metasurfaces. Nano Lett 15, 5254-5260 (2015).
35. Shalabney, A. & Abdulhalim, I. Electromagnetic fields distribution in multilayer thin film structures and the origin of sensitivity enhancement in surface plasmon resonance sensors. Sens Actuators A Phys 159, 24-32 (2010).
36. Isaacs, S. & Abdulhalim, I. Long range surface plasmon resonance with ultra-high penetration depth for self-referenced sensing and ultra-low detection limit using diverging beam approach. Appl Phys Lett 106, (2015).
37. Lahav, A., Auslender, M. & Abdulhalim, I. Sensitivity enhancement of guided-wave surface-plasmon resonance sensors. Opt Lett 33, 2539 (2008).
38. CompleteEASE® Software Manual. in Data Acquisition and Analysis Software for J.A. Woollam Co. Spectroscopic Ellipsometers (2014).
39. You, J.-B., Lee, W.-J., Won, D. & Yu, K. Multiband perfect absorbers using metal-dielectric films with optically dense medium for angle and polarization insensitive operation. Opt Express 22, 8339 (2014).
40. Cheng, H., Sun, Y. & Hing, P. The influence of deposition conditions on structure and morphology of aluminum nitride films deposited by radio frequency reactive sputtering. Thin Solid Films 434, 112-120 (2003).
41. Xie, B. W. et al. Substrate angle-induced fully c-axis orientation of AlN films deposited by off-normal DC sputtering method. Rare Metals 40, 3668-3675 (2021).
42. Ababneh, A. et al. Optical characterization of sputtered aluminum nitride thin films—correlating refractive index with degree of c-axis orientation. Thin Solid Films 693, 137701 (2020).
43. Aspnes, D. E. Optical properties of thin films. Thin Solid Films 89, 249-262 (1982).
44. Shokhovets, S. et al. Determination of the anisotropic dielectric function for wurtzite AlN and GaN by spectroscopic ellipsometry. J Appl Phys 94, 307-312 (2003).
45. Jiang, W., Lin, W., Li, S., Chen, J. & Kang, J. Optical anisotropy of AlN epilayer on sapphire substrate investigated by variable-angle spectroscopic ellipsometry. Opt Mater (Amst) 32, 891-895 (2010).
46. Gartia, M. R., Hsiao, A., Pokhriyal, A., Seo, S., Kulsharova, G., Cunningham, B. T., Bond, T. C., Liu, G. L. Colorimetric Plasmon Resonance Imaging Using Nano Lycurgus Cup Arrays. Adv. Optical Mater 1, 68-76 (2013).
47. Yanik, A. A. et al. Seeing protein monolayers with naked eye through plasmonic Fano resonances. Proc Natl Acad Sci USA 108, 11784-11789 (2011).
48. Huang, Y. H., Ho, H. P., Kong, S. K. & Kabashin, A. V. Phase-sensitive surface plasmon resonance biosensors: Methodology, instrumentation and applications. Ann Phys 524, 637-662 (2012).
49. Wan, Y., Zheng, Z., Cheng, M., Kong, W. & Liu, K. Polarimetric-phase-enhanced intensity interrogation scheme for surface wave optical sensors with low optical loss. Sensors (Switzerland) 18, (2018).
50. Deng, S., Wang, P. & Yu, X. Phase-sensitive surface plasmon resonance sensors: Recent progress and future prospects. Sensors (Switzerland) 17, (2017).
51. Committee, A. M. Recommendations for the definition, estimation and use of the detection limit. Analyst 112, 199-204 (1987).
52. Lavin, Á. et al. On the determination of uncertainty and limit of detection in label-free biosensors. Sensors (Switzerland) 18, (2018).
53. Loock, H. P. & Wentzell, P. D. Detection limits of chemical sensors: Applications and misapplications. Sens Actuators B Chem 173, 157-163 (2012).
54. Wang, D. et al. Recent advances in surface plasmon resonance imaging sensors. Sensors (Switzerland) 19, (2019).
55. Shi, H. et al. A symmetrical optical waveguide based surface plasmon resonance biosensing system. Sens Actuators B Chem 185, 91-96 (2013).
56. Jiang, L. et al. Multifunctional Hyperbolic Nanogroove Metasurface for Submolecular Detection. Small 13, 1-8 (2017).
57. Liu, L. et al. A two-dimensional polarization interferometry based parallel scan angular surface plasmon resonance biosensor. Review of Scientific Instruments 82, (2011).
58. Wang, G., Wang, K., Ren, J., Ma, S. & Li, Z. A novel doublet-based surface plasmon resonance biosensor via a digital Gaussian filter method. Sens Actuators B Chem 360, 131680 (2022).
59. Wang, G., Wang, C., Yang, R., Liu, W. & Sun, S. A sensitive and stable surface plasmon resonance sensor based on monolayer protected silver film. Sensors (Switzerland) 17, (2017).
60. Moirangthem, R. S., Chang, Y.-C. & Wei, P.-K. Investigation of surface plasmon biosensing using gold nanoparticles enhanced ellipsometry. Opt Lett 36, 775 (2011).
61. Moirangthem, R. S., Yaseen, M. T., Wei, P.-K., Cheng, J.-Y. & Chang, Y.-C. Enhanced localized plasmonic detections using partially-embedded gold nanoparticles and ellipsometric measurements. Biomed Opt Express 3, 899 (2012).
62. Chung, K. et al. Enhancing the Performance of Surface Plasmon Resonance Biosensor via Modulation of Electron Density at the Graphene-Gold Interface. Adv Mater Interfaces 5, 1-8 (2018).
63. Kaur, B., Kumar, S. & Kaushik, B. K. 2D Materials-Based Fiber Optic SPR Biosensor for Cancer Detection at 1550 nm. IEEE Sens J 21, 23957-23964 (2021).
64. Liu, Z. et al. Phase Interrogation Sensor Based on All-Dielectric BIC Metasurface. Nano Lett 23, 10441-10448 (2023).
65. Barth, I., Conteduca, D., Reardon, C., Johnson, S. & Krauss, T. F. Common-path interferometric label-free protein sensing with resonant dielectric nanostructures. Light Sci Appl 9, (2020).
66. Etxebarria-Elezgarai, J. et al. Amplifying Sensing Capabilities: Combining Plasmonic Resonances and Fresnel Reflections through Multivariate Analysis. Small Methods 2301445, 1-10 (2024).
67. Phan, Q. H., Yang, P. M. & Lo, Y. L. Surface plasmon resonance prism coupler for gas sensing based on Stokes polarimetry. Sens Actuators B Chem 216, 247-254 (2015).
68. Li, X. & Liu, X. Group III nitride nanomaterials for biosensing. Nanoscale 9, 7320-7341 (2017).
69. Vashist, S. K., Lam, E., Hrapovic, S., Male, K. B. & Luong, J. H. T. Immobilization of antibodies and enzymes on 3-aminopropyltriethoxysilane-functionalized bioanalytical platforms for biosensors and diagnostics. Chem Rev 114, 11083-11130 (2014).
70. Khoshbin, Z., Verdian, A., Housaindokht, M. R., Izadyar, M. & Rouhbakhsh, Z. Aptasensors as the future of antibiotics test kits—a case study of the aptamer application in the chloramphenicol detection. Biosens Bioelectron 122, 263-283 (2018).
71. Junza, A. et al. Multiclass method for the determination of quinolones and β-lactams, in raw cow milk using dispersive liquid-liquid microextraction and ultra high performance liquid chromatography-tandem mass spectrometry. J Chromatogr A 1356, 10-22 (2014).
72. Sun, L. et al. Quantitative analysis of amoxicillin, its major metabolites and ampicillin in eggs by liquid chromatography combined with electrospray ionization tandem mass spectrometry. Food Chem 192, 313-318 (2016).
73. Sahebi, H., Konoz, E., Ezabadi, A., Niazi, A. & Ahmadi, S. H. Simultaneous determination of five penicillins in milk using a new ionic liquid-modified magnetic nanoparticle based dispersive micro-solid phase extraction followed by ultra-performance liquid chromatography-tandem mass spectrometry. Microchemical Journal 154, (2020).
74. Mishra, R. K., Pulidindi, I. N., Kabha, E. & Gedanken, A. In situ formation of carbon dots aids ampicillin sensing. Analytical Methods 8, 2441-2447 (2016).
75. Kaur, S., Garg, M., Mittal, S., Wangoo, N. & Sharma, R. K. Copper based facile, sensitive and low cost colorimetric assay for ampicillin sensing and quantification in nano delivery system. Sens Actuators B Chem 248, 234-239 (2017).
76. Shrivas, K., Sahu, J., Maji, P. & Sinha, D. Label-free selective detection of ampicillin drug in human urine samples using silver nanoparticles as a colorimetric sensing probe. New Journal of Chemistry 41, 6685-6692 (2017).
77. HAQUE, S. K. M. OPTIMIZED AND VALIDATED SPECTROPHOTOMETRIC METHOD FOR THE DETERMINATION OF AMPICILLIN IN PHARMACEUTICAL FORMULATIONS. Int J Pharm Pharm Sci 34-38 (2021) doi:10.22159/ijpps.2021v13i2.40025.
78. Luo, Z. et al. Fluorescent aptasensor for antibiotic detection using magnetic bead composites coated with gold nanoparticles and a nicking enzyme. Anal Chim Acta 984, 177-184 (2017).
79. Simmons, M. D., Miller, L. M., Sundström, M. O. & Johnson, S. Aptamer-based detection of ampicillin in urine samples. Antibiotics 9, 1-16 (2020).
80. Esmaelpourfarkhani, M., Abnous, K., Taghdisi, S. M. & Chamsaz, M. A novel turn-off fluorescent aptasensor for ampicillin detection based on perylenetetracarboxylic acid diimide and gold nanoparticles. Biosens Bioelectron 164, (2020).
81. Lin, H. et al. A fluorescent sensor-assisted paper-based competitive lateral flow immunoassay for the rapid and sensitive detection of ampicillin in hospital wastewater. Micromachines (Basel) 11, (2020).
82. Liu, X. et al. Novel nanoarchitecture of Co-MOF-on-TPN-COF hybrid: Ultralowly sensitive bioplatform of electrochemical aptasensor toward ampicillin. Biosens Bioelectron 123, 59-68 (2019).
83. Wang, M. et al. Covalent organic framework-based electrochemical aptasensors for the ultrasensitive detection of antibiotics. Biosens Bioelectron 132, 8-16 (2019).
84. Yuan, R., Yan, Z., Shaga, A. & He, H. Design and fabrication of an electrochemical sensing platform based on a porous organic polymer for ultrasensitive ampicillin detection. Sens Actuators B Chem 327, (2021).
85. Flauzino, J. M. R. et al. Click and Detect: Versatile Ampicillin Aptasensor Enabled by Click Chemistry on a Graphene-Alkyne Derivative. Small 19, (2023).
86. Gawronska, M., Kowalik, M. & Makowski, M. Recent advances in medicinal chemistry of ampicillin: Derivatives, metal complexes, and sensing approaches. TrAC—Trends in Analytical Chemistry vol. 155 Preprint at https://doi.org/10.1016/j.trac.2022.116691 (2022).

### References for the Supplementary Information of the Second Embodiment

1. Oates, T. W. H., Wormeester, H. & Arwin, H. Characterization of plasmonic effects in thin films and metamaterials using spectroscopic ellipsometry. Prog Surf Sci 86, 328-376 (2011).
2. Chabot, V., Miron, Y., Grandbois, M. & Charette, P. G. Long range surface plasmon resonance for increased sensitivity in living cell biosensing through greater probing depth. Sens Actuators B Chem 174, 94-101 (2012).
3. Little, S. A., Collins, R. W. & Marsillac, S. Analysis of interband, intraband, and plasmon polariton transitions in silver nanoparticle films via in situ real-time spectroscopic ellipsometry. Appl Phys Lett 98, (2011).
4. Marsillac, S., Little, S. A. & Collins, R. W. A broadband analysis of the optical properties of silver nanoparticle films by in situ real time spectroscopic ellipsometry. Thin Solid Films 519, 2936-2940 (2011).
5. Zhang, Y. et al. Vernier Ellipsometry Sensing with Ultralow Limit-of-Detection and Large Dynamic Range by Tuning of Zero-Reflection Points. Laser Photon Rev 2300801, 1-10 (2024).
6. Danilov, A. et al. Ultra-narrow surface lattice resonances in plasmonic metamaterial arrays for biosensing applications. Biosens Bioelectron 104, 102-112 (2018).
7. Zhu, S. et al. Label-free biosensing with singular-phase-enhanced lateral position shift based on atomically thin plasmonic nanomaterials. Light Sci Appl 13, (2024).
8. Hojat, N., Gentile, P., Ferreira, A. M. & Siller, L. Automatic pore size measurements from scanning electron microscopy images of porous scaffolds. Journal of Porous Materials 30, 93-101 (2023).

### References for the Third Embodiment

[1] L. Feng, Y.-L. Xu, W. S. Fegadolli, M.-H. Lu, J. E. B. Oliveira, V. R. Almeida, Y.-F. Chen, A. Scherer, Nat. Mater. 2013, 12, 108.
[2] L. Feng, X. Zhu, S. Yang, H. Zhu, P. Zhang, X. Yin, Y. Wang, X. Zhang, Opt. Express 2014, 22, 1760.
[3] V. G. Kravets, F. Schedin, R. Jalil, L. Britnell, R. V. Gorbachev, D. Ansell, B. Thackray, K. S. Novoselov, A. K. Geim, A. V. Kabashin, A. N. Grigorenko, Nat. Mater. 2013, 12, 304.
[4] Y. Tsurimaki, J. K. Tong, V. N. Boriskin, A. Semenov, M. I. Ayzatsky, Y. P. Machekhin, G. Chen, S. V. Boriskina, ACS Photonics 2018, 5, 929.
[5] S. Kim, M. S. Jang, V. W. Brar, K. W. Mauser, L. Kim, H. A. Atwater, Nano Lett. 2018, 18, 971.
[6] K. V. Sreekanth, S. Han, R. Singh, Adv. Mater. 2018, 30, 1706696.
[7] H. Song, N. Zhang, J. Duan, Z. Liu, J. Gao, M. H. Singer, D. Ji, A. R. Cheney, X. Zeng, B. Chen, S. Jiang, Q. Gan, Adv. Optical Mater 2017, 5, 1700166.
[8] R. Paniagua-Dominguez, Y. F. Yu, A. E. Miroshnichenko, L. A. Krivitsky, Y. H. Fu, V. Valuckas, L. Gonzaga, Y. T. Toh, A. Y. S. Kay, B. Luk'yanchuk, A. I. Kuznetsov, Nat. Commun. 2016, 7, 10362.
[9] D. Brewster, Philos. Trans. R. Soc. Lond. 1815, 105, 125.
[10] S. Deng, P. Wang, X. Yu, Sensors 2017, 17, 2819.
[11] A. Shalabney, I. Abdulhalim, Laser Photonics Rev. 2011, 5, 571.
[12] A. V. Kabashin, S. Patskovsky, A. N. Grigorenko, Opt. Express 2009, 17, 21191.
[13] D. Jariwala, A. R. Davoyan, G. Tagliabue, M. C. Sherrott, J. Wong, H. A. Atwater, Nano Lett. 2016, 16, 5482.
[14] A. Berkhout, A. F. Koenderink, ACS Photonics 2019, 6, 2917.
[15] K. V. Sreekanth, S. Sreejith, S. Han, A. Mishra, X. Chen, H. Sun, C. T. Lim, R. Singh, Nat. Commun. 2018, 9, 369.
[16] P. A. Thomas, K. S. Menghrajani, W. L. Barnes, Nat. Commun. 2022, 13, 1809.
[17] G. Ermolaev, K. Voronin, D. G. Baranov, V. Kravets, G. Tselikov, Y. Stebunov, D. Yakubovsky, S. Novikov, A. Vyshnevyy, A. Mazitov, I. Kruglov, S. Zhukov, R. Romanov, A. M. Markeev, A. Arsenin, K. S. Novoselov, A. N. Grigorenko, V. Volkov, Nat. Commun. 2022, 13, 2049.
[18] S. K. Ozdemir, S. Rotter, F. Nori, L. Yang, Nat. Mater. 2019, 18, 783.
[19] D. Zhao, S. Ke, Q. Liu, B. Wang, P. Lu, Opt. Express 2018, 26, 2817.
[20] H. Hodaei, A. U. Hassan, S. Wittek, H. Garcia-Gracia, R. El-Ganainy, D. N. Christodoulides, M. Khajavikhan, Nature 2017, 548, 187.
[21] J.-H. Park, A. Ndao, W. Cai, L. Hsu, A. Kodigala, T. Lepetit, Y.-H. Lo, B. Kanté, Nat. Phys. 2020, 16, 462.
[22] I. Inou, M. Fujimoto, K. Bando, ACS Appl. Nano Mater. 2021, 4, 250.
[23] X. Liu, T. Galfsky, Z. Sun, F. Xia, E.-C. Lin, Y.-H. Lee, S. Kéna-Cohen, V. M. Menon, Nat. Photonics 2014, 9, 30.
[24] Y. M. Qing, Y. Ren, D. Lei, H. F. Ma, T. J. Cui, J Opt 2022, 24, 024009.
[25] R. L. Pinals, F. Ledesma, D. Yang, N. Navarro, S. Jeong, J. E. Pak, L. Kuo, Y.-C. Chuang, Y.-W. Cheng, H.-Y. Sun, M. P. Landry, Nano Lett. 2021, 21, 2272.
[26] Y. Xu, P. Bai, X. Zhou, Y. Akimov, C. E. Png, L.-K. Ang, W. Knoll, L. Wu, Adv. Optical Mater 2019, 7, 1801433.
[27] X. Liu, M. Li, R. Singh, Y. Wang, Y. Xie, X. Su, F. Gao, G. Li, D. Kumar, B. Zhang, S. Kumar, Appl. Opt. 2022, 61, 2327.
[28] S. Sharma, V. S. Chaudhary, D. Kumar, Mater Today Proc 2020, 33, 2122.
[29] R. Ameling, H. Giessen, Laser Photonics Rev. 2013, 7, 141.
[30] N. Odebo Lank, R. Verre, P. Johansson, M. Kall, Nano Lett. 2017, 17, 3054.
[31] M. Elkabbash, T. Letsou, S. A. Jalil, N. Hoffman, J. Zhang, J. Rutledge, A. R. Lininger, C.-H. Fann, M. Hinczewski, G. Strangi, C. Guo, Nat. Nanotechnol. 2021, 16, 440.
[32] A. Smolyaninov, A. El Amili, F. Vallini, S. Pappert, Y. Fainman, Nat. Photonics 2019, 13, 431.
[33] J. W. Stewart, J. H. Vella, W. Li, S. Fan, M. H. Mikkelsen, Nat. Mater. 2020, 19, 158.
[34] L. Chang, S. Liu, J. E. Bowers, Nat. Photonics 2022, 16, 95.
[35] Y. Kuai, J. Chen, Z. Fan, G. Zou, J. R. Lakowicz, D. Zhang, Nat. Commun 2021, 12, 6835.
[36] T. W. H. Oates, H. Wormeester, H. Arwin, Prog. Surf Sci. 2011, 86, 328.
[37] N. Li, C. P. Ho, S. Zhu, Y. H. Fu, Y. Zhu, L. Y. T. Lee, Nanophotonics 2021, 10, 2347.
[38] A. Ababneh, Z. Albataineh, A. M. K. Dagamseh, I. S. Al-Kofahi, B. Schafer, T. Zengerle, K. Bauer, H. Seidel, Thin Solid Films 2020, 693, 137701.
[39] V. G. Achanta, Reviews in Physics 2020, 5, 2405.
[40] L. Zhang, R. Gogna, W. Burg, E. Tutuc, H. Deng, Nat. Commun. 2018, 9, 713.
[41] J.-B. You, W.-J. Lee, D. Won, K. Yu, Opt. Express 2014, 22, 8339.
[42] R.-G. Wan, M. S. Zubairy, Phys. Rev. A 2020, 101, 023837.
[43] Y. Foo, J. A. Zapien, Appl. Surf Sci. 2017, 421, 878.
[44] K. T. Cheung, Y. Foo, C. H. To, J. A. Zapien, Appl. Surf Sci. 2013, 281, 2.
[45] Y. Foo, K. T. Cheung, C. H. To, J. A. Zapien, Thin Solid Films 2014, 571, 356.
[46] M. R. Gartia, A. Hsiao, A. Pokhriyal, S. Seo, G. Kulsharova, B. T. Cunningham, T. C. Bond, G. L. Liu, Adv. Optical Mater 2013, 1, 68.
[47] A. A. Yanik, A. E. Cetin, M. Huang, A. Artar, S. H. Mousavi, A. Khanikaev, J. H. Connor, G. Shvets, H. Altug, PNAS 2011, 108, 11784.
[48] C. Lee, B. Lawrie, R. Pooser, K.-G. Lee, C. Rockstuhl, M. Tame, Chem. Rev. 2021, 121, 4743.
[49] R. Slavik, J. Homola, Sens. Actuators, B 2007, 123, 10.
[50] M. Vala, S. Etheridge, J. A. Roach, J. Homola, Sens. Actuators, B 2009, 139, 59.
[51] H. Shi, Z. Liu, X. Wang, J. Guo, L. Liu, L. Luo, J. Guo, H. Ma, S. Sun, Y. He, Sens. Actuators, B 2013, 185, 91.
[52] G. A. Cervantes Tellez, S. Hassan, R. N. Tait, P. Berini, R. Gordon, Lab Chip 2013, 13, 2541.
[53] S. Mariani, L. M. Strambini, G. Barillaro, ACS Sens. 2018, 3, 595.
[54] I. Barth, D. Conteduca, C. Reardon, S. Johnson, T. F. Krauss, Light Sci Appl 2020, 9, 96.
[55] Y. H. Huang, H. P. Ho, S. K. Kong, A. V. Kabashin, Ann. Phys. (Berlin) 2012, 524, 637.
[56] G. Wang, C. Wang, R. Yang, W. Liu, S. Sun, Sensors 2017, 17, 2777.
[57] E. Buzavaite-Verteliene, I. Plikusiene, T. Tolenis, A. Valavicius, J. Anulyte, A. Ramanavicius, Z. Balevicius, Opt. Express 2020, 28, 29033.
[58] R. Ahmed, M. O. Ozen, M. G. Karaaslan, C. A. Prator, C. Thanh, S. Kumar, L. Torres, N. Iyer, S. Munter, S. Southern, T. J. Henrich, F. Inci, U. Demirci, Adv. Mater. 2020, 32, 1907160.
[59] M. Wu, S. Wu, G. Wang, W. Liu, L. T. Chu, T. Jiang, H. K. Kwong, H. L. Chow, I. W. S. Li, T.-H. Chen, Sci. Adv. 2022, 8.
[60] R. Funari, K.-Y. Chu, A. Q. Shen, Biosens. Bioelectron. 2020, 169, 112578.
[61] D. Rodrigo, O. Limaj, D. Janner, D. Etezadi, F. J. Garcia De Abajo, V. Pruneri, H. Altug, Science 2015, 349, 165.
[62] B. N. Shivananju, W. Yu, Y. Liu, Y. Zhang, B. Lin, S. Li, Q. Bao, Adv. Funct. Mater. 2017, 27, 1603918.
[63] T. Xue, W. Liang, Y. Li, Y. Sun, Y. Xiang, Y. Zhang, Z. Dai, Y. Duo, L. Wu, K. Qi, B. N. Shivananju, L. Zhang, X. Cui, H. Zhang, Q. Bao, Nat. Commun. 2019, 10, 28.
[64] J. Liu, D. Zhang, D. Yu, M. Ren, J. Xu, Light Sci Appl 2021, 10, 55.
[65] S. Haq, T. E. Tesema, B. Patra, E. Gomez, T. G. Habteyes, ACS Photonics 2020, 7, 622.
[66] F. A. A. Nugroho, P. Bai, I. Darmadi, G. W. Castellanos, J. Fritzsche, C. Langhammer, J. Gómez Rivas, A. Baldi, Nat. Commun. 2022, 13, 5737.
[67] X. Zhang, X. Zhang, C. Luo, Z. Liu, Y. Chen, S. Dong, C. Jiang, S. Yang, F. Wang, X. Xiao, Small 2019, 15, 1805516.
[68] D. Conteduca, I. Barth, G. Pitruzzello, C. P. Reardon, E. R. Martins, T. F. Krauss, Nat. Commun. 2021, 12, 3293.
[69] R. Chikkaraddy, J. J. Baumberg, ACS Photonics 2021, 8, 2811.
[70] S. H. Cho, K. M. Baek, H. J. Han, M. Kim, H. Park, Y. S. Jung, Adv. Funct. Mater. 2020, 30, 2000612.

### References for the Supplementary Information of the Third Embodiment

[1] Foo, Y., Zapien, J.A. Convergence and precision characteristics of finite difference time domain method for the analysis of spectroscopic ellipsometry data at oblique incidence. Applied Surface Science 421, 878-883 (2017).
[2] Foo, Y., Cheung, K. T., To, C. H., Zapien, J.A. On the development of Finite-Difference Time-Domain for modeling the spectroscopic ellipsometry response of 1D periodic structures. Thin Solid Films 571, 356-363 (2014).
[3] Cheung, K. T., Foo, Y., To, C. H. Zapien, J.A. Towards FDTD modeling of spectroscopic ellipsometry data at large angles of incidence. Applied Surface Science 281, 2-7 (2013).
[4] Thomas, P. A., Menghrajani, K. S., Barnes, W. L. All-optical control of phase singularities using strong light-matter coupling. Nat Commun 13, 1809 (2022).
[5] Deng, S., Wang, P., Yu, X. Phase-Sensitive Surface Plasmon Resonance Sensors: Recent Progress and Future Prospects. Sensors 17, (2017).
[6] Xu, Y., Bai, P., Zhou, X., Akimov, Y., Png, C. E., Ang, L-K., Knoll, W., Wu, L. Optical Refractive Index Sensors with Plasmonic and Photonic Structures: Promising and Inconvenient Truth. Advanced Optical Materials 7, (2019).
[7] Sohrabi, F., Saeidifard, S., Hamidi, S. M. Plasmonic structures for phase-sensitive ellipsometry biosensing: a review. Optical and Quantum Electronics 53, (2021).
[8] Chen, J., Gan, F., Wang, Y., Li, G. Plasmonic Sensing and Modulation Based on Fano Resonances. Advanced Optical Materials 6, (2018).
[9] Shrivastava A, Gupta V B. Methods for the determination of limit of detection and limit of quantitation of the analytical methods. Chron Young Sci 2, 21-5, (2011).
[10] Armbruster D A, Pry T. Limit of blank, limit of detection and limit of quantitation. Clin. Biochem. Rev. 29, 49-52, (2008).
[11] Pum, J. A practical guide to validation and verification of analytical methods in the clinical laboratory. Adv Clin Chem. 90, 215-281, (2019).
[12] Jung, L. S., Campbell, C. T., Chinowsky, T. M., Mar, M. N., Yee, S. S. Quantitative Interpretation of the Response of Surface Plasmon Resonance Sensors to Adsorbed Films. Langmuir 14, 5636-5648 (1998).
[13] Pfeifer, P., Aldinger, U., Schwotzer, G., Diekmann, S., Steinrucke, P. Real time sensing of specific molecular binding using surface plasmon resonance spectroscopy. Sensors and Actuators B: Chemical 54, 166-175 (1999).
[14] Gupta, G., Kondoh, J. Tuning and sensitivity enhancement of surface plasmon resonance sensor. Sensors and Actuators B: Chemical 122, 381-388 (2007).
[15] Sutapun, B., Somboonkaew, A., Amrit, R., Houngkamhang, N., Srikhirin, T. A multichannel surface plasmon resonance sensor using a new spectral readout system without moving optics. Sensors and Actuators B: Chemical 156, 312-318 (2011).
[16] Lu, M., Liang, Y., Qian, S., Li, L., Jing, Z., Masson, J-F., Peng, W. Optimization of Surface Plasmon Resonance Biosensor with Ag/Au Multilayer Structure and Fiber-Optic Miniaturization. Plasmonics 12, 663-673 (2017).
[17] Wang, G., Wang, C., Yang, R., Liu, W., Sun, S. A Sensitive and Stable Surface Plasmon Resonance Sensor Based on Monolayer Protected Silver Film. Sensors 17, 2777, (2017).
[18] Nenninger, G. G., Tobiska, P., Homola, J., Yee, S. S. Long-range surface plasmons for high-resolution surface plasmon resonance sensors. Sens. Actuators B: Chem. 74, 145-151 (2001).
[19] Slavik, R., Homola, J. Ultrahigh resolution long range surface plasmon-based sensor. Sensors and Actuators B: Chemical 123, 10-12 (2007).
[20] Vala, M., Etheridge, S., Roach, J.A., Homola, J. Long-range surface plasmons for sensitive detection of bacterial analytes. Sensors and Actuators B: Chemical 139, 59-63 (2009).
[21] Shi, H., Liu, Z., Wang, X., Guo, J., Liu, L., Luo, L., Guo, J., Ma, H., Sun, S., He, Y. A symmetrical optical waveguide based surface plasmon resonance biosensing system. Sensors and Actuators B: Chemical 185, 91-96 (2013).
[22] Isaacs, S. Abdulhalim, I. Long range surface plasmon resonance with ultra-high penetration depth for self-referenced sensing and ultra-low detection limit using diverging beam approach. Applied Physics Letters 106, 193701 (2015).
[23] Wu, S. Y., Ho, H. P., Law, W. C., Lin, C. Highly sensitive differential phase-sensitive surface plasmon resonance biosensor based on the Mach-Zehnder configuration. Opt Lett 29, 2378 (2004).
[24] Kabashin, A. V., Patskovsky, S., Grigorenko, A. N. Phase and amplitude sensitivities in surface plasmon resonance bio and chemical sensing. Opt Express 17, 21191-21204 (2009).
[25] Moirangthem, R. S., Chang, Y. C., Hsu, S. H., Wei, P. K. Surface plasmon resonance ellipsometry based sensor for studying biomolecular interaction. Biosens Bioelectron 25, 2633-2638 (2010).
[26] Moirangthem, R. S., Chang, Y. C., Wei, P. K. Investigation of surface plasmon biosensing using gold nanoparticles enhanced ellipsometry. Opt Lett 36, 775-777 (2011).
[27] Moirangthem, R. S., Yaseen, M. T., Wei, P. K., Cheng, J. Y., Chang, Y. C. Enhanced localized plasmonic detections using partially-embedded gold nanoparticles and ellipsometric measurements. Biomed. Opt. Express 3, 899-910 (2012).
[28] Watad, I., Abdulhalim, I. Spectropolarimetric Surface Plasmon Resonance Sensor and the Selection of the Best Polarimetric Function. IEEE Journal of Selected Topics in Quantum Electronics 23, 89-97 (2017).
[29] Claes, T., Bogaerts, W., Bienstman, P. Experimental characterization of a silicon photonic biosensor consisting of two cascaded ring resonators based on the Vernier effect and introduction of a curve fitting method for an improved detection limit. Opt Express 18, 22747-22761 (2010).
[30] Xu, Z., Sun, Q., Li, B., Luo, Y., Lu, W., Liu, D., Shum, P. P., Zhang, L. Highly sensitive refractive index sensor based on cascaded microfiber knots with Vernier effect. Opt Express 23, 6662-6672 (2015).
[31] Barth, I., Conteduca, D., Reardon, C. et al. Common-path interferometric label-free protein sensing with resonant dielectric nanostructures. Light Sci Appl 9, 96 (2020).
[32] Gomes, A., D. Kobelke, J., Bierlich, J. Dellith, J., Rothhardt, M., Bartelt, H., Frazao, O. Giant refractometric sensitivity by combining extreme optical Vernier effect and modal interference. Sci. Rep. 10, 19313 (2020).
[33] Lee, K.-L., Wei, P.-K. Enhancing Surface Plasmon Detection Using Ultrasmall Nanoslits and a Multispectral Integration Method. Small 6, 1900-1907 (2010).
[34] Blanchard-Dionne, A.-P., Guyot, L., Patskovsky, S., Gordon, R., Meunier, M. Intensity based surface plasmon resonance sensor using a nanohole rectangular array. Opt Express 19, 15041 (2011).
[35] Lee, K. L. Chih, M-J., Shi, X., Ueno, K., Misawa, H., Wei, P-K. Improving surface plasmon detection in gold nanostructures using a multi-polarization spectral integration method. Adv Mater 24, 253-259 (2012).
[36] Cervantes Tellez, G. A., Hassan, S., Tait, R. N., Berini, P., Gordon, R. Atomically flat symmetric elliptical nanohole arrays in a gold film for ultrasensitive refractive index sensing. Lab Chip 13, 2541-2546 (2013).
[37] Lin, E. H., Tsai, W. S., Lee, K. L., Lee, M. C., Wei, P. K. Enhancing detection sensitivity of metallic nanostructures by resonant coupling mode and spectral integration analysis. Opt Express 22, 19621-19632 (2014).
[38] Mariani, S., Strambini, L. M., Barillaro, G. Electrical Double Layer-Induced Ion Surface Accumulation for Ultrasensitive Refractive Index Sensing with Nanostructured Porous Silicon Interferometers. ACS Sens 3, 595-605 (2018).
[39] Lee, K.-L., You, M.-L., Wei, P.-K. Aluminum Nanostructures for Surface-Plasmon-Resonance-Based Sensing Applications. ACS Applied Nano Materials 2, (2019).
[40] Conteduca, D., Barth, I., Pitruzzello, G., Reardon, C. P., Martins, E. R., Krauss, T. F. Dielectric nanohole array metasurface for high-resolution near-field sensing and imaging. Nat Commun 12, 3293 (2021).
[41] Buzavaite-Verteliene, E., Plikusiene, I., Tolenis, T., Valavicius, A., Anulyte, J., Ramanavicius, A., Balevicius, Z. Hybrid Tamm-surface plasmon polariton mode for highly sensitive detection of protein interactions. Opt Express 28, 29033-29043 (2020).
[42] Lin, C., Chen, S. High-performance bimetallic film surface plasmon resonance sensor based on film thickness optimization. Optik 127, 7514-7519 (2016).
[43] Arwin, H., Poksinski, M., Johansen, K. Total internal reflection ellipsometry: principles and applications. Appl. Opt. 43, 3028-3036 (2004).
[44] Oates, T. W. H., Wormeester, H., Arwin, H. Characterization of plasmonic effects in thin films and metamaterials using spectroscopic ellipsometry. Progress in Surface Science 86, 328-376 (2011).
[45] Shalabney, A., Abdulhalim, I. Sensitivity-enhancement methods for surface plasmon sensors. Laser & Photonics Reviews 5, 571-606 (2011).
[46] Marsillac, S., Little, S. A., Collins, R. W. A broadband analysis of the optical properties of silver nanoparticle films by in situ real time spectroscopic ellipsometry. Thin Solid Films 519, 2936-2940 (2011).
[47] Little, S. A., Collins, R. W., Marsillac, S. Analysis of interband, intraband, and plasmon polariton transitions in silver nanoparticle films viain situreal-time spectroscopic ellipsometry. Applied Physics Letters 98, (2011).

1. An optical sensing method, comprising:
obtaining a plurality of zero-reflection points (ZRPs) with overlapping conditions for s-polarization and p-polarization at a given value of interrogation variable; and
sensing variations in amplitude ratio (Ψ) and phase difference (Δ) spectra of orthogonally polarized ZRPs at overlapping conditions, or alternative representations derived upon polarization changes.

2. The method of claim 1, wherein the alternative representations comprise ρ, N, C, S, non-zero Mueller-Matrix elements, and/or other variables derived upon the polarization changes.

3. The method of claim 1, wherein the step of obtaining the plurality of ZRPs with overlapping conditions for s-polarization and p-polarization at a given value of interrogation variable comprises tuning a resonance of one or more optical waveguides and a thickness of two or more plasmonic layers.

4. The method of claim 1, wherein the interrogation variable comprises wavelength (λ), photon energy (E) and/or angle of incidence (AoI).

5. The method of claim 1, wherein obtaining the plurality of ZRPs comprises implementing a hybrid plasmonic-photonic mode enabling interaction between surface plasmon polaritons (SPPs) and photonic waveguide (PWG) resonances.

6. The method of claim 5, wherein p-polarized reflectivity spectra Rₚ is affected by coupling of SPPs and PWG modes, while s-polarized reflectivity spectra Rₛ remains uncoupled.

7. The method of claim 6, wherein the p-polarized reflectivity spectra Rₚ exhibits the Rabi splitting or waveguide coupled SPR where two distinct polariton states energetically split from the uncoupled SPP and PWG resonances and identified as lower polariton branch (LPB) and upper polariton branch (UPB).

8. The method of claim 7, wherein one branch of Rₚ overlapping with the ZRP of Rₛ in a polarimetric strategy is used for smaller variation sensing, and another branch of Rₚ is used for larger increment sensing.

9. The method of claim 1, wherein obtaining the plurality of ZRPs enables spectral overlap of s-polarized photonic modes with coupled p-polarized resonances.

10. The method of claim 1, further comprising resetting the ZRPs by adjusting the interrogation variable.

11. The method of claim 1, wherein the optical sensing method is used for refractometric sensing and/or biosensing.

12. An optical sensor, comprising:
a substrate for coupling light into surface plasmon polaritons;
a first layer of plasmonic material on the substrate;
a second layer of photonic material on the first layer;
a third layer of plasmonic material on the second layer; and
an outer layer exposed to external stimulus for sensing.

13. The optical sensor of claim 12, wherein the substrate is transparent in one or more bands in ultraviolet/visible/near infrared/infrared spectral regions, and wherein the substrate comprises quartz, glass, sapphire, and/or silicon.

14. The optical sensor of claim 12, wherein the plasmonic material comprises metals, doped semiconductors, and/or 2D materials.

15. The optical sensor of claim 12, wherein the first layer and the third layer need not be the same plasmonic material and can comprise silver (Ag), gold (Au), copper (Cu), aluminum (Al), indium tin oxide (ITO), titanium nitride (TiN), zirconium nitride (ZrN), graphene, or other 2D materials, black phosphorus or a mixture or alloy thereof to satisfy the plasmonic resonance conditions in ultraviolet/visible/near infrared/infrared spectral regions.

16. The optical sensor of claim 12, wherein the second layer comprises aluminum nitride (AlN), aluminum oxide (Al₂O₃), aluminum oxynitride (AlON), titanium dioxide (TiO₂), silicon nitride (Si₃N₄), silica (SiO₂), and/or other suitable materials that can be part of the photonic waveguide part.

17. The optical sensor of claim 12, wherein the thickness of the first layer is no more than 30 nm, and the thickness of the third layer is no more than 100 nm.

18. The optical sensor of claim 12, wherein the outer layer is exposed to air or solution in contact with analyte or other forms of the external stimulus, the external stimulus comprising temperature, humidity, stress, vibrations, pressure and/or combinations thereof.

19. The optical sensor of claim 12, wherein the outer layer contacts microfluidic device, electrode, temperature controller, and/or surface modification anchors for sensing.

20. The optical sensor of claim 12, further comprising:
a fourth layer of a photonic material on the third layer acting as a photonic waveguide.

21. The optical sensor of claim 20, wherein the fourth layer comprises aluminum nitride (AlN), aluminum oxide (Al₂O₃), aluminum oxynitride (AlON), titanium dioxide (TiO₂), silicon nitride (Si₃N₄), silica (SiO₂), and/or other suitable materials that can be part of a second photonic waveguide part.

22. The optical sensor of claim 12, wherein the thickness of the second layer and/or the fourth layer is larger than 1000 nm, and the optical sensor provides multiple spectral sensing points.

23. The optical sensor of claim 12, wherein each of the first layer, the second layer, the third layer, and/or the fourth layer comprises metasurfaces, and the metasurfaces comprise subwavelength plasmonic or photonic nanostructures.

24. A method for fabricating an optical sensor, comprising:
preparing a substrate;
forming a multilayer stack on the substrate, the multilayer stack comprising a first layer of plasmonic material, a second layer of photonic material on the first layer, and a third layer of plasmonic material on the second layer; and
forming an outer layer on the multilayer stack.

25. The method of claim 24, wherein the step of forming the multilayer stack further comprises forming a fourth layer of photonic material on the third layer.

26. The method of claim 24, wherein the step of forming the multilayer stack comprises sequentially depositing the first layer, the second layer, and the third layer, or additionally the fourth layer, via physical vapor deposition.

27. The method of claim 26, wherein the step of forming the multilayer stack is lithography-free.

28. The method of claim 24, wherein each of the first layer, the second layer, the third layer, and/or the fourth layer comprises metasurfaces, and the metasurfaces comprise subwavelength plasmonic or photonic nanostructures.
